(19) United States
(12) Patent Application Publication
(10) Pub. No.: US 2016/0162616 A1
(43) Pub. Date: Jun. 9, 2016

(54) PERFORMANCE AND LIFE PREDICTION MODEL FOR PHOTOVOLTAIC MODULE: EFFECT OF ENCAPSULANT CONSTITUTIVE BEHAVIOR

(71) Applicant: King Fahd University of Petroleum and Minerals, Dhahran (SA)

(72) Inventors: Osama HASAN, Riyadh (SA); Abul Fazal Muhammad Arif, Dhahran (SA)

(73) Assignee: King Fahd University of Petroleum and Minerals, Dhahran (SA)

(21) Appl. No.: 14/227,373

(22) Filed: Mar. 27, 2014

(51) Int. Cl. G06F 17/50

(52) U.S. Cl. CPC G06F 17/5018

(57) ABSTRACT

The present disclosure includes a method and/or a computer system for modeling the performance and lifetime of a photovoltaic module (PV). The method includes preparing a comprehensive finite element model; viscoelastic modeling of the encapsulant material of the PV; and orthotropic modeling of the silicon cells of the PV. It also includes carrying out the finite element model by including the predicted time to crack initiation due to temperature; and analyzing the temperature cycling fatigue of copper interconnects in the PV module, and analyzing the PV module under variable mechanical environmental stresses including temperature and sun exposure. Meteorological data are used for modeling the variable environmental stresses.

### BACKGROUND

1. Field of the Disclosure

The disclosure relates to method and computer system for modeling the performance and lifetime of a photovoltaic module (PV) using a finite element model including viscoelastic modeling of the encapsulant material of the PV and an orthotropic modeling of the silicon cells of the PV.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the near future the demand for electric energy is expected to increase rapidly due to global population growth and industrialization. This increase in energy demand requires electric utilities to increase electric generation. Recent studies predict that the world's net electricity generation is expected to rise from 20,261 terawatt-hours in 2008 to 24,400 terawatt-hours (an increase of 20.4%) in 2015 and 33,300 terawatt-hours (an increase of 64.4%) in 2030, U.S. Energy Information Administration, 2011, International Energy Outlook 2011, U.S. Energy Information Administration, DOE/EIA-0484(2011), incorporated by reference herein. Currently, a large share of electricity is generated from fossil fuels, especially coal, due to their low prices. However, the increasing use of fossil fuels accounts for a significant portion of environmental pollution and greenhouse gas emissions, which are considered as the main reason behind the global warming. For example, the emissions of carbon dioxide and mercury are expected to increase by 35% and 8%, respectively, by the year 2020 due to the expected increase in electricity generation Report to Congressional Requesters prepared by the United States General Accounting Office, 2002, Meeting Future Electricity Demand Will Increase Emissions of Some Harmful Substances, GAO-03-49, incorporated by reference herein. Moreover, possible depletion of fossil fuel reserves and unstable price of oil are two main concerns for industrialized countries.

To overcome the problems associated with generation of electricity from fossil fuels, renewable energy sources can participate in the energy mix. One of the renewable energy sources that can be used for this purpose is the light received from the sun. This light can be converted to clean electricity through the photovoltaic (PV) process. The use of PV systems for electricity generation started in the seventies of the 20th century and is currently growing rapidly worldwide. The PV industry is growing even in times of economic crisis. The global solar electricity market is currently more than $10 billion/year and the industry is rising at a rate of greater than 30% per annum Lewis N. S., 2007, “Toward cost-effective solar energy use,” Science (New York, N.Y.), 315(5813), pp. 798-801, incorporated by reference herein.

The lifetime of today's PV module is expected to be 25 years with 20% reduction in its power output over this period, and this is usually guarantee of the manufacturer. In accordance with such requirements, the PV module must withstand mechanical loads reliably. Its high reliability will help it to reach grid parity. But the problem is that it is not convenient to wait and assess its durability. Qualification standards such as ASTM E1171-09 and ASTM E1830-09 ASTM Standard E1171-09, 2009, Standard Test Methods for Photovoltaic Modules in Cyclic Temperature and Humidity Environments, ASTM International, West Conshohocken, Pa., and ASTM Standard E1830-09, 2009, Standard Test Methods for Determining Mechanical Integrity of Photovoltaic Modules, ASTM International, West Conshohocken, Pa., incorporated by reference herein, are useful in predicting failures during the infant mortality period of operation but cannot foresee long-term failures.

### SUMMARY

The present disclosure includes a method and/or a computer system for modeling the performance and lifetime of a photovoltaic module (PV).

In one embodiment the method includes preparing a comprehensive finite element model; viscoelastic modeling of the encapsulant material of the PV; and orthotropic modeling of the silicon cells of the PV.

Another embodiment includes carrying out the finite element model by including the predicted time to crack initiation due to temperature; and analyzing the temperature cycling fatigue of copper interconnects in the PV module.

Another embodiment includes analyzing the PV module under variable mechanical environmental stresses including temperature and sun exposure.

Another embodiment includes modeling the variable environmental stresses include using meteorological data.

Another embodiment includes using viscoelastic modeling of an encapsulant ionomer as the choice for PV module encapsulation.

Another embodiment includes modeling the performance and lifetime of a PV module including changing the encapsulant material to decrease the effect of mechanical stress on copper interconnects of a PV module; and obtaining better electrical performance of a PV module.

Another embodiment includes modeling the performance and lifetime of a PV includes presenting design procedures that result in the uniformity of the PV module temperature.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of a cross-section of a PV module;

FIG. 2 is a schematic of the Czochralski process;

FIG. 3 is a schematic of an untabbed PV cells at BP Solar in Riyadh;

FIG. 4 are close-up images of crack in cells, broken interconnects and solder bond failures;

FIG. 5a is an image of delamination;

FIG. 5 b is showing an image of Glass Breakage;

FIG. 6 is a line chart of Hemispherical transmittance vs. wavelength of different aged samples of EVA;

FIG. 7 is a chart of failure modes of PV modules;

FIG. 8 is a chart of one temperature cycle of ASTM E1171-09;

FIG. 9 is a structure of Silicon crystal;

FIG. 10 a is a chart of tensile tests on copper interconnects performed on Zwick;

FIG. 10 b is a chart of the temperature dependence of Young's modulus of copper interconnects found by DMA;

FIG. 11 a is a schematic of Maxwell's model;

FIG. 11 b is a schematic of the generalized Maxwell or Maxwell-Wiechert model;

FIG. 12 a is a line chart of a DMA experiment result for EVA;

FIG. 12 b is a line chart of Isothermal relaxation curves for EVA;

FIG. 13 is a line chart of CTE of Silicon vs. Temperature;

FIG. 14 is a line chart of CTE of Copper vs. Temperature;

FIG. 15 shows a prony series fit of the master curve in Eitner el Al;

FIG. 16 shows modes of energy transfer in a PV model;

FIG. 17 is a schematic of an equivalent circuit of an actual PV cell;

FIG. 18 is a schematic of shell model dimensions;

FIG. 19 is a schematic of a layered configuration of areas along transverse direction;

FIG. 20 is a schematic of an interconnection approximation in shell model;

FIG. 21 is a schematic of a FE mesh of the geometric model for PV module;

FIG. 22 is a flowchart of the validation process;

FIG. 23 is showing a digital image correlation experimental setup to measure cell-gap displacement;

FIG. 24 is a chart showing the temperature history of the cell gap displacement experiment;

FIG. 25 is a schematic of a solid model representing cells without glass, encapsulant and backsheet;

FIG. 26 is a chart showing a comparison of the two linear elastic models with experimental data;

FIG. 27 is a chart showing a comparison of the viscoelastic model for EVA with the experimental results;

FIG. 28 a is a Von-Mises stress contour of backsheet using a solid model;

FIG. 28 b is a Von-Mises stress contour of backsheet using a shell model;

FIG. 29 a is a Von-Mises stress contour of glass cover using a solid model;

FIG. 29 b is a Von-Mises stress contour of glass cover using a shell model;

FIG. 30 a is a Von-Mises stress contour of cell using a solid model;

FIG. 30 b is a Von-Mises stress contour of cells using a shell model;

FIG. 31 is a line chart showing a comparison of the von-Mises stress along the thickness of the module by using solid and shell modules;

FIG. 32 is a stimulation of a temperature profile;

FIG. 33 is showing a first principle stress on glass (left) and third principle stress on glass (right) at 40 Celsius;

FIG. 34 is showing a first principle stress within the backsheet at −40 Celsius;

FIG. 35 is showing an x-direction stress in cells (left) and third principle stress in cells (right) at −40 Celsius;

FIG. 36 is showing a first principle stress on the interconnects (left) and on the connection between the interconnects (right);

FIG. 37 is a chart showing a parametric study showing max. third principle stress on cells by varying encapsulant thickness;

FIG. 38 is a flowchart of the modeling process;

FIG. 39 shows the irradiation and ambient temperatures of the four representative days;

FIG. 40 shows the Von-Mises stress (left) and von-Mises plastic strain (right) at room temperature after the lamination process at the interconnects region between two adjacent cells (shaded region A);

FIG. 41 shows the Max von-Mises stress and first principle stress through the thickness of the module at lowest temperature on Day 4;

FIG. 42a shows the first principle contours of glass at region A.

FIG. 42b shows the first principle contours of Backsheet at region A.

FIG. 42c shows the first principle contours of Cells at region B.

FIG. 42d shows the Encapsulant at region A at lowest temperature on day 4.

FIG. 43a shows the first principle stress contours of interconnect region over the cells at region A.

FIG. 43b shows the interconnects region between two adjacent cells at region B at lowest temperature on day 4.

FIG. 44a shows stress variation on module along Longitudinal path AB.

FIG. 44b shows Transverse path CD at lowest temperature on Day 4.

FIG. 45 shows a transient change in von-Mises stress and first principal stress for Day 3 on copper interconnect. A represents the time of max. stress, min. temperature and B represents the time of min. stress, max. temperature;

FIG. 46 shows a measured data and master-curve for the loss modulus of PDMS in reduced frequency domain;

FIG. 47 shows the master-curve for PVB obtained by shifting the results of stress relaxation experiments at different temperatures in time domain;

FIG. 48 shows a prony fit of the master-curve of TPU in time domain;

FIG. 49 shows a location of points A, B, C and D for Table 18;

FIG. 50a shows a stress variation on module along the longitudinal path AB.

FIG. 50b shows the transverse path CD at lowest temperature on Day 3 using EVA as encapsulant.

FIG. 51 shows a Von-Mises stress variation along thickness of the PV module using EVA for Day 3;

FIG. 52 shows cell efficiency for the 5 encapsulants during day 3;

FIG. 53 shows the total first principal strain variation for all encapsulants during day 3, Line A shows the time of maximum strain and Line B shows the time of minimum strain;

FIG. 54 shows nominal system;

FIG. 55 shows perturbed system;

FIG. 56 shows the division of relaxation curve of EVA on time scale where A represents the glassy region, B represents the viscoelastic region and C is the rubbery region.

FIG. 57 shows the relaxation modulus of EVA at −20° C. varying by one order;

FIG. 58 shows the relaxation modulus of EVA at −20° C. with varying slope by 10%;

FIG. 59 shows the NSC evaluated through life output varying encapsulant parameters;

FIG. 60 shows the NSC evaluated through power output varying encapsulant parameters;

FIG. 61 illustrates an exemplary hardware configuration of the system server according to one example.

### DETAILED DESCRIPTION OF THE EMBODIMENTS

A Photovoltaic (PV) module includes or consists of layers of different materials constrained together through an encapsulant polymer. During operation the PV module experiences thermal loads due to temperature variations and humidity which cause breakage of interconnects owing to fatigue, corrosion and laminate warpage. This is due to the fact that there is a coefficient of thermal expansion (CTE) mismatch because of the presence of unlike materials within the laminate. The encapsulant protects the silicon cells and interconnects from moisture, heat and mechanical damage. The lifetime of today's PV module is expected to be 25 years. Assessment of the actual lifetime is complicated due to the inconvenience and impracticability of waiting through an entire lifetime to assess durability.

A comprehensive Finite-Element (FE) model capable of capturing the actual behavior of PV module under operation is disclosed. Viscoelasticity of the encapsulant polymer was taken into account and the silicon cells were modeled as orthotropic. It was found that the copper interconnects undergo plastic deformation just after the lamination process. The developed model is sequentially-coupled to a transient thermal model. By using meteorological data, average life of PV module was predicted considering thermal fatigue life of copper interconnects. An encapsulant based comparative study identifies superior options with respect to various parameters affecting PV module performance and life.

Performance is actually the measure of output derived by a system. In the case of Photovoltaic (PV) modules, the total performance can be categorized into 3 types:

(i) Electrical Performance: It is estimated through the power output (Vmp×Imp) and the electrical efficiency. Vmp and Imp are the voltage and current at maximum power point respectively.
(ii) Thermal Performance: Thermal performance is basically measured through the electrical performance except that it is can be quantified through cell temperature (Tc). In the case where a thermal collector is attached to a PV module, it is also a measured through outlet fluid temperature (Tout) of the thermal collector. It actually gives the heat removal from cells. As described in Skoplaki E., and Palyvos J. a., 2009, “On the temperature dependence of photovoltaic module electrical performance: A review of efficiency/power correlations,” Solar Energy, 83(5), pp. 614-624 incorporated herein by reference, electrical performance of a PV module is adversely affected by increasing Tc.
(iii) Structural Performance: As disclosed herein and estimated through working life of a PV module. Life can be defined as the time span within which a module delivers performance up to its specification. For example, the statement “25-year life with 20% loss in power output” given by most manufacturers specifies the structural performance of the PV module.

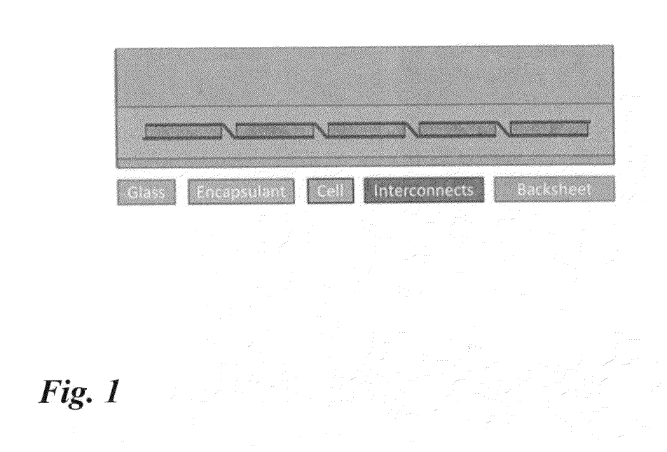

Referring now to the drawings, FIG. 1 is a PV module that contains of layers of different materials (e.g. glass, interconnects, cells and back sheet) that are bound together through an encapsulant polymer. This single laminate of various materials is formed by the lamination process, in which the encapsulant is placed between each layer and melted at its curing temperature. Polymer chains are cross-linked after curing and the whole laminate is cooled to room temperature. Upon cooling, each material tends to contract but all of them are restricted to one another due to adhesion of the encapsulant. The differences in the coefficients of thermal expansion (CTE) of all components induce thermo-mechanical stresses within them. Hence, a PV module is pre-stressed before its service. During operation, it experiences temperature cycles of day and night due to which each component is further stressed within the laminate, which may lead to failure. During manufacturing of a PV module, the components face different mechanical and thermal stresses. The pre-stress during manufacturing ads up to the stresses generated during operating loads, thus it is important to study in order assess the structural performance of PV module.

Silicon dioxide is used as a raw material to develop pure silicon. Silicon is purified in a first step. Purification is done by dissociating silicon dioxide into pure molten silicon and carbon dioxide by an electric arc. The process is done in an electric arc furnace. Silicon obtained by this method is almost 1% impure. Even this percentage of impurity is removed through the Floating Zone technique. The general procedure is to drag the silicon rod through a heated zone, in the same direction, several times. The impurities are dragged to one end with each pass. After a certain time and number of passes, impurities are removed and pure silicon is obtained. “How solar cell is made—material, manufacture, making, used, parts, structure, procedure, steps, industry, Raw Materials, The Manufacturing Process of solar cell”[Online]. Available: http://www.madehow.com/Volume-1/Solar-Cell.html.[Accessed: 29 Oct. 2012]., incorporated by reference herein.

General silicon cell types are listed in Table 1. A thin film solar cell is produced by depositing PV material on a ceramic substrate. These PV materials are mentioned in the second column of Table 1. Thin-Film solar cells are less efficient as compared to crystalline cells. Throughout the literature, only monocrystalline cells will be considered. Monocrystalline silicon cells, among the mentioned types, are the most efficient cells. It comprises of a single crystal of silicon grown and doped, as discussed in the next articles.

TABLE 1
silicon cell types

| Crystalline Solar Cells | Thin-Film |
|---|---|
| Monocrystalline | CdTe |
| Polycrystalline | CIGS |
| | CIS |
| | a-Si |

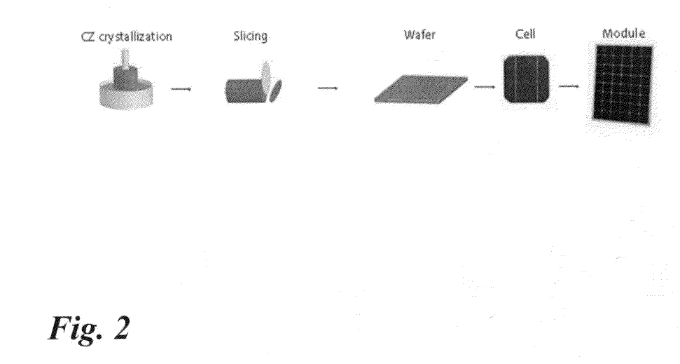

FIG. 2 is a schematic of a process of monocrystalline silicon growing into a pseudo-square wafer cut from ingots through the Czochralski (CZ) process. Saga T., 2010, “Advances in crystalline silicon solar cell technology for industrial mass production,” NPG Asia Materials, 2(3), pp. 96-102, incorporated by reference herein. The technique involves lowering a seed crystal of silicon into silo of melted purified silicon. As the dipped seed crystal is removed from the vat and rotated, a long cylindrical boule of silicon is formed. This ingot or boule is extremely pure, as the impurities are likely to remain in the molten liquid. Now the ingot is sliced to make wafers of silicon by a circular diamond saw. A multiwire saw may also be used to cut many wafers at a time. About half of the silicon is wasted from the ingot to the finished circular wafer. In order to increase the area of solar cells over the front surface of the module, the wafers are given pseudo-square shape as they require less space and get more room for additional silicon in a limited area.

Doping is done to make pure silicon able to conduct electricity. Basically, dopant elements are added in order to produce excess of electrons in one region and deficiency of electrons in the other. Usually, silicon is p-doped by adding boron in the Cz process described previously Gallium, Indium or their combination with Boron can also suffice as a p-dopant. Now, the n-dopant is applied whose conductivity is opposite as of the first dopant. This forms a p-n junction in the wafer. This is done by depositing the n-dopant onto the surface of the wafer and heating the wafer in order to allow the n-dopant to penetrate within. Phosphorus is a preferred n-dopant and applied through Phosphorusoxychloride. The wafer is heated to a temperature of 700° C. to 850° C.

Pure silicon is shiny and it reflects up to 35% of light. To decrease reflection, antireflective coatings (ARC) are deposited on the front surface of the cells. The coatings comprise of di-electric such as titanium oxide, silicon dioxide or silicon nitride. There are several methods of depositing the anti-reflective layer, one of which is Low Pressure Chemical Vapor Deposition (LPCVD). The wafer is kept in an environment of a silicon compound and ammonia at an elevated temperature of 750° C. to 850° C. Then the surface coating, preferably silicon nitride is deposited. The wafer also receives a coating of the Back-Surface Field (BSF) to increase the efficiency of the cell. It comprises of depositing of a heavily doped p++ layer at the back of the cell usually aluminum. The aluminum containing paste is applied at the back of the cell by screen printing technique and then it transferred to a furnace where the cell is heated to a temperature of 200° C., so that newly applied paste can diffuse. Busbar pads are used to solder interconnects onto the cells thereby connecting one cell to other. It is applied by using the same technique as of the BSF, except silver paste is applied instead of Aluminum.

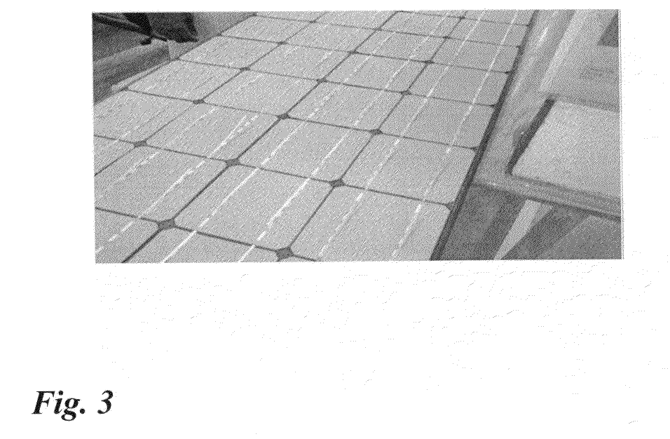

FIG. 3 is a schematic of untabbed PV cells at BP Solar in Riyadh where the assembling process was investigated. The steps are summarized as follows:

(i) Pure copper strips are soldered over the busbar pad from the top (n-doped) of the cell to the bottom (p-doped) of the next cell to connect them in series. The soldering temperature is about 280° C.
(ii) Next the soldered cells are kept in between two encapsulant layers (Ethylene-Vinyl Acetate) and placed over the top of a white tedlar back-sheet. A float glass is then positioned over the top of the laminate and the whole assembly is kept in a laminator. The assembly is heated to 150° C. for about 12 minutes. The heating is done so that the encapsulant layers melt and cover the empty spaces plus adds adhesion in between so that the assembly converts into a single laminate after cooling to room temperature.

A junction box (J-box) is fixed below the panel and the panel is fixed with an aluminum frame. The frame is sealed by butyl rubber.

A solar cell faces a number of temperature changes during the above-described manufacturing process. When silicon is solidified after purification, it may result in internal tension. However, due to slow cooling rate, internal stresses might be negligibly small. Then there are the stresses caused by the sawing process after the growth to form an ingot. Here, it is assumed that purely elastic deformations occur in the wafer, Pander M., 2010, “Mechanische Untersuchungenan Solarzellen in PV-Modulenmittels Finite-Elemente-Modellierung,” Hochschuleftür Technik, Wirtschaft and Kultur Leipzig (FH), incorporated by reference herein. The pure Si wafer, under these assumptions, is regarded as a stress-free. But, stresses may arise due to the screen printing and coating processes as they are done at high temperatures. Due to the difference in thermal expansion of aluminum at the back and silver on the top, it may induce significant stresses within the cell. Next, the cell is heated to temperatures between 230° C. and 300° C. depending on the soldering alloy. To reduce the temperature difference, the cells are usually preheated to a temperature of 120° C. During the lamination process heating takes place to a temperature of 150° C. (curing temperature of EVA). In this step, all of the components of a solar module expand, and are unbound to one another at that instant. The subsequent cooling causes the encapsulant to bind all the components. Due to different CTEs of components, each restrains one another inducing thermo-mechanical stresses. As a simple assumption it can be stated that all the components of the laminate are stress free at 150° C. Table 2 gives the summary of the processes described.

TABLE 2
Temperatures of PV components during manufacturing

| Process | Components | Condition |
|---|---|---|
| Cz process | Si wafer | Sawing after growing |
| | | crystals |
| Doping | Si wafer | Heated from 700° C. to |
| | | 850° C. |
| Deposition of the ARC | Cell | Heated from 750° C. to |
| | | 850° C. |
| Deposition of BSF & | Cell | Heated to 200° C. |
| Busbar pads | | |
| Soldering | Cell. Interconnects | Heated to 280° C. |
| Lamination | All | Heated to 150° C. |

A PV module may be subjected to four types of loading while at service. Wiese S., Meier R., Kraemer F., and Bagdahn J., 2009, “Constitutive Behaviour of Copper Ribbons Used in Solar Cell Assembly Processes,” EuroSimE 2009-10^{th} International Conference on Thermal, Mechanical and Multi-Physics Simulation and Experiments in Microelectronics and Microsystems, IEEE, pp. 1-8, incorporated by reference herein:

(i) Mechanical Loads
Wind is a source of mechanical load on the module. Heavy winds may be a reliability concern for a PV module. Similarly, snow accumulation over the top of glass surface for long periods and its intrinsic weight induce creeping effects on the structure.

(ii) Thermal Loads
As stated earlier, a PV module is aged due to consecutive alternation of day and night and seasonal temperature variations. Therefore, thermo-mechanical stresses are induced and may cause failures due to fatigue in certain components.

(iii) Radiation
UV rays from sun decreases the functionality of the polymeric sheet deployed as encapsulant material by either yellowing the medium (decreases the transparency of encapsulant) or by destruction of chemical bonds (decreases the adhesion).

(iv) Chemical Loads
Moisture in the form of damp heat is the main cause of corrosion. Moisture reacts with the polymeric sheet which introduces chemicals within the interface. These chemicals corrode the components of PV module.

Failure is defined as the change in properties of a structure, machine or machine part that makes it inept to perform its intended functions. The occurrence of such failure is through physical means which are known as failure modes, Collins J. A., 1993, Failure of Materials in Mechanical Design: Analysis, Prediction, Prevention, John Wiley & Sons, incorporated by reference herein. In the case of PV modules, failure may be stated as when the module is not capable of producing power as per its specification due to degradation caused by failure modes. While operating in the field a PV module is subjected to various loading conditions. A number of failures have been reported during the course of its operation. Such failures have been adequately described in Munoz M., Alonso-García M. C., Vela N., and Chenlo F., 2011, “Early Degradation of Silicon PV Modules and Guaranty Conditions,” Solar Energy, 85(9), pp. 2264-2274, and Wohlgemuth J. H., 2010, Overview of Failure Mechanisms and PV Qualification Tests, Photovoltaic Module Reliability Workshop 2010, Denver, Colo., incorporated by references. During the last decade, PV industry has constantly been trying to decrease the thickness of silicon cells as this will help to decrease the manufacturing cost and to increase the cell's performance Beck M., Gonzalez P., Gruber R., Tyler J., and Solar F., “Thin Film Module Reliability—enabling solar electricity generation,” incorporated by reference herein. It is reported that in the last few years, thickness of silicon wafers has decreased from 300 μm to 200 μm today Mason N. B., 2007, “Industry Developments that Sustain the Growth of Crystalline Silicon PV Output,” Proceedings of the Photovoltaic Science, Applications & Technology Conference, Durham, pp. 28-30, incorporated by reference herein, and is expected to decrease to 100 μm by the year 2020, Poortmans J., and Beaucarne G., 2006, “Thin, Thinner, Thinnest: An Evolutionary Vision on Crystalline Silicon Solar Cell Technology,” 21st European Photovoltaic Solar Energy Conference 2006, pp. 554-559, incorporated by reference herein. But with the reduction in thickness, cell area has increased up to 210 mm×210 mm. These factors have made the cells more susceptible to warpage and ultimately cracking. These problems arise because of the thermally induced stresses during soldering and lamination which eventually lead to cracking during operation. Direct mechanical stressing due to snow and ice accumulation over the top surface has also been regarded as the reason for such failure.

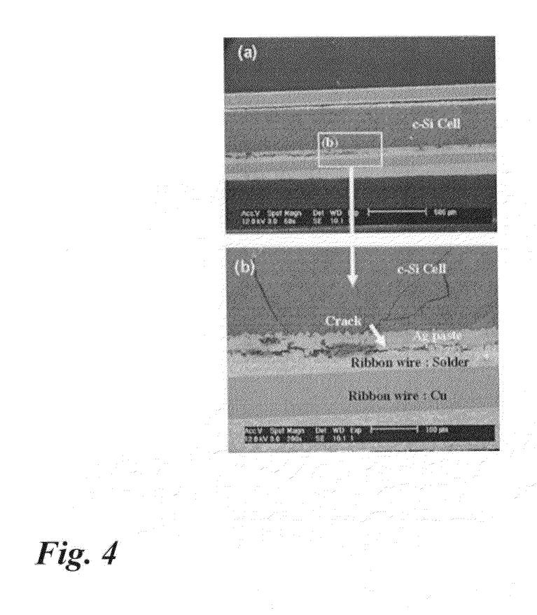

FIG. 4 is a captured image for cracks in cells for an aged PV module, Jeong J.-S., Park N., and Han C., 2012, “Field failure mechanism study of solder interconnection for crystalline silicon photovoltaic module,” Microelectronics Reliability, 52(9-10), pp. 2326-2330, incorporated by reference herein. The thickness of interconnects range from 100 μm to 150 μm whereas for the solder bond is only about 15 μm to 20 μm. Such small thicknesses make them easily vulnerable to damage. These components are already pre-stressed as they have gone through the soldering process. Furthermore, during operation they undergo temperature cycles of day and night causing fatigue which leads to breakage. This failure mechanism is shown in FIG. 4.

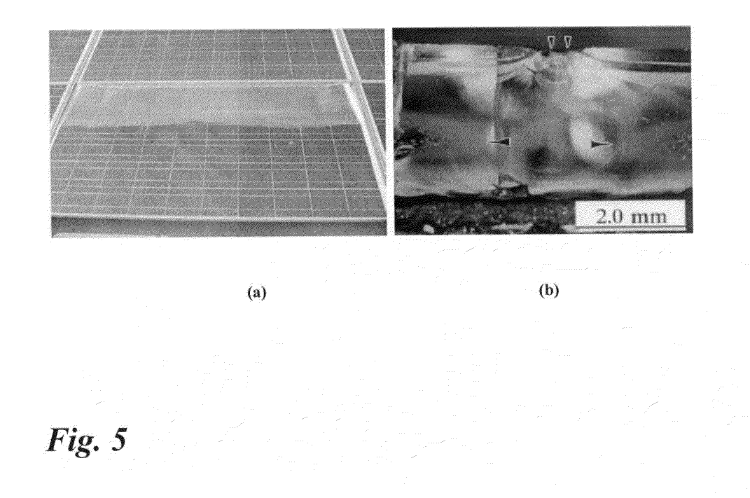

Detachment is basically the separation of the frame whereas FIG. 5 (a), King D. L., Quintana M. a., Kratochvil J. a., Ellibee D. E., and Hansen B. R., 1999, “Photovoltaic module performance and durability following long-term field exposure,” AIP Conference Proceedings, ALP, pp. 565-571 incorporated by reference herein, shows delamination, which is the loss of adherence of the encapsulant material. Both the failures are originated when PV modules operate under hot and humid climates. When such a phenomenon occurs, it may cause foreign impurities to enter and react with the constituents of the module producing gases which may be seen in the form of bubbles over the surface. The damp heat causes moisture ingress which corrodes the components of the module. Another reason is the use of stiff adhesive which loses its adhesion under thermocycling. Glass provides mechanical rigidity to the module being the thickest layer within the laminate. If the glass is not strong enough, cracks and fractures may induce due to direct mechanical loading on the top surface. Such cracks are harmful as they provide open invasion of environmental impurity to react with the inner components of the laminate. It is generally caused due to stresses induced by hail, storm, and snow and ice accumulation. FIG. 5 (b), King D. L., Quintana M. a., Kratochvil J. a., Ellibee D. E., and Hansen B. R., 1999, “Photovoltaic module performance and durability following long-term field exposure,” AIP Conference Proceedings, AIP, pp. 565-571 incorporated by reference herein, shows the damage in glass due to windblown roofing gravel.

For more than 25 years, Ethylene-Vinyl Acetate (EVA) has been used as an encapsulant in PV module industry. It is prioritized over other encapsulants due to its low cost. However, EVA encapsulants have shown problems in the field and its failures have been studied through accelerated aging tests. The EVA produced acetic acid in moisture which could catalyze the corrosion process, Kempe M. D., Jorgensen G. J., Terwilliger K. M., McMahon T. J., Kennedy C. E., and Borek T. T., 2007, “Acetic acid production and glass transition concerns with ethylene-vinyl acetate used in photovoltaic devices,” Solar Energy Materials and Solar Cells, 91(4), pp. 315-329, incorporated by reference herein. It was also seen that the glass transition of EVA starts at temperatures less than −15° C., which decreases the compliancy of EVA and may cause mechanical problems due to wind and snow in regions with the cold climate. Accelerated aging tests are performed to photovoltaic modules to find out the effect of ultraviolet (UV) radiation which the disruption of bonds of EVA prescribed by its yellowing, Kempe M. D., 2010, “Ultraviolet light test and evaluation methods for encapsulants of photovoltaic modules,” Solar Energy Materials and Solar Cells, 94(2), pp. 246-253, and Kempe M. D., 2008, “Accelerated UV test methods and selection criteria for encapsulants of photovoltaic modules,” 2008 33rd IEEE Photovolatic Specialists Conference, IEEE, pp. 1-6, incorporated by references herein.

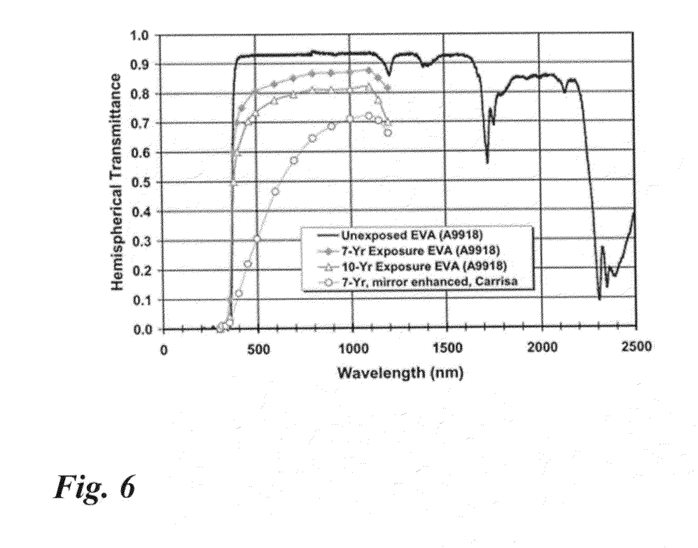

FIG. 6 shows some of the aged samples of EVA that were tested and compared in Sandia labs, King D. L., Quintana M. a., Kratochvil J. a., Ellibee D. E., and Hansen B. R., 1999, “Photovoltaic module performance and durability following long-term field exposure,” AIP Conference Proceedings, AIP, pp. 565-571, incorporated by reference herein. UV exposure, damp heat and 30× concentration tests were performed encapsulant samples which were the variants of EVA and silicones. It was found that EVA had a great tendency to react with moisture, McIntosh K. R., Cotsell J. N., Cumpston J. S., Norris A. W., Powell N. E., and Ketola B. M., 2009, “An optical comparison of silicone and EVA encapsulants for conventional silicon PV modules: A ray-tracing study,” 2009 34th IEEE Photovoltaic Specialists Conference (PVSC), IEEE, pp. 000544-000549, incorporated by reference herein.

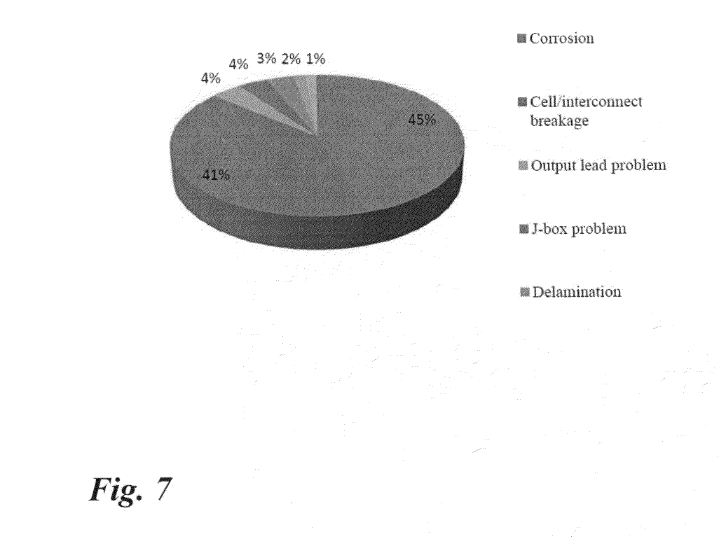

A number of failures have been reported during the course of its operation. Wohlgemuth et al. have gathered commercial PV module returns under warranty of BP Solar/Solarex from 1994 to 2005, Wohlgemuth J. H., Cunningham D. W., Nguyen A. M., and Miller J., 2005, “Long Term Reliability of PV Modules,” 20th European Photovoltaic Solar Energy Conference, IEEE, pp. 1942-194, incorporated by reference herein. Each product was examined and the cause of failure was found. FIG. 7 is a summary of the cause of failure. It is seen that corrosion and cell/interconnect breakage have the highest part in failure. Wohlgemuth et al. have concluded that cell breakage during operation is due to pre-damaged cells during soldering. Wiese et al. have attributed interconnect breakage to fatigue as a result of thermocycling, Wiese S., Meier R., and Kraemer F., 2010, “Mechanical Behaviour and Fatigue of Copper Ribbons used as Solar Cell Interconnectors,” 2010 11th International Thermal, Mechanical & Multi-Physics Simulation, and Experiments in Microelectronics and Microsystems (EuroSimE), IEEE, pp. 1-5, incorporated by reference herein. Such failures deteriorate PV module performance, ultimately affecting its life.

The encapsulant is defined as a protective material to completely wrap up and segregate the silicon cells from moisture, heat and mechanical damage in addition to good optical contact between the surface of PV cells and the outer coating, Poulek V., Strebkov D. S., Persic I. S., and Libra M., 2012, “Towards 50 Years Lifetime of PV Panels Laminated with Silicone gel Technology,” Solar Energy, 86(10), pp. 3103-3108, incorporated by reference herein. Good thermal conduction has also been defined as a property of encapsulant, Dhere N. G., 2005, “Reliability of PV modules and balance-of-system components,” Conference Record of the Thirty-first IEEE Photovoltaic Specialists Conference, 2005., IEEE, pp. 1570-1576, incorporated by reference herein. The encapsulant defined as a polymeric material that is used to provide electrical insulation and protection from mechanical damage and environmental corrosion. In addition to this, there are certain desirable properties which come with an encapsulant and link to the performance of a PV module. Table 3 provides a list of desired properties and the dependence of PV module performance to them. A good transparent encapsulant and such which prevents its yellowing through resistance of UV radiation provides a means of more transmittance of light and thus more electrical power. Higher the thermal conductivity of the encapsulant polymer, more will be the heat removed absorbed by cells through natural convection or by attaching an auxiliary thermal collector. An encapsulant should also be in its solid state within the operating range of the module and its glass transition temperature should be far from this range, as the sudden change of properties might decrease the compliancy or adhesiveness of the encapsulant material.

TABLE 3
Desired properties of encapsulant and
their link with PV module performance

| Properties | Performance |
|---|---|
| Good transmittance of light | Electrical Performance |
| Good thermal conduction | Thermal performance |
| Long operational temperature | Structural performance |
| range | |
| UV radiation resistant | Electrical performance |
| Good compliancy | Structural performance |
| Low glass transition temperature | Structural performance |
| Long life | Structural performance |

Studies on the reliability and failure observed during its operation began in the 1980s, Osterwald C. R., and McMahon T. J., 2009, “History of Accelerated and Qualification Testing of Terrestrial Photovoltaic Modules: A Literature Review,” Progress in Photovoltaics: Research and Applications, 17(1), pp. 11-33, incorporated by reference herein. It has led to the design of certain certification methods for PV modules such as ASTM E1171-09, ASTM E1830-09 etc. These standards are generally test methods to determine the ability of a PV module to withstand thermo-mechanical stresses under heat, humidity, static and dynamic loads etc. ASTM E1171-09 deals with accelerated aging test using temperature cycles to simulate effect of day and night.

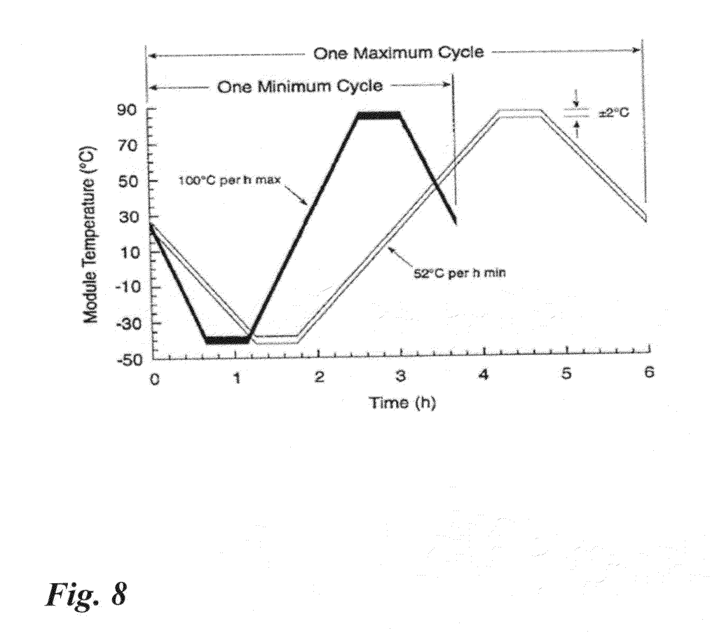

FIG. 8 is a chart showing that the temperature cycle test of ASTM E1171-09 is used to predict the effect of thermo-mechanical stresses. The module is run under accelerated aging test from 50 to 200 cycles between temperatures from −40° C. to 85° C. Similarly, according to ASTME1830-09 for the mechanical testing of wind effects, load of 2400 Pa is applied, both on the front side (wind pressure) and at the back (suction) of the module. This corresponds to a wind speed of 130 km/h with a safety factor of 3 for gusty winds. The burden is on surface is maintained for 1 hour. To simulate the effect of snow and ice deposits, a load of 5400 Pa is applied to the front of module. The implementation of the temperature testis carried out in a climatic chamber with automatic temperature control and air circulation. The total cycle time must not be greater than 6 hours. The minimum time for isothermal condition is about 30 minutes and the heating rate can be up to a maximum of 100° C./h.20

Qualification tests are generally used by manufacturers to determine the ability of a module to work under environmental conditions. It is also used by customers, to qualify it for purchase. But such standards are only beneficial to find design failures or failures which may occur during the infant mortality period for a module under test. This has been proven by evaluating qualified module failures under service, Wohlgemuth J. H., and Kurtz S., 2011, “Using accelerated testing to predict module reliability,” 2011 37th IEEE Photovoltaic Specialists Conference, IEEE, pp. 003601-003605, incorporated by reference herein. Thus, different manufacturers have developed their own reliability testing procedures by altering the conditions of tests mentioned in the standards. In the case of temperature cycles this is usually done by either increasing the test duration (no. of cycles) or by using higher stress levels (increasing the upper temperature limit and decreasing the lower one). The level of alteration and its relation to module life is determined by equalizing the failures caused by long-term field testing and reliability assessment.

BP Solar has estimated the link between reliability testing and the number of years of life through thorough experimentation by altering the no. of temperature cycles of the standard IEC61215, Wohlgemuth J. H., Cunningham D. W., Monus P., Miller J., and Nguyen A., 2006, “Long Term Reliability of Photovoltaic Modules,” 2006 IEEE 4th World Conference on Photovoltaic Energy Conference, IEEE, pp. 2050-2053, incorporated by reference herein. Table 4 summarizes these findings.

TABLE 4
Link between no. of temperature cycles and life of a PV module used by
BP Solar

| No. of | Life |
|---|---|
| Temperature Cycles | (years) |
| 50 | 2 to 2.5 |
| 200 | 10 |
| 400 | 20 |
| 500 | 25 |

The usual warranty given by a PV module manufacturer is “25 years of life with 20% reduction in power output”. This has been found out by accelerated aging tests where their extremity has been linked with the no. of years of life. Thus, it can be said that it is quite a rough estimate of PV module life. It is also not convenient to wait assess the durability of a PV module for such long times as technology changes are rapid. Furthermore, accelerated aging tests account for a fixed temperature cycle and neglect the effect of different operating environments of PV modules. The long life of modules may help them to reach grid parity. Thus, a numerical model is required which accounts of life as well as the operating conditions of PV module. This model will be helpful in determining the pros and cons of design changes.

FE modeling is a good tool to assess the durability of PV module. But some have modeled only cell strings while others have idealized the material behavior to temperature independent linear elastic. Hence, there is need of a comprehensive model which captures the actual behavior of PV modules. This comprehensive model should be able to be used with thermal and life prediction models to incorporate the effect of operating conditions and estimate reliability respectively.

By viewing the voids within this field, the present disclosure addresses the following:
(i) To develop a comprehensive FE structural model and validate to find the reason of dominant mode of failure.
(ii) Couple a transient thermal model for PV modules with a structural model to include the effect of operating conditions.
(iii) Couple a life prediction model using the outcomes of (ii) and predict lifetime through the meteorological data of representative days of a year.
(iv) Identify encapsulant polymer by the model developed on the basis of overall performance of PV module and its life.

Literature shows some recent efforts in modeling and studying the structural behavior of PV module through Finite Element (FE) Analysis. Chen et al. developed a structural model which was used estimate cell warpage and residual stress induced during soldering, Chen C.-H., Lin F.-M., Hu H.-T., and Yeh F.-Y., Residual Stress and Bow Analysis for Silicon Solar Cell Induced by Soldering, incorporated by reference herein. The pre-stress in the cell during assembly was studied, Wiese S., Kraemer F., Betzl N., and Wald D., 2010, “The Packaging Technologies for Photovoltaic Modules—Technological Challenges and Mechanical Integrity,” 3rd Electronics System Integration Technology Conference ESTC, IEEE, pp. 1-6, incorporated by reference herein. The variation of stress in cells was also studied by changing Young's modulus, yield strength and geometry of copper ribbon. The impact on stress in cell due to the composition of solder alloy was also viewed. Eitner et al. have applied uniform temperature loads from 150° C. to −40° C. to the model and have calculated thermal stresses in a static time independent analysis, Either U., Altermatt P. P., Kontges M., Meyer R., and Brendel R., 2008, “A Modeling Approach to the Optimization of Interconnects for Back Contact Cells by Thermomechanical Simulations of Photovoltaic Modules,” 26th European Photovoltaic Solar Energy Conference, Hamburg, pp. 258-260, incorporated by reference herein. The variation of stress and electrical loss is also compared for different interconnect designs. Dietrich et al. have assessed thermo-mechanical behavior of a three cell interconnected string using sub-modeling procedure, Dietrich S., Pander M., Sander M., Schulze S. H., and Ebert M., 2010, “Mechanical and Thermomechanical Assessment of Encapsulated Solar Cells by Finite-Element-Simulation,” Reliability of Photovoltaic Cells, Modules, Components, and Systems III, SPIE, p. 77730F-77730F-10, incorporated by reference herein. PV module warpage and cell gap displacements were calculated during the lamination procedure. A parametric study was also performed with respect to encapsulant thickness to see its effect on deflection and stress in cells. Gonzalez et al. [have used their structural model to study the effect of encapsulant and cell dimensions on the thermal stress developing in cells and interconnects, Gonzalez M., Govaerts J., Labie R., De Wolf I., and Baert K., 2011, “Thermomechanical Challenges of Advanced Solar Cell Modules,” 2011 12th Intl. Conf. on Thermal, Mechanical & Multi-Physics Simulation and Experiments in Microelectronics and Microsystems, IEEE, pp. 1/7-7/7, incorporated by reference herein. This was done by performing a parametric study to view the consequence of encapsulant material, encapsulant thickness and cell thickness on the thermal stresses in cells. The conclusion of the work was that the stresses in cells are less for soft and thin encapsulant and thick PV cells, Eitner U., Kajari-Schroder S., Marc K., and Altenbach H., 2011, Thermal Stress and Strain of Solar Cells in Photovoltaic Modules, Shell-like Structures, Springer Berlin Heidelberg, Berlin, Heidelberg, incorporated by reference herein.

Eitner et al. have performed FE simulations for a 60 cell module during thermal cycling after validating their model with the experiment they have performed in, Eitner U., Kontges M., and Brendel R., 2009, “Measuring Thermomechanical Displacements of Solar Cells in Laminates Using Digital Image Correlation,” 200934th IEEE Photovoltaic Specialists Conference (PVSC), IEEE, pp. 001280-001284, incorporated by reference herein. Siddiqui and Arif have developed a model to determine the thermal stresses in cell during temperature variations of a day, Siddiqui M. U., and Arif A. F. M., 2012, “Effect of Changing Atmospheric and Operating Conditions on the Thermal Stresses in PV Modules,” 11th Biennial Conference on Engineering Systems Design and Analysis, Nantes, and Siddiqui M. U., 2011, “Multi-physics Modeling of Photovoltaic Modules and Arrays with Auxiliary Thermal Collectors,” M. S Thesis, King Fahd University of Petroleum and Minerals, incorporated by references herein. One of the most important aspects of modeling is the material model. The closer it gets to real life situation of a material, the better are outcomes of a numerical simulation. Chen et al. developed a 2D shell model of a single cell with aluminum back surface field (BSF), copper and solder. All materials were modeled as temperature independent elastic perfectly plastic. Wiese et al. have modeled copper, silver (busbar) and aluminum BSF as bilinear and silicon as linear elastic. Eitner et al. have modeled a 3D nine cell string with 2D plane stress back contacts for the string. Dietrich et al. have assessed thermo-mechanical behavior of a three cell interconnected string using a 3D FE model and have included the effect of metallization paste used in soldering using sub-modeling procedure. Gonzalez et al. have modeled a back contact PV module using 3D elements by idealizing copper as a layer in between silicon and the encapsulant. Either et al. have modeled a 60 cell module as 3D without incorporating the interconnects. They have used temperature dependent properties for silicon and modeled it as an orthotropic material. They also have performed DMA and relaxation tests on Ethylene-Vinyl Acetate (EVA) to develop a viscoelastic model, Eitner U., Kajari-schroder S., Kontges M., and Brendel R., 2010, “Non-linear Mechanical Properties of Ethylene-Vinyl Acetate (EVA) and its Relevance to Thermomechanics of Photovoltaic Modules,” 25th European Photovoltaic Solar Energy Conference, Valencia, pp. 4366-4368, incorporated by reference herein. The viscoelastic model was compared with linear and temperature dependent model for EVA.

It was found that the viscoelastic model matched close to the experimental results of cell gap displacement. Siddiqui and Arif developed a PV model using 3D layered shell elements by defining layers of different materials within. They have also used a 3D solid model to couple an auxiliary heat exchanger to the PV module. Interconnects were not modeled and all panel materials were assumed to be temperature independent linear elastic. The model was used to determine the effect of changing operating conditions on the stressing of PV module. The material modeling in the literature is summarized in Table 5. In almost all the previous work discussed either the lamination process was studied or IEC 61215 standard thermal test cycle (80° C. to −40° C.) was simulated or both of them were studied. Lamination process actually comprises the curing of the encapsulant material which for EVA is heating at 150° C. and cooling to room temperature. The selection of strain-free temperature was also different for them. It gives the initial state or the stress-free state of the model and has significant impact on the results of simulation. Eitner et al. have assumed a strain-free temperature of 150° C. to study lamination and temperature cycle of IEC 61215. Gonzalez et al. have used a strain-free temperature of 100° C. Dietrich et al. used a strain-free temperature of 150° C. to simulate the lamination process. The study of the IEC 61215 temperature cycle comprised 20° C. as the strain-free temperature. Siddiqui and Arif have coupled a three dimensional numerical thermal model to the structural model of PV module. Thermal stresses were evaluated during the temperature variations of the day. Thus, their transient analysis was capable to simulate the effect of real-life environmental conditions.

TABLE 5
Summary of the material models used for the components of a
PV module in the literature. T.I stands for temperature
independent, T.D stands for temperature dependent and
BISO stands for bilinear isotropic hardening model

| | | EVA | Copper | | | Alu- | |
|---|---|---|---|---|---|---|---|
| Refer- | | Encap- | Inter- | Silver | Silicon | minum | Back- |
| ences | Glass | sulant | connects | Paste | Cells | BSF | sheet |
| [32] | N.A | N.A | Perf. | Perf. | Perf. | Perf. | N.A |
| | | | Plastic | Plastic | Plastic | Plastic | |
| [11] | N.A | N.A | T.D. | T.D. | T.I | Non- | N.A |
| | | | BISO | BISO | | Linear | |
| [33] | N.A | N.A | T.D. | T.D. | T.D | T.D. | N.A |
| | | | BISO | BISO | | BISO | |
| [34] | T.I | T.I | N.A | N.A | T.I | N.A | T.I |
| [35] | T.D | T.D | T.D | N.A | T.D | N.A | N.M |
| [36] | T.I | T.I | Perf. | N.A | T.I | N.A | T.I |
| | | | Plastic | | | | |
| [37] | T.I | Visco- | N.A | N.A | T.D | N.A | T.I |
| | | elastic | | | | | |
| [39] | T.I | T.I | N.A | N.A | T.I | N.A | T.I |

Both models are used in conjunction to calculate absorbed solar radiation. This factor is used in thermal and electrical models to determine cell temperature and efficiency of the PV module respectively. Various radiation models are disclosed and implemented and a comparative study was performed to evaluate the prediction performance. The compared models included isotropic, Hay & Davies, Hay-Davies-Klucher-Riendl (HDKR) and Perez models. Experimental data for the representative simulated days was used to find that the Isotropic radiation model is the simplest and the most conservative whereas the Perez model had the highest over-prediction. HDKR model showed minimum mean bias error. Thus, the HDKR model was implemented as its prediction was closest to the actual values.

Thermal models of PV modules are developed to evaluate the temperature field. Most of the previous work deals with the one-dimensional model which calculates temperature variations along thickness of the module. A three dimensional numerical model was developed to predict temperature field in a PV module, with and without cooling. The absorbed solar radiation from the HDKR model was used as an input to the model. This absorbed radiation was divided into two portions. One dealt with the generation of electrical energy, whereas the other one was consumed in temperature rise of the components of PV module. It was applied in the form of internal heat generation in cells. Convection was applied to the top and bottom of the module using a correlation incorporating wind speed. Layered-shell elements were used to define the layered structure of PV module without cooling. Interconnects were not modeled. The model was validated using experimentally measured data and against the normal operating conditions temperature (NOCT) reported in the simulated module datasheet. A parametric study was performed under varying atmospheric and operating conditions.

The performance of a PV module is estimated through its electrical efficiency. To estimate electrical performance, various electrical models have been developed. The inputs of such models are generally the absorbed radiation and the operating temperature of PV cells. Several electrical models have been discussed. These include models in which temperature and radiation scaling of reference parameters, interpolation of I-V curves, empirical derivation of correlations and electrical circuit modeling are done. Three electrical models were selected for comparison with the five parameter model. The parameter estimation was done through multi-variable optimization technique known as the Nelder-Mead simplex search algorithm. The three performance models were the four parameter electric circuit model, Townsend T. U., 1989, “A method for predicting the long-term performance of directly-coupled photovoltaic systems,” University of Wisconsin, Madison, incorporated by reference herein. Sandia labs model, King D. L., Boyson W. E., and Kratochvil J. A., 2004, Photovoltaic array performance model, Sandia National Laboratories: New Mexico, N. Mex., USA, incorporated by reference herein, and Villalva et al. Villalva M. G., Gazoli J. R., and Filho E. R., 2009, “Comprehensive Approach to Modeling and Simulation of Photovoltaic Arrays,” IEEE Transactions on Power Electronics, 24(5), pp. 1198-1208, incorporated by reference herein. Electric circuit model. These models were compared by simulating the performance of a total of six PV modules including three crystalline and three thin film cell modules. It was seen that the new parameter estimation methodology provided comparable results to other models and better than the five parameter model when the parameter estimation methodology of Villalva et al. was used. Next, a sensitivity analysis was performed to find the relative importance of five model parameters which are light current (IL), diode reverse saturation current (Io), modified diode ideality factor (a), series resistance (Rs) and shunt resistance (Rsh). It was found that IL and a are more sensitive than the other three parameters by several orders. By viewing the impact of these parameters, a seven parameter model was proposed. Two new parameters were introduced which actually are the irradiance dependence for IL (m) and temperature dependence for a (n). These were estimated using a secondary optimization routine by minimizing the objective function. This model showed improvement in the electrical performance prediction accuracy.

For three dimensional temperature distribution, a thermal model was utilized as described by Siddiqui and Arif. The energy equation of heat transfer for each layer is given by Eq. (1), where i represents the number of layers.

$${ρ}_{i} {C}_{pi} \frac{\partial {T}_{i} ( x , y , z )}{\partial t} = ∇ \cdot ( {q}_{i} ) + {Q}_{i} \cdot i = 1 , 2 , … , n \qquad ( 1 )$$

The classical linear elasticity theory has been discussed. Total strain is given as the sum of elastic strain and thermal strain as in Eq. (2). These strains are the result of mechanical loading and thermal expansion due to temperature change.

{∈}={∈^{el}+∈^{th}} (2)

Here,

{∈}={∈ₓ∈_{y}∈_{z}γ_{xy}γ_{yz|}γ_{xz}}^{T}

is the total strain vector, {∈ₑₗ} is the elastic strain vector and {∈ₜₕ} is the thermal strain vector. In a three dimensional case, thermal strain vector can be given as Eq. (3).

{∈^{th}}={αₓα_{y}α_{z}0 0 0}^{T}·(T−T_{ref}) (3)

where, αᵢ is the linear Coefficient of Thermal Expansion (CTE) in iₜₕ direction (i=x, y, z), T is the current temperature and _{ref} T is the initial temperature. From Hooke's law, elastic strain is given as Eq. (4).

{∈^{el}}=[S]{σ} (4)

where, [S] is the compliance matrix given in Eq. (8) for an isotropic material and

{σ}={σₓσ_{y}σ_{z}σ_{xy}σ_{yz}σ_{xz}}^{T}

is the stress vector.

σ=[D]({∈}−{∈^{th}}) (5)

σ=[D]({∈}−{αₓα_{y}α_{z}0 0 0}^{T}·(T−T_{ref})) (6)

The Material properties matrix [D] in Eq. (5) is the inverse of compliance matrix. Eq. (6) gives the constitutive relation for thermo-mechanical induced stresses. When temperature is increased in a material, the amplitude of vibration of the atoms increases with respect to their equilibrium position and leads to larger inter-atomic distances. This results in an increase in geometric dimensions of a material under subject. The thermal expansion coefficient describes the relative change in length of a body at a temperature change of 1 K. The coefficient depends on the strength of the inter-atomic bonds. Materials with strong bonds have a lower CTE, i.e., their expansion or contraction due to temperature change is lesser than those materials having a higher CTE. The encapsulant material used in PV modules is a polymer. In polymers there are strong covalent bonds along the chain molecules, while the secondary bonds between the chains are weak. This leads to relatively large coefficient of expansion. The CTE of polymers is temperature dependent and it changes its behavior significantly above the glass transition temperature. The glass transition is the reversible transition in polymer materials from a hard and relatively brittle state into a molten or rubber-like state. The CTE is defined by Eq. (7) where LO is the original length of the heated specimen.

$$α ( {T}_{o} , T ) = \frac{{L}_{F} - {L}_{O}}{{L}_{O} ( T - {T}_{O} )} = \frac{1}{{L}_{O}} \cdot \frac{Δ L}{Δ T} \qquad ( 7 )$$

TABLE 6
Comparison of the material modeling used in the literature along
with the material model used in the current work. T.D stands
for Temperature Dependent; T.I stands for Temperature
Independent and BISO stands for Bilinear Isotropic

| | | | | | | | Tedlar |
|---|---|---|---|---|---|---|---|
| | Float | EVA | Cu | Ag | Si | Al | Back- |
| Ref. | Glass | Encap. | Connects | Paste | Cells | Paste | sheet |
| [35] | T.D | T.D | T.D | N.A | T.D | N.A | N.M |
| [36] | T.I | T.I | Perf. | N.A | T.I | N.A | T.I |
| | | | Plastic | | | | |
| [37] | T.I | Visco- | N.A | N.A | T.D | N.A | T.I |
| | | elastic | | | | | |
| [34] | T.I | T.I | N.A | N.A | T.I | N.A | T.I |
| [33] | N.A | N.A | T.D. | T.D. | T.D | T.D. | N.A |
| | | | BISO | BISO | | BISO | |
| [11] | N.A | N.A | T.D. | T.D. | T.I | Non- | N.A |
| | | | BISO | BISO | | Linear | |
| [32] | N.A | N.A | Perf. | Perf. | Perf. | Perf. | N.A |
| | | | Plastic | Plastic | Plastic | Plastic | |
| * | T.I | Visco- | T.D. | N.A | T.D | N.A | T.I |
| | | elastic | BISO | | | | |

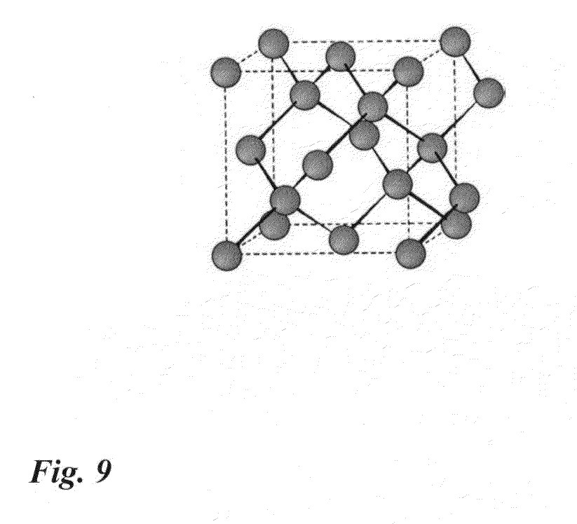

Keeping in view of the material models discussed in the literature, the following topics are intended to understand the actual behavior of materials. The element silicon is the most important component of most semiconductors and micro-electronic components. The wafer production procedure for making solar cells from both monocrystalline and polycrystalline silicon has been discussed earlier. The atoms of silicon are arranged in a diamond structure. This arises from two face-centered cubic (FCC) lattices as shown in FIG. 9. It is seen that each silicon atom is linked with four other atoms via covalent bond. The constellation of atoms and bonds of silicon are different in different directions therefore, silicon exhibits anisotropy. The silicon lattice also exhibits cubic symmetry so mutually perpendicular directions and planes within the lattice are equivalent. In case of anisotropy, the compliance tensor has 81 constants in Eq.(8). If the material properties of silicon wafers are described in a fixed arbitrary direction, the cubic symmetry of silicon lattice may be exploited to give compliance in matrix form as shown in Eq.(8). The experimentally determined values of elastic constants of the compliance of silicon oriented in the <100> directions is given in the literature Hoperoft M. A., Nix W. D., and Kenny T. W., 2010, “What is the Young's Modulus of Silicon?,” Journal of Microelectromechanical Systems, 19(2), pp. 229-238, incorporated by reference herein, and shown in Table 7. An orthotropic material has two or three planes of symmetry, thus compliance of silicon may be described by the expansion of Eq. (8) as shown, which will enable us to determine the Young's modulus (E), shear modulus (G) and Poisson's ratio (ν).

TABLE 7
Elastic constants for the compliance of Silicon.

| Compliance (S) | s₁₁ | s₁₂ | s₄₄ |
|---|---|---|---|
| ×10¹² Pa | 7.68 | −2.14 | 12.6 |

{∈^{el}}=[S]{σ} (8)

where,

$$[ S ] = [ \begin{matrix}{s}_{11} & {s}_{12} & {s}_{12} & 0 & 0 & 0 \\ {s}_{12} & {s}_{11} & {s}_{12} & 0 & 0 & 0 \\ {s}_{12} & {s}_{12} & {s}_{11} & 0 & 0 & 0 \\ 0 & 0 & 0 & {s}_{44} & 0 & 0 \\ 0 & 0 & 0 & 0 & {s}_{44} & 0 \\ 0 & 0 & 0 & 0 & 0 & {s}_{44}\end{matrix} ]$$

It can be further expanded to,

$$[ S ] = [ \begin{matrix}\frac{1}{{E}_{x}} & - \frac{{v}_{xy}}{{E}_{x}} & - \frac{{v}_{xz}}{{E}_{x}} & 0 & 0 & 0 \\ - \frac{{v}_{yx}}{{E}_{y}} & \frac{1}{{E}_{y}} & - \frac{{v}_{yz}}{{E}_{y}} & 0 & 0 & 0 \\ - \frac{{v}_{zx}}{{E}_{z}} & - \frac{{v}_{zy}}{{E}_{z}} & \frac{1}{{E}_{z}} & 0 & 0 & 0 \\ 0 & 0 & 0 & \frac{1}{{G}_{xy}} & 0 & 0 \\ 0 & 0 & 0 & 0 & \frac{1}{{G}_{yz}} & 0 \\ 0 & 0 & 0 & 0 & 0 & \frac{1}{{G}_{xz}}\end{matrix} ]$$

Glass structure used in PV modules is well transparent due to low iron content, so that a high transmission in usable range of the light spectrum (between 380 and 1200 nm) is achieved. The transmittance is almost 95%. Glass behaves as a completely elastic material and does not undergo plastic deformation within the module. It is also characterized by its excellent weather resistance, so that it prevents the effect of oxygen, water vapor and atmospheric pollution over the entire demanded period of 25 years. The thermal expansion coefficient is depends on the chemical composition of the glass being used.

For the back side isolation of crystalline solar modules there are a number of industrial solutions and within these solutions an important role is played by polyvinyl fluoride (PVF), Hoperoft M. A., Nix W. D., and Kenny T. W., 2010, “What is the Young's Modulus of Silicon?,” Journal of Microelectromechanical Systems, 19(2), pp. 229-238, incorporated by reference herein. PVF in the early sixties was introduced by the plastic manufacturer DuPont™ under the trade name Tedlar, DuPont, 1995, Tedlar technical information, incorporated by reference herein. PVF is characterized by low water absorption (<0.5%), good weather resistance, resistance to acids and alkalis, and has been tested over long periods of time in the outdoors. The film is designed for use between −72° C. and 107° C. It has a high electrical resistance and very good insulating properties. PVF is one of the few polymers that can be easily colored, with mostly white color is selected to achieve a high reflection, DeBergalis M., 2004, “Fluoropolymer films in the photovoltaic industry,” Journal of Fluorine Chemistry, 125(8), pp. 1255-1257, incorporated by reference herein. Most commonly, the solar module manufacturers produce a PVF/PET/PVF three-layer composite used that combines the best qualities of both materials. Additional Polyethylene-terephthalate (PET) layer improves the electrical insulation. It also helps to reduce cost as PVF is expensive.

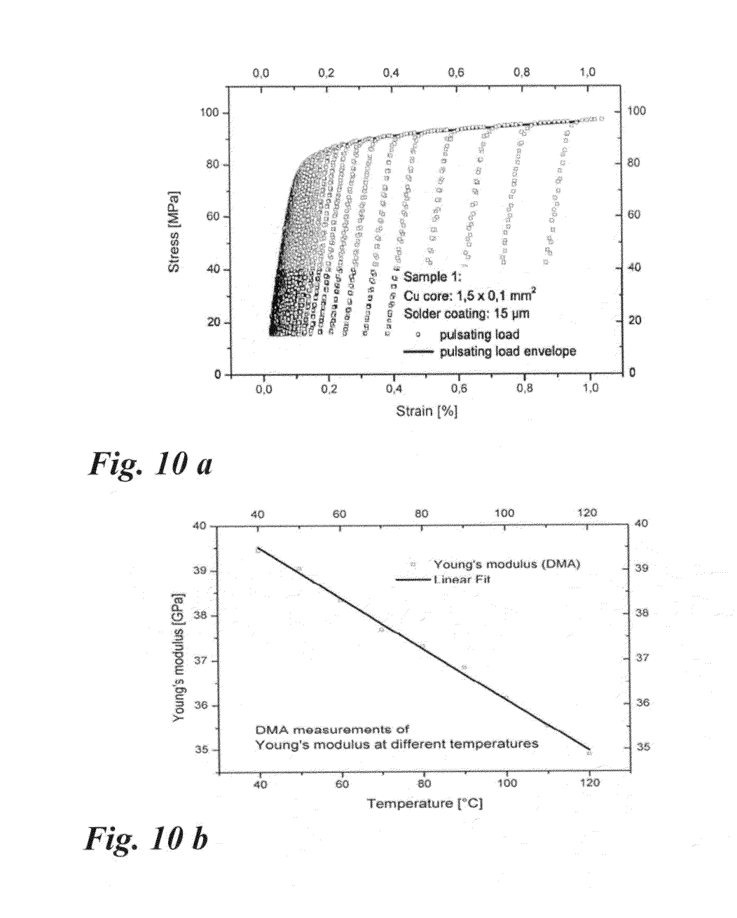

Steffen Wiese et al. conducted experiments on copper ribbons used for interconnections between cells. The experiments helped them to provide the yield stress and Young's modulus of copper. First they performed tensile tests on Zwick (FIG. 10(a)), which gave the stress-strain curie at room temperature. When DMA was carried out, it was found that the Young's modulus of copper changed with temperature as shown in FIG. 10 (b). Thus, they combined both the results to get the effective stress-strain curve of copper for a range of temperature between −40 to 125° C.

The Encapsulant widely used in PV industry is Ethylene-vinyl acetate (EVA) copolymer. The properties of EVA are largely dependent on vinyl acetate content within the polymer. By increasing the vinyl acetate content, crystallization is hampered, thus increasing the elasticity and weather resistance, stress crack resistance, stickiness and flexibility. Due to its amorphous structure EVA is transparent to provide hurdle-free transmittance of light. Its curing takes place at about 150° C. At this temperature the EVA-melted and polymeric chains are cross-linked so that polymer network forms. After cooling, it results in a permanent association with the module, to protect cells from environmental influences. Furthermore, additives are provided to prevent yellowing and aging caused by UV radiation, light and heat.

Viscoelastic materials are such that exhibit the behavior of both elastic and viscous materials. It is a property of viscous materials to strain linearly with time when load is applied. In contrast to this, elastic materials strain on the spot when stressed and return to their original state when load is removed. A hysteresis can be observed in the stress strain curve of such material as energy is lost while returning to its initial state. Hence, stress relaxation phenomenon is observed when a viscoelastic material is kept under constant strain. Similarly, creep occurs when constant stress is applied (strain increases). The time taken for the molecular rearrangements in a viscoelastic material, after being stressed occur on a time-scale comparable to that of the experiment performed on it. Therefore, the relation between stress and strains cannot be just described by material constants as it is in the case of purely elastic or viscous materials Ferry J. D., 1980, Viscoelastic Properties of Polymers, Wiley, incorporated by reference herein. The behavior of viscoelastic materials is characterized by its time and temperature dependency. Hence, the constitutive equation for a viscoelastic material in simple shear.

$$σ = {\int }_{0}^{I} R ( t - τ ) \frac{d ɛ}{d τ} d τ \qquad ( 9 )$$

σ=Cauchy stress
∈=Deviatoric strain
R(t)=Shear relaxation modulus
t=Current time
τ=Pseudo time

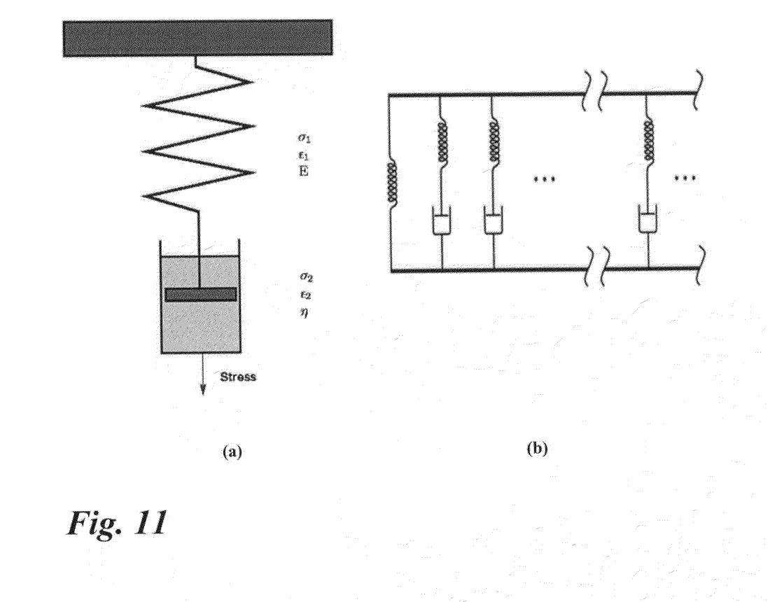

The shear relaxation modulus of viscoelasticity can be approximated by Maxwell's model through spring and dashpot configuration as shown in FIG. 11 (a). The spring depicts elastic part of a viscoelastic material whereas the dashpot represents the viscous part. Eq. (10) and Eq. (11) give the constitutive relation (disregarding the tensorial character of stress and strain) in shear for spring and dashpot respectively.

σ₁(t)=G∈₁(t)

σ₂(t)=η\dot{∈}₂(t) (10,11)

where,

η=viscosity of the dashpot
\dot{∈}₂(t)=rate of strain

For the elements attached in series as shown in FIG. 11 (a),

σ=σ₁=σ₂

\dot{∈}=\dot{∈}₁+\dot{∈}₂ (12)

It is understood that the stress and strains in the formulation are functions of time hence; it is not shown in some parts of the derivation for convenience. Here σ and ∈ represent the total stress and strain of the \dot{∈}₁ system. Taking time rate of change of Eq. \dot{∈}₂ (10) and substituting the value of in Eq. (12). Also, substituting from Eq. (11) to Eq. (12).

$$\dot{ɛ} ( t ) = \frac{\dot{σ} ( t )}{G} + \frac{σ ( t )}{η} \qquad ( 13 )$$

Eq. (13) gives the constitutive relation for Maxwell's model. Now, consider a cylindrical block of viscoelastic material loaded in uniaxial direction such that the strain is held constant. Then relaxation modulus of the spring can be given as,

$${R}_{1} ( t ) = \frac{{σ}_{1} ( t )}{{ɛ}_{1}} = \frac{G {ɛ}_{1}}{{ɛ}_{1}} = G ( t )$$

And for the dashpot,

$${σ}_{2} ( t ) = η \frac{d {ɛ}_{2}}{d t} = 0$$

$${R}_{2} ( t ) = \frac{{σ}_{2} ( t )}{{ɛ}_{2}} = 0$$

Substituting constant strain ∈0 in Eq. (13),

$$0 = \frac{\dot{σ}}{G} + \frac{σ}{η}$$

Rearranging,

$$\frac{d σ}{d t} = - \frac{G σ}{η}$$

Integrating on both sides,

$${\int }_{{σ}_{o}}^{σ} \frac{d σ}{σ} = - {\int }_{0}^{t} \frac{d G}{η} d t \\ ln ( σ ) - ln ( {σ}_{O} ) = - \frac{G}{η} t \\ σ ( t ) = {σ}_{O} {e}^{\frac{G}{η} t} \qquad ( 14 )$$

Now, relaxation modulus for the whole system can be given as,

$$R ( t ) = \frac{σ ( t )}{{ɛ}_{O}}$$

Substituting σ(t) from Eq. (14),

$$R ( t ) = \frac{{σ}_{O} {e}^{- \frac{G}{η} t}}{{ɛ}_{O}} = G {e}^{- \frac{G}{η} t}$$

But Relaxation time=

$$= τ = \frac{η}{G} , \\ therefore , \\ R ( t ) = G {e}^{- \frac{t}{τ}}$$

For a generalized case with n number of springs and dashpots are connected in parallel with a single spring element (shown in FIG. 11 (b)), the relaxation modulus is expressed by Eq. (15). Here G_{∞} is the shear modulus of the single spring element.

$$R ( t ) = {G}_{∞} + {\sum }_{i = 1}^{n} {G}_{i} {e}^{\frac{t}{{τ}_{t}}} \qquad ( 15 )$$

Eq. (15) takes the form of prony series. In our problem bulk modulus (K) is assumed to be constant with time as in most polymers, viscoelastic effects are much stronger in shear. The number of spring-dashpot elements is represented by n in Eq. (15).

Dynamic mechanical analysis (DMA) is used to characterize a material's response with respect to temperature and frequency by applying small cyclic deformations. It is useful in the study of viscoelasticity in polymers. The outcomes of this procedure is the storage modulus (E′) and the loss modulus (E″). The cumulative effect of both the moduli is called the complex modulus (E). The storage modulus gives the energy stored during deformation or the elastic part of viscoelasticity whereas, the loss modulus is the energy lost or converted to heat during deformation. Due to this phenomenon, a phase lag (δ) is observed:

$$Storage modulus ( {E}^{′} ) = \frac{σ}{ɛ} cos δ$$

$$Loss modulus ( {E}^{″} ) = \frac{σ}{ɛ} sin δ$$

Similarly we also define shear storage and shear loss moduli, G′ and G″.

Complex modulus is then expressed as:

E=E′+iE″

G=G′+iG″

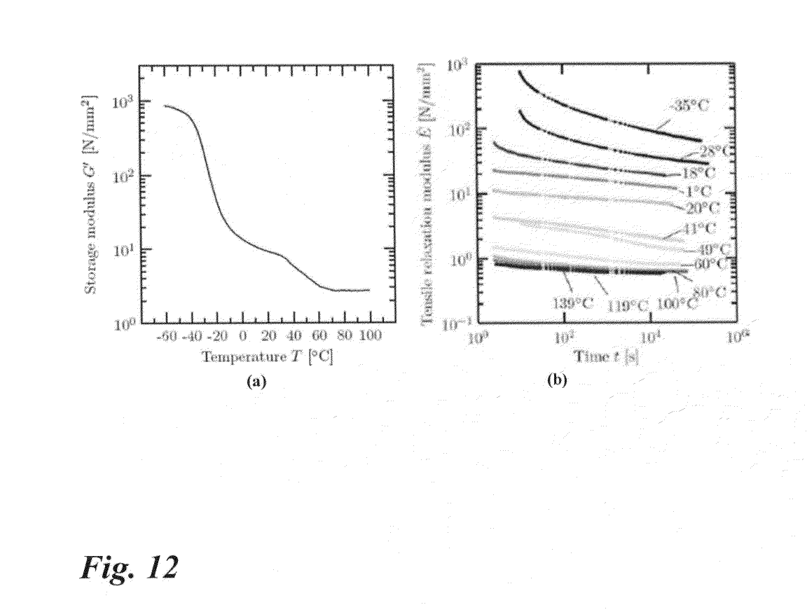

The temperature or frequency of the sample is varied in order to identify their effect or to find the glass transition temperature. Inverse Fourier transform is used to find time dependence. Eitner et al. performed DMA to investigate the dependency of EVA on the temperature. Their result is shown in FIG. 12 (a). To perform a relaxation test a material specimen is simply held for a prolonged period of time by applying constant strain. The procedure is repeated at different temperatures to develop a master curve for relaxation of the polymer. During the experiment, the time dependency of a viscoelastic polymer is analyzed. Results of relaxation tests performed by Eitner et al. Eitner U., Kajari-schroder S., Kontges M., and Brendel R., 2010, “Non-linear Mechanical Properties of Ethylene-Vinyl Acetate (EVA) and its Relevance to Thermomechanics of Photovoltaic Modules,” 25th European Photovoltaic Solar Energy Conference, Valencia, pp. 4366-4368, incorporated by reference herein, are given in FIG. 12 (b).

With Time-Temperature Superposition (TTS) one can add temperature effects in the viscoelastic model. With the help of relaxation experiment at different temperatures, a single master curve may be formed by shifting others over the time scale. This process is done through shift function In TTS, it is assumed that at higher temperature, relaxation occurs faster. This assumption is called “Thermorheologically simple”. So the shift function basically scales time to get pseudo time. If A[T(t)] is a shift function, then,

A[T(t)]=τ/t

where,
t=current time
τ=pseudo time

log [A{T(t)}]=log(τ)−log(t)

log(τ)=log(t)+log [A{T(t)}] (16)

As depicted by Eq. (16), log of shift function represents the horizontal shifting of the master curve. The William-Landel-Ferry (WLF) shift function is widely used and is given by Eq. (17).

$$log A [ T ( τ ) ] = \frac{- {C}_{1} ( T - {T}_{r} )}{{C}_{2} + T - {T}_{r}} \qquad ( 17 )$$

where,

Tr=Reference temperature at which the master curve is obtained
C₁, C₂=Material constants

When the reference temperature is chosen to be equal to glass transition temperature for the polymer under consideration, then in most cases, C1=17.44 and C2=51.6K. It should be noted that all temperatures must be Kelvin. Temperatures less that C2-Trshould be avoided as it is the limit below which response of the material is fully elastic, Imaoka S., 2008, Viscoelasticity, STI0807B, incorporated by reference herein.

Table 6 gives the comparison of the material modeling used in the literature. It can be seen that when only cells are modeled, details such as silver and aluminum paste are also provided to the FE package. But as in the current work the whole PV module is modeled, therefore, silver and aluminum are not included considering their effect to be negligible. The later sections provide the reasons for model selection for each material.

By using Table 7, one can easily find values of Young's modulus, Poisson's ratio and shear modulus described by Eq. (18), Eq. (19) and Eq. (20).

$$\begin{matrix}{E}_{( 100 )} = \frac{1}{{s}_{11}} = 130 GPa \\ {υ}_{( 100 ) , ( 010 )} = {υ}_{( 100 ) , ( 001 )} = \frac{- {s}_{12}}{{s}_{11}} = 0.28 & ( 18 , 19 ) \\ {G}_{( 100 ) , ( 010 )} = \frac{1}{{s}_{44}} = 79.5 GPa & ( 20 )\end{matrix}$$

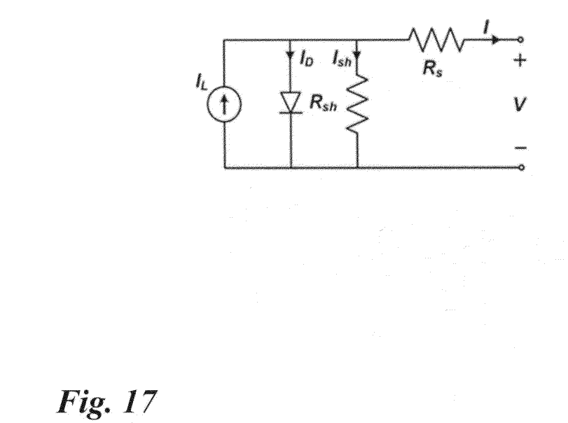

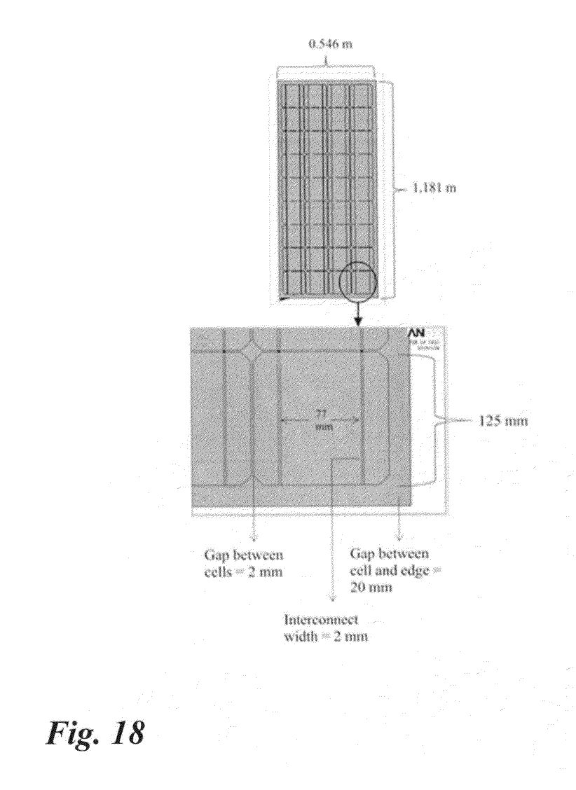

Regarding, the CTE of silicon, it varies with temperature as shown in FIG. 17.

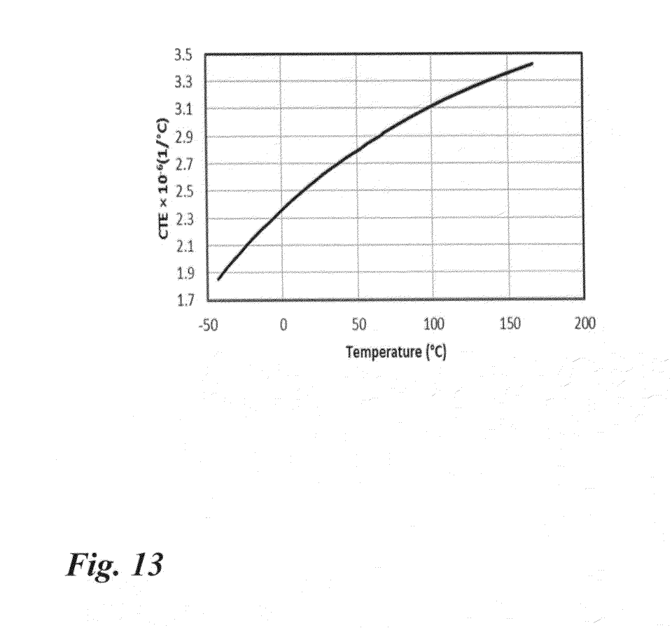

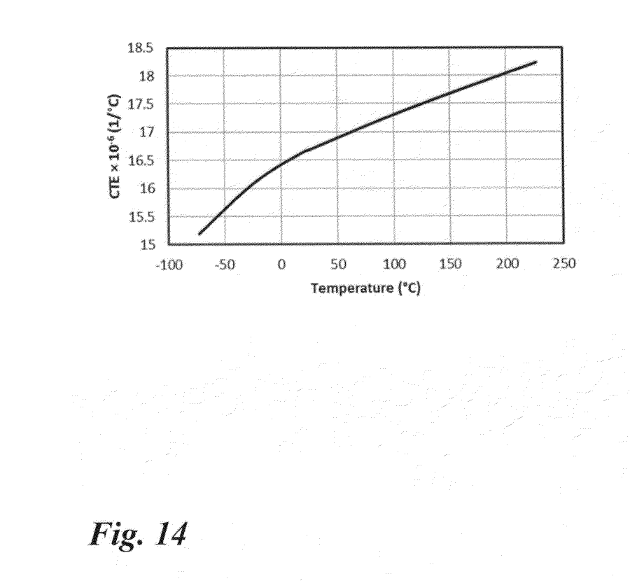

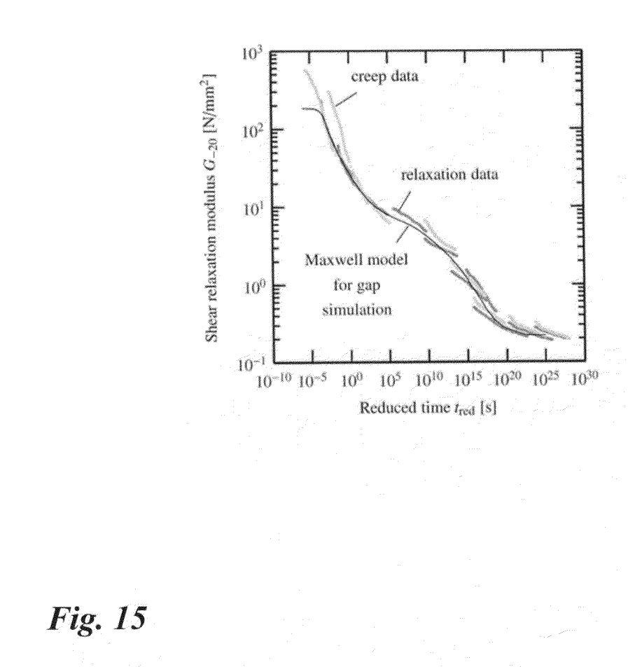

The CTE values in FIG. 13 have obtained through experiments performed by K. G. Lyon et al. Lyon K. G., Salinger G. L., Swenson C. A., and White G. K., 1977, “Linear Thermal Expansion Measurements on Silicon from 6 to 340 K,” Journal of Applied Physics, 48(3), p. 865, incorporated by reference herein, and R. B. Roberts, Roberts R. B., 1981, “Thermal Expansion Reference Data: Silicon 300-850 K,” Journal of Physics D: Applied Physics, 14(10), pp. L163-L166. Hence, its dependence on temperature cannot be ignored. The density is taken as 2329 kg/m3, incorporated by reference herein. Dietrich et al. Dietrich S., Pander M., Sander M., Schulze S. H., and Ebert M., 2010, “Mechanical and Thermomechanical Assessment of Encapsulated Solar Cells by Finite-Element-Simulation,” Reliability of Photovoltaic Cells, Modules, Components, and Systems III, SPIE incorporated by reference herein, concluded that interconnects undergo plastic strain when cooled from lamination temperature. Wiese et al. found that the stress-strain curve of copper can be approximated by bilinear model so that computation can be simplified. By including the temperature dependence of Young's modulus through DMA and the stress 51 strain curve at room temperature, they developed a model shown in Table 8, which can be used for FE simulation. CTE of copper also depends on temperature (shown in FIG. 14) and its temperature dependence is provided in the literature, White G. K., and Minges M. L., 1997, “Thermophysical Properties of Some Key Solids: An Update,” International Journal of Thermophysics, 18(5), pp. 1269-1327, incorporated by reference herein. Density of copper is given as 8890 kg/m₃.

TABLE 8
Bilinear elastic-plastic model for Copper

| Temperature | Young's Modulus | Yield Stress | Tangent Modulus |
|---|---|---|---|
| (° C.) | (GPa) | (MPa) | (MPa) |
| −40 | 91.5 | 116.2 | 1000 |
| 25 | 85.7 | 95.1 | 1000 |
| 125 | 82 | 62.6 | 1000 |
| 225 | 79.2 | 30 | 1000 |

The CTE for soda-lime glass was looked into the literature, Schott Borofloat, Schott Borofloat® 33, http://www.schott.com/hometech/english/download/brochure_borofloat_e.pdf, incorporated by reference herein, and was found to be almost constant throughout the temperature range of −40 to 150° C. It is preferred to use a constant CTE for glass which is equal to 8×10-6 (1/° C.). It is modeled as isotropic linear elastic with its Young's modulus equal to 73 GPa and Poisson's ratio equal to 0.23. The density is provided as 2500 kg/m3. Tensile tests were performed by Eitner et al. in order to determine the mechanical properties at different temperatures for PVF/PET/PVF. The back-sheet used was Isovolta Icosolar 2442 and it found that the Young's modulus did not show significant changes with the change in temperature thus its value was taken as 3.5 GPa with Poisson's ratio equal to 0.29. The density and the CTE is given as 2520 kg/m3 and 50.4×10-6 (1/° C.) respectively.

Viscoelasticity of EVA has been discussed in detail in the earlier section where Eq.(15) was found to be as the relaxation modulus given by prony series. ANSYS interprets relaxation modulus in terms of relative modulus (αᵢ) where,

$${α}_{i} = \frac{{G}_{i}}{{G}_{o}} \\ {G}_{o} = {G}_{∞} + {\sum }_{i = 1}^{n} {G}_{i} \qquad ( 21 , 22 )$$

By substituting, Eq. (21) and Eq. (22) in Eq. (15), we get,

$$R ( t ) = {G}_{o} [ {α}_{∞} + {\sum }_{i = 1}^{n} {α}_{i} {e}^{- \frac{t}{{τ}_{i}}} ] \\ where , \\ {α}_{∞} = \frac{{G}_{∞}}{{G}_{o}} \qquad ( 23 )$$

To fit the prony series mentioned in Eq. (23), experimental results can be used. A value of n (number of spring-dashpot elements) is chosen with guess values for αi, and τi. Residuals are calculated and brought to minimum by a number of iterations. For this process, a master curve plotted by relaxation experiments and WLF shift function can be used. In this case, the master curve in FIG. 3.7 was used. Table 3.4 provides all the viscoelastic properties used for EVA.

The application of the procedure gives the Prony series fit for the Maxwell's model of 25 arms. The relative shear moduli and the pseudo time found can be directly fed into ANSYS. Now, the issue is to find the instantaneous shear modulus (Go). From αi obtained from the curve fitting procedure, it is given that,

$${α}_{∞} = 1 - {\sum }_{i = 1}^{n} {α}_{i} \qquad ( 24 )$$

For each data point of the master curve, the value of instantaneous shear modulus can be calculated. For a proper curve fit, this value will be almost same for each data point or an average may be taken. The density of EVA is taken as 960 kg/m3.

TABLE 9
Viscoelastic properties for EVA

| | |
|---|---|
| C₁ | 48.44 |
| C₂ | 172.55K |
| Tᵣ | 253K |
| Eₒ | 1.3 GPa |
| φ₁ | 0.5467175 |
| τ₁ | 0.0001219 |
| φ₂ | 0.2222377 |
| τ₂ | 0.0007823 |
| φ₃ | 0.0992664 |
| τ₃ | 0.0063471 |
| φ₄ | 0.0590673 |
| τ₄ | 0.075255 |
| φ₅ | 0.0265249 |
| τ₅ | 1.261626 |
| φ₆ | 0.0136822 |
| τ₆ | 15.7945 |
| φ₇ | 0.0105574 |
| τ₇ | 235.0052 |
| φ₈ | 0.0037958 |
| τ₈ | 10333.19 |
| φ₉ | 0.002486 |
| τ₉ | 99967.33 |
| φ₁₀ | 0.0010978 |
| τ₁₀ | 1000001 |
| φ₁₁ | 0.0021774 |
| τ₁₁ | 10⁷ |
| φ₁₂ | 0.0010461 |
| τ₁₂ | 10⁸ |
| φ₁₃ | 0.0015563 |
| τ₁₃ | 10⁹ |
| φ₁₄ | 0.0023002 |
| τ₁₄ | 10¹⁰ |
| φ₁₅ | 0.0008377 |
| τ₁₅ | 10¹¹ |
| φ₁₆ | 0.0013597 |
| τ₁₆ | 10¹² |
| φ₁₇ | 0.0013157 |
| τ₁₇ | 10¹³ |
| φ₁₈ | 0.00076 |
| τ₁₈ | 10¹⁴ |
| φ₁₉ | 0.0011088 |
| τ₁₉ | 10¹⁵ |
| φ₂₀ | 0.0005415 |
| τ₂₀ | 10¹⁶ |
| φ₂₁ | 0.0005575 |
| τ₂₁ | 10¹⁷ |
| φ₂₂ | 0.0003087 |
| τ₂₂ | 10¹⁸ |
| φ₂₃ | 0.000177 |
| τ₂₃ | 10¹⁹ |
| φ₂₄ | 1.122E−05 |
| τ₂₄ | 10²⁰ |
| φ₂₅ | 1.536E−08 |
| τ₂₅ | 10²¹ |
| φ₂₆ | 6.337E−06 |
| τ₂₆ | 10²² |

As the name indicates, it is a combination of two models. The radiation model is used to calculate the plane of array irradiance from the measured horizontal solar irradiance. The optical model is used to estimate the amount of plane of array irradiance absorbed on a respective surface. Eq. (25) is used to calculate the transmittance-absorptance product (τα). Here θ and θ rare the incidence and refraction angles, K is the extinction coefficient and L is the thickness of the glass cover Siddiqui M. U., 2011, “Multiphysics modeling of Photovoltaic panels and Arrays with auxiliary thermal collectors,” King Fahd University of Petroleum & Minerals, incorporated by reference herein. Eq. (26) is used to calculate the incidence angle modifiers (Kτα) by using the (τα) product. It should be noted that separate incidence angle modifiers are required for beam, diffuse and ground reflected components of the incident solar radiation.

$$τα ( θ ) = {e}^{- ( KL / cos {θ}_{r} )} [ 1 - \frac{1}{2} ( \frac{{sin}^{2} ( {θ}_{r} - θ )}{{sin}^{2} ( {θ}_{r} + θ )} + \frac{{tan}^{2} ( {θ}_{r} - θ )}{{tan}^{2} ( {θ}_{r} + θ )} ) ] \\ {K}_{τα} ( θ ) = \frac{τα ( θ )}{τα ( 0 )} \qquad ( 25 , 26 )$$

The radiation model used in the current work is the Hay-Davies-Reindl-Klutcher (HDKR) model and is given by Eq. (27). Here, S is the absorbed solar radiation, G is the horizontal plane solar radiation, R beam is the ratio of beam radiation on tilted plane to that on horizontal plane, ρ is the ground reflectivity, β is the tilt angle of PV module, Ai is the anisotropy index (given by Eq. (28)) and M is the air mass modifier. The subscripts b, d, g and ref are for the beam, diffuse, ground reflected and reference solar radiations respectively.

$$\frac{S}{{S}_{ref}} = M \frac{{G}_{b} + {A}_{i} {G}_{d}}{{G}_{ref}} {R}_{beam} {K}_{τα , b} + M \frac{( 1 - {A}_{i} ) {G}_{d}}{{G}_{ref}} {K}_{τα , d} ( \frac{1 + cos β}{2} ) ( 1 + f {sin}^{3} ( \frac{β}{2} ) ) + M \frac{G}{{G}_{ref}} ρ {K}_{τα , g} ( \frac{1 - cos β}{2} ) \qquad ( 27 )$$

where the factor f and Sref are given by Eq. (29). and Eq.(30) respectively.

$${A}_{i} = \frac{{G}_{b}}{{G}_{o}} \\ f = \sqrt{\frac{{G}_{b}}{G}} \\ {S}_{ref} = {( τ α )}_{n} {G}_{ref} \qquad ( 28 , 29 , 30 )$$

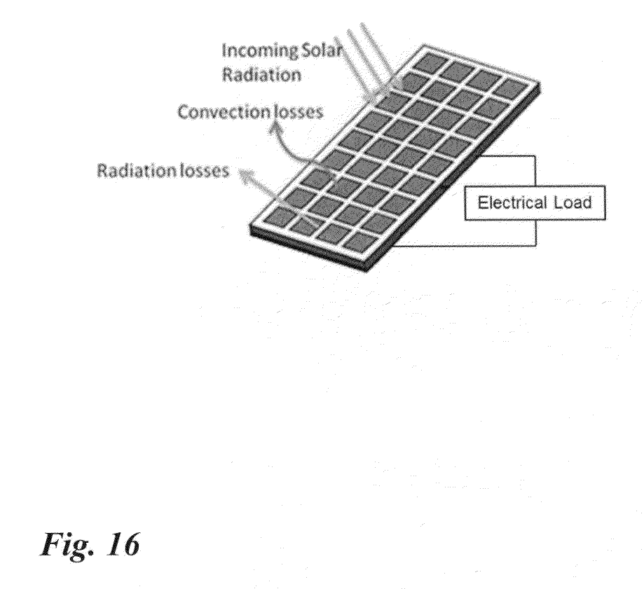

Thermal modeling is done in ANSYS by providing various modes of energy transfer, as shown in FIG. 16. The application of these modes are explained in the loads and boundary conditions section. The PV module gains energy by absorbing the incoming solar radiation. Some of the energy is lost due to convection by wind on the top and bottom surfaces. Some of it is lost through radiation to the environment. The energy is also used to convert thermal energy to electrical energy by cells and the rest of the energy is used up in the heating of the module. The combined thermal and structural properties for the components of the PV module are summarized by Table 10.

TABLE 10
Material properties of module components.
T. dep. stands for temperature dependent,
BISO stands for bilinear isotropic

| | | | | | | Thermal |
|---|---|---|---|---|---|---|
| | | | | | Specific | conduc- |
| | Density | Elastic | Poisson's | CTE | heat | tivity |
| | ρ | Modulus | ratio | α (10⁻⁶ | C | k |
| Component | (kg/m³) | E (GPa) | ν | 1/K) | (J/kg K) | (W/m K) |
| Silicon | 2329 | Stiffness matrix | | T. dep. | 677 | 130 |
| Backsheet | 2520 | 3.5 | 0.29 | 50.4 | 1010 | 0.36 |
| Glass | 2500 | 73 | 0.23 | 8 | 913 | 0.937 |

| | | | | | |
|---|---|---|---|---|---|
| EVA | 960 | Viscoelastic model | 270 | 2090 | 0.311 |
| Copper | 8890 | BISO | T. dep. | 386 | 401 |

The electrical model used was developed by Siddiqui et al. (2013) in which a PV device is represented by an equivalent electric circuit of FIG. 17 (Duffie and Beckman, 1991). The governing equation for current-voltage relationship for the PV devices is given by Eq. (31).

$$I = {I}_{L} - {I}_{o} ( exp ( \frac{V + I \cdot {R}_{s}}{a} ) - 1 ) - \frac{V + I \cdot {R}_{s}}{{R}_{sh}} \qquad ( 31 )$$

The model is used by determining the parameters IL, Io, a, Rs and Rsh at a reference condition. Then these are translated to the operating condition using the translation equations (32)-(36). The parameters m and n are determined using two additional maximum power values at a higher temperature and a lower irradiance.

$$a = {{a}_{ref} ( \frac{{T}_{cell}}{{T}_{cell , ref}} )}^{n} \\ {I}_{L} = {( \frac{S}{{S}_{ref}} )}^{m} ( {I}_{L , ref} + {μ}_{ise} ( {T}_{cell} - {T}_{cell , ref} ) ) \\ {I}_{o} = {{I}_{o , ref} ( \frac{{T}_{cell}}{{T}_{cell , ref}} )}^{3} {e}^{( \frac{NCS , {T}_{cell , ref}}{{a}_{ref}} ( \frac{{E}_{g , ref}}{{T}_{cell , ref}} - \frac{{E}_{g}}{{T}_{cell}} ) )} \\ {R}_{sh} = \frac{{S}_{ref}}{S} {R}_{sh , ref} \\ {R}_{s} = {R}_{s , ref} \qquad ( 32 , 33 , 34 , 35 , 36 )$$

The layers of a PV module are very thin as compared to their lengths. Therefore, solving a 3D problem of such nature over the whole module would take time in days which is inappropriate. To resolve this issue, shell modeling was a perfect option as it idealizes the problem to 2D. Shell elements in ANSYS have the ability to solve problems from thin to moderately thick structures, ANSYS, 2010, ANSYS Mechanical APDL Structural Analysis Guide, Canonsburg, Pa., incorporated by reference herein. The multilayer definition ability in shell helped to provide dimensions and material properties along the thickness of the laminate. It evaluates the results in one plane and interpolates them along the thickness. Thus, stresses and strains can be viewed in each layer. FIG. 3.10 shows the overall module area (0.546 m×1.181 m) along with its dimensions. The area of a single cell is 125 mm×125 mm. The gap between two cells is 2 mm and 20 mm from the edge of the module. The space between two strips of interconnection is 77 mm. It is seen that the whole module area has been constructed by smaller sections (separated by lines) and are merely of four types.

(i) Areas representing the cell region,

(ii) Areas representing the interconnect region along the cells,

(iii) Areas representing the interconnect region within the cell gap and

(iv) Rest of the module area.

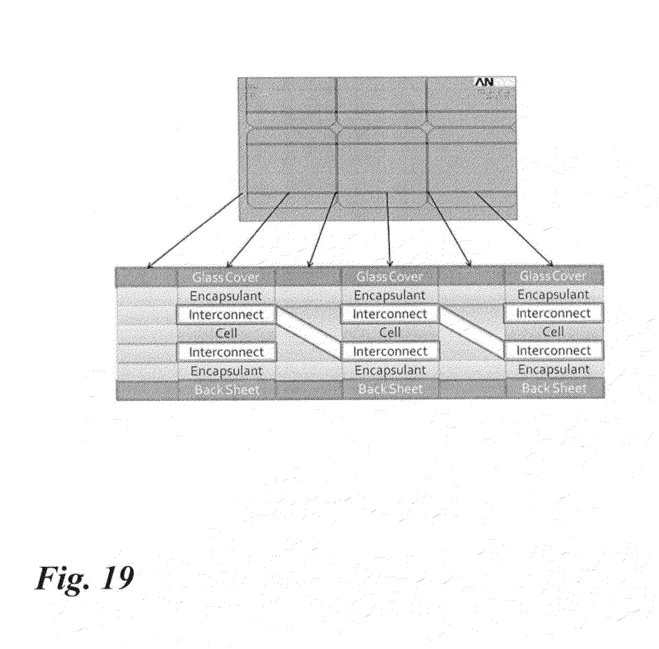

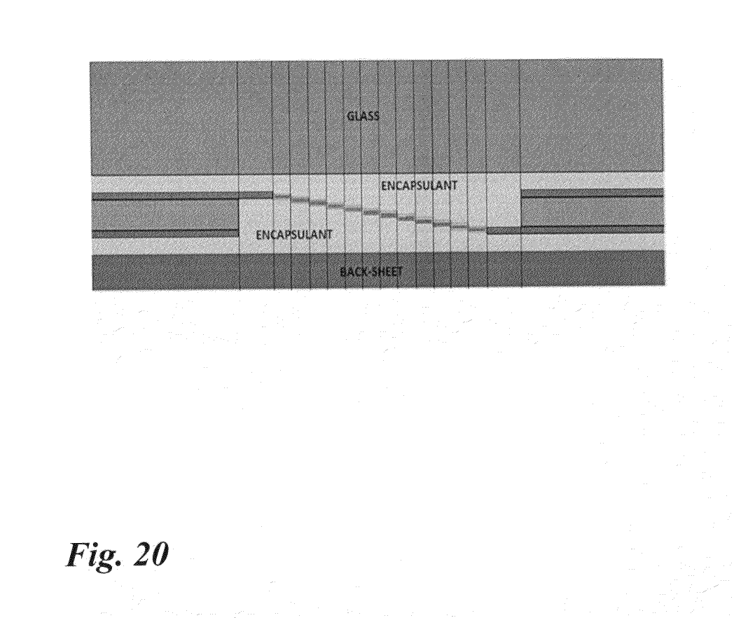

Different layered configuration, along the thickness of the module, is defined for each section. Some of them are shown in FIG. 19. The section type (iii) modeling consists of interconnects. The interconnects, within the cell gaps, have a curved slanted profile as shown in FIG. 19. To approximate such profile along the thickness, the cell gap region is further divided into 14 sections. These sections are defined to constitute a layer of copper which is positioned in adjacent layers in such a way that it produced almost the same profile. This is done by varying the thickness of encapsulant layers within these sections as depicted in FIG. 20. The thickness of each layer within the PV laminate is mentioned in Table 11.

TABLE 11
Thickness of layers within the PV laminate

| | Thickness |
|---|---|
| Layer | (μm) |
| Glass | 4000 |
| Cell | 200 |
| Encapsulant | 1200 |
| Back-Sheet | 350 |
| Interconnector | 129 |

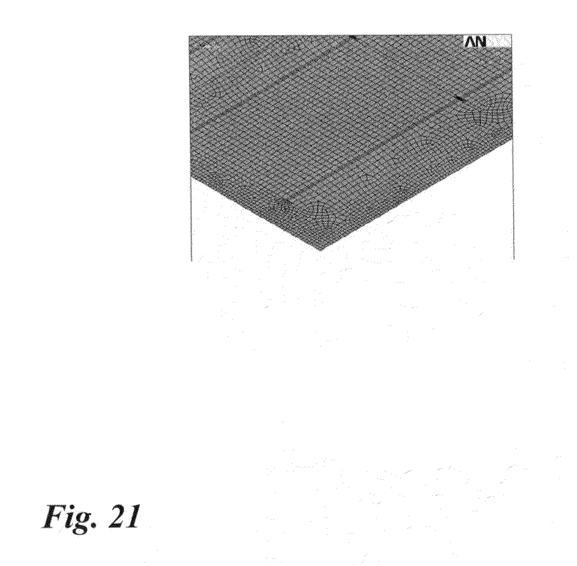

As shown in FIG. 21, the FE mesh consists of four node shell elements. SHELL131 was used for thermal analysis and its counterpart SHELL181 was used to solve the structural problem. Mesh convergence test was performed with respect to maximum von-Mises stress within each component of the PV module. The converged mesh had 83,351 elements as shown in Table 12. It is evident that the same geometry and mesh was used to couple thermal model with structural model.

TABLE 12
Mesh convergence with respect to maximum
von-Mises stress in all layers

| | |
|---|---|
| No. of | Max. von-Mises stress (MPa) |

| Elements | Glass cover | Backsheet | Cell | Interconnects |
|---|---|---|---|---|
| 8.394 | 6.41 | 41.2 | 212 | 160 |
| 16.356 | 9.31 | 41.2 | 219 | 162 |
| 32.627 | 9.23 | 41.1 | 217 | 162 |
| 59.162 | 9.24 | 41.2 | 218 | 162 |
| 83.351 | 9.24 | 41.2 | 218 | 162 |

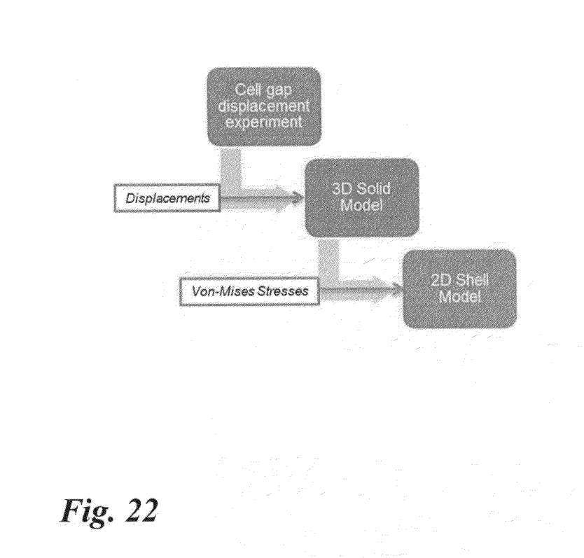

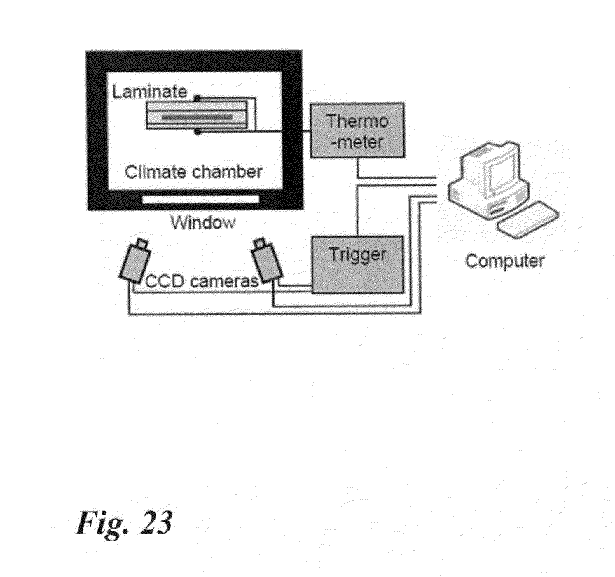

Validation is done in two steps. The first step deals with the development of a 3D FE solid model. This model is then given the inputs of an experiment in the literature. The results were found to be in good agreement. In the second step, the stresses in the solid model were compared to that of the shell model to find similarity between them. This is depicted in FIG. 22. Although shell elements ANSYS will be used for analysis to save computational time, but displacement of each component cannot be viewed using shell elements. These elements instead compute the cumulative displacements and estimate stresses on each layer by forming an equivalent stiffness matrix. The cell-gap displacement is basically the change of cell gap due to temperature change. Eitner et al. applied digital image correlation technique to measure the thermo-mechanical displacements in cells due to heating and cooling of a module. FIG. 23 gives a schematic diagram to understand the setup. As shown, two cameras as attached to take pictures of the specimen. The measurement of displacement is done by comparing the pictures in reference state and in the loaded state through a computer algorithm. A three cell sample is prepared with speckled surface for measurement purposes. The three cells are then laminated by EVA, attaching glass and backsheet. The lamination is done by heating the assembly to 150° C. for 13 minutes. The cells were not interconnected. The laminate is 40 cm×15 cm. The cells had a dimension of 125 mm×125 mm and were placed at a distance of 2 mm from each other. The thicknesses of each component are given in Table 13.

TABLE 13
Thicknesses of the components of the PV module specimen

| | Thickness |
|---|---|
| Component | (μm) |
| Glass | 4000 |
| Cell | 200 |
| Encapsulant | 1100 |
| Backsheet | 100 |

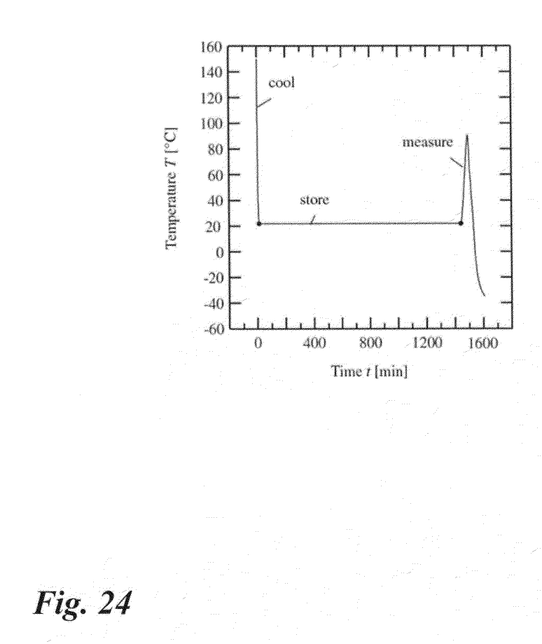

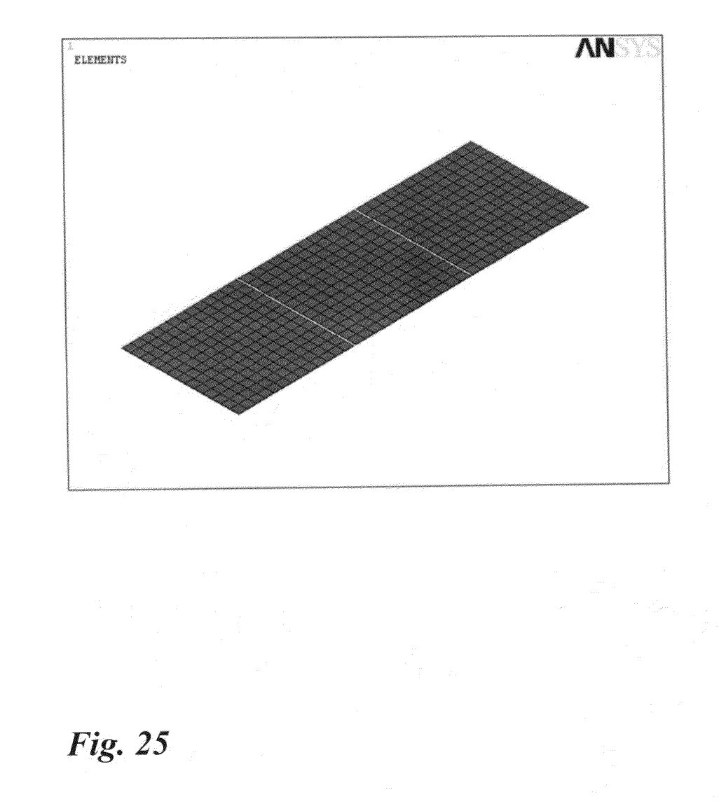

FIG. 24, Eitner U., Kajari-Schroder S., Marc K., and Altenbach H., 2011, Thermal Stress and Strain of Solar Cells in Photovoltaic Modules, Shell-like Structures, Springer Berlin Heidelberg, Berlin, Heidelberg incorporated by reference herein, gives the complete temperature history under which the 3 cell module was experimented. As depicted by the figure, first the curing of the encapsulant was done by cooling it from 150° C. to room temperature of 23° C. Then the specimen was stored for 24 hours under constant room temperature. After that the module was first heated to 85° C. and then cooled to −40° C. The cell gap displacements were recorded. Eitneret el. evaluate different material models for EVA by comparing the results for cell gap displacements in experiment and simulation. In the current work, the same methodology has been adopted to reproduce similar validation results. As seen in FIG. 25, the shape of cells is square instead of pseudo square. It was done in order to create assistance in mapped meshing of the components of the module.

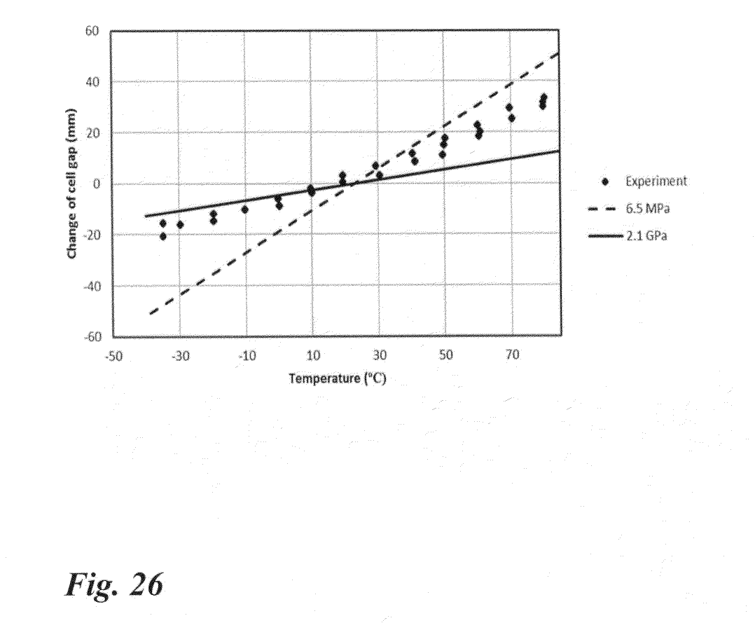

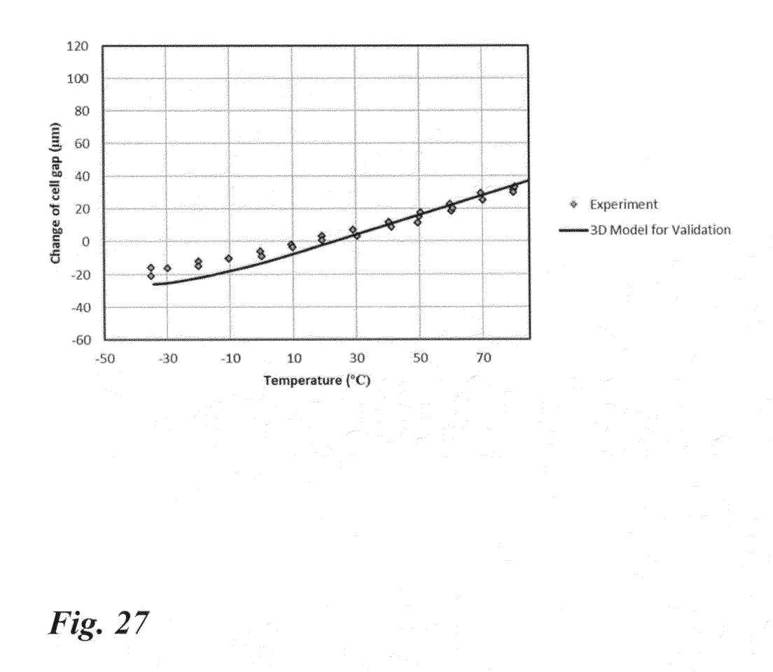

The first part was done by modeling the EVA encapsulant as linear elastic. FIG. 26 shows the comparison of the two linear elastic models used for EVA with experimental data of cell gap displacement. Eitner et al. determined that the Young's modulus of elasticity (E) is not the same for EVA and changes with time and temperature. Therefore, highest and the lowest values of E were chosen for comparison which were 2.1 GPa and 6.5 MPa respectively. The same was done in the current work and a great difference was found between the actual and the simulated results as shown in FIG. 26. The reference temperature was set as 150° C. i.e. the temperature of zero strain. The cell gap displacements were calculated (FIG. 27) and compared with the experimental results performed in Eitner et al. It is actually the difference of the average displacement of the nodes on the center of the edge along the thickness between the two adjacent cells. A good agreement is seen between both experimental and the simulation outcomes.

The present disclosure validates the shell model so that it can be used for FE simulation of a whole PV module. As discussed earlier, the shell model calculates a cumulative displacement of all layers and therefore, single layer displacements cannot be viewed. But the experiment for validation required is placements to be compared with the model and for this reason, a solid model was developed. Now the solid model with the shell model under the same load and having the same geometric and material properties are compared. To remove the effect of boundary condition, the boundaries of glass, encapsulant and backsheet were moved further from the cells causing an increase in the size of the specimen of both the solid and the shell model.

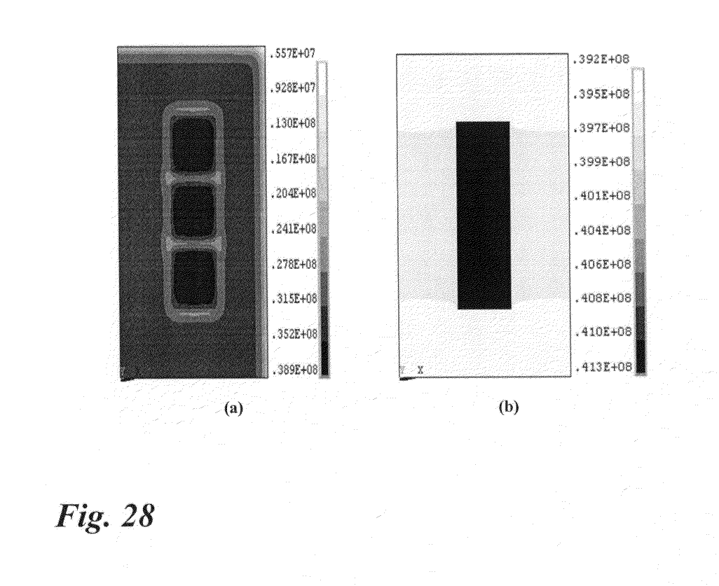

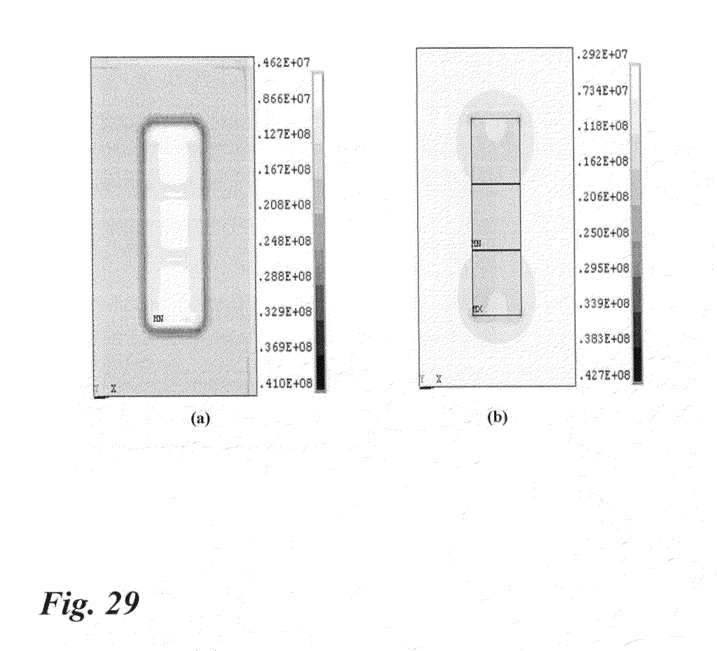

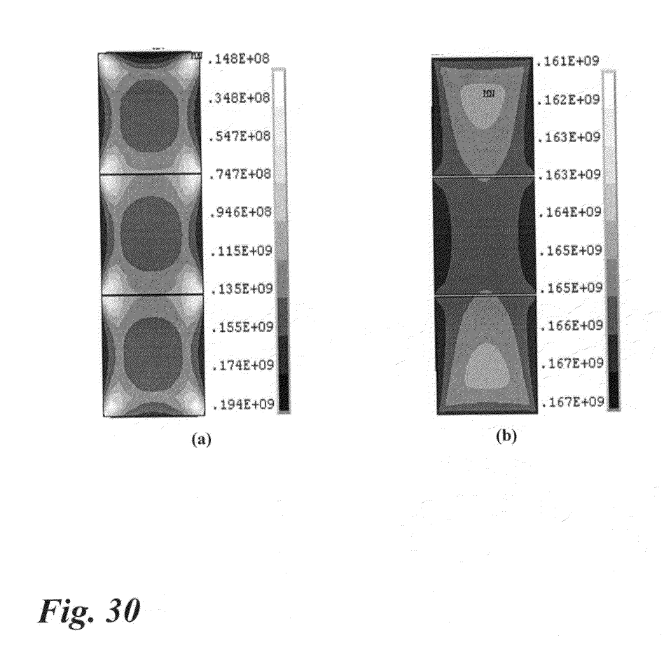

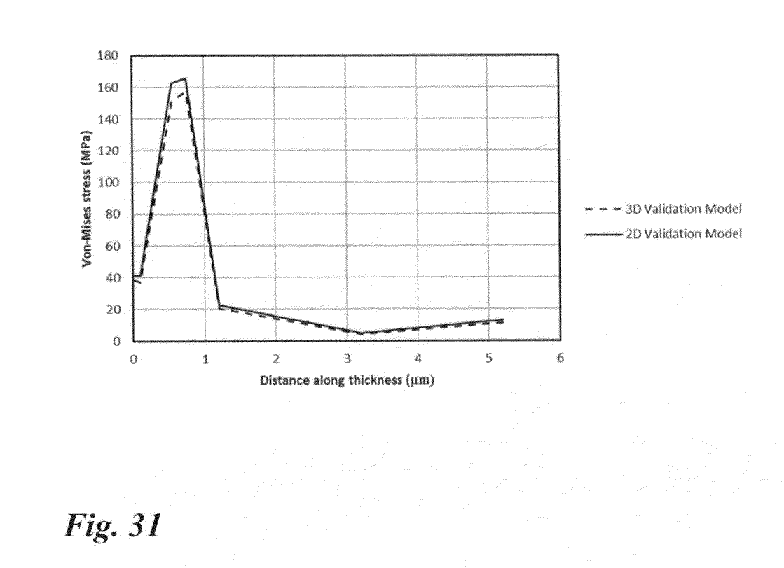

FIGS. 28 (a) and (b) are the von-Mises stress contours of solid and shell models for backsheet respectively. It is seen that the maximum stress is below the cell region and which are quite close for models. The error between the two increases towards the boundary of the model. It is attributed to boundary condition effect. The same can implied for glass cover and cells respectively in FIG. 29 and FIG. 30 respectively. A larger difference can be seen in the case of cells but this difference is subject to normalize for a 36 cell PV module model. It can also be seen that the shell model gives a conservative estimate of stresses, which is beneficial if used for design purposes. FIG. 31 gives a comparison along the thickness of the module for both models over a point on the top surface away from the boundaries of the specimen. A good agreement can be seen for both the cases with maximum difference between them to be 6%.

Different models for EVA were used in FE simulation and the experimental results in the literature were compared. The similarity between the results of shell and solid model is also assessed to draw out the following conclusions:
Viscoelastic model for EVA is a close estimate of its constitutive behavior, unlike the linear elastic model which gave a large deviation from actual behavior.
Shell model is able to capture the response of PV module over loads as the
solid model. It also provides conservative estimates, useful for design purposes.

A lot about this temperature cycle has been discussed and shown by FIG. 8. The cycle has a maximum temperature of 85° C. and a minimum temperature of −40° C. Qualification standards such as ASTM E1171-09 are useful in predicting a module's failure. A single temperature cycle has been simulated in order to get an insight on the behavior of the components of the PV module. For accurate prediction, the simulated temperature cycle starts from the lamination process of the module following 24 hour storage. At the end a parametric study has been performed to find the effect of the thickness of the encapsulant.

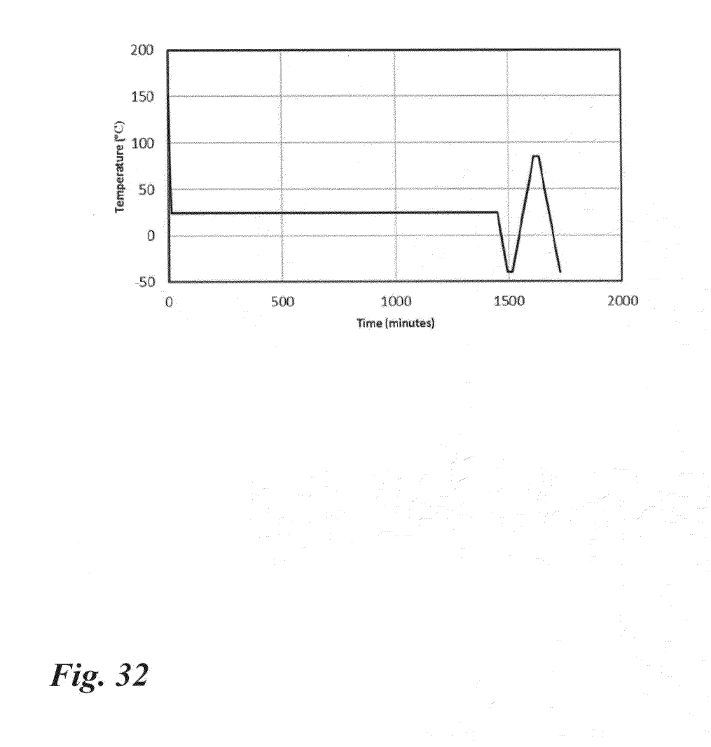

The module is constraint at one corner to allow free deformation. This will help to study the pure dependence of materials on one another. The stress-free temperature is taken as the lamination temperature (150° C.) because at that temperature every component of the module is independent to one another thus allowing a stress-free expansion. FIG. 32 provides the simulated temperature profile. As seen, the simulation starts from the lamination temperature to room temperature of 21° C. Then the panel is assumed to be under 24 hour storage in order to incorporate the time effect of the viscoelastic model of EVA. Then a single temperature cycle of the ASTM E1171-09 standard is simulated and results are viewed at −40° C.

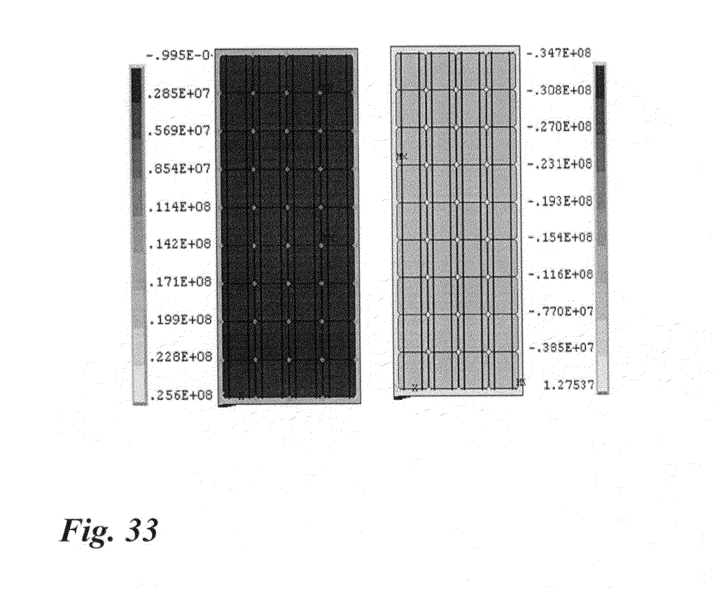

At the end of temperature profile, at −40° C., the first principle stress on the edges of the glass cover is tensile and is about 14.2 MPa. In the center of the glass where cells are present, the stresses are compressive with the first principle stress almost negligible. The presence of encapsulant and back-sheet only at the module edges has a higher CTE as compared to that of glass. Thus, they compress more ultimately producing tensile stress on the edges of glass. The third principle stress is around −11.6 MPa over the region where cells are present. The compressive stress over the center of glass is regarded as the same reason that cells have a lesser CTE and therefore restricts glass to undergo compression. The stress contours are given in FIG. 33.

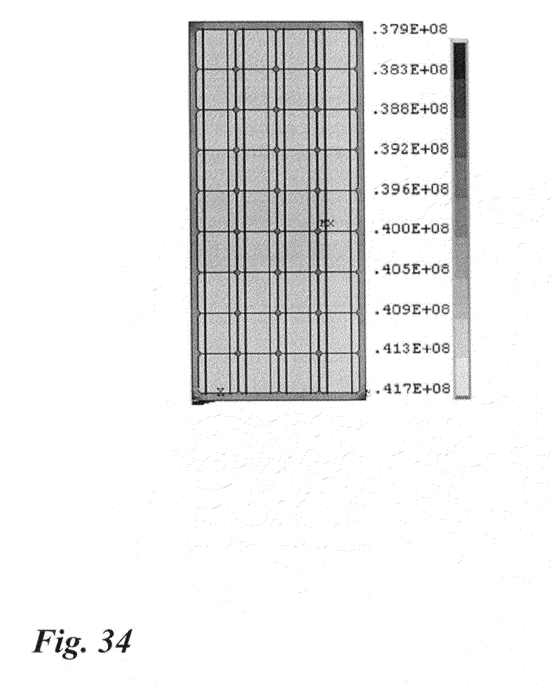

The back-sheet is under high tension. The values of the first principle stress range from 39.2 MPa to 40.9 MPa with the highest stress being generated over the region where cells are present. The high tensile stresses are the result of low CTE of glass as compared to that of back-sheet. Glass exhibits a dominant character in the contraction of the module as it has the largest thickness. All other components are forced to follow the thermal contraction of glass. The stresses generated decrease at the edges of the module as encapsulant is only present between the glass and back-sheet. Here, the contraction is accommodated by the encapsulant because of its low stiffness. Cells do not contract much and thus produce tensile stresses with in the back-sheet. Contour of the first principle stress is shown in FIG. 34.

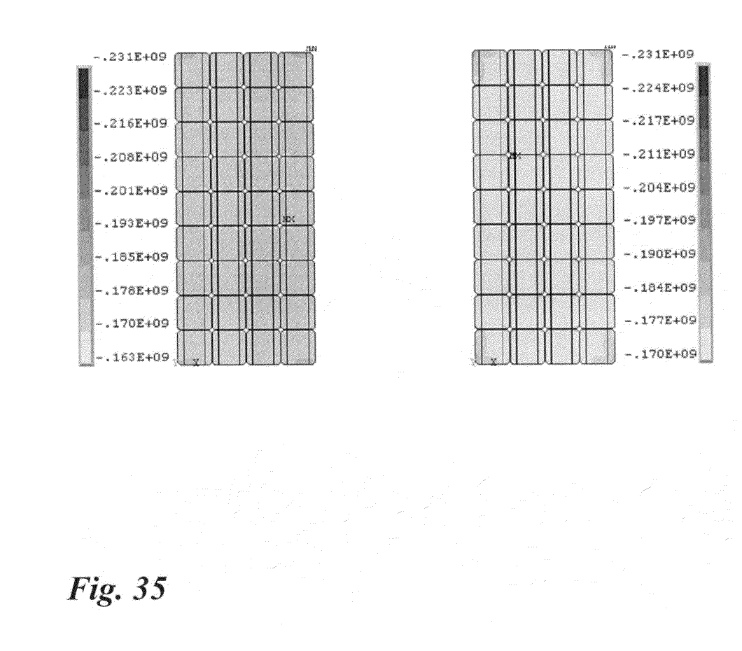

It can be seen in FIG. 35 that cells are under high compressive stresses. The maximum third principle stress in along the interconnectors and reach −217 MPa. The major region of cells has almost a uniform stress of −170 MPa. It is clear that silicon does not undergo plastic deformation as its yield stress is around 7 GPa as mentioned in Petersen K. E., 1982, “Silicon as a mechanical material,” Proceedings of the IEEE, 70(5), pp. 420-457, incorporated by reference herein. The areas where the copper interconnects are present constitute the least thickness of encapsulant within the laminate. Furthermore, copper is the stiffest component in the module and thus high stresses originate. Results of lamination process in Dietrich et al. also show that high stresses in cells originate along the interconnect region. Shear stress values are dominant in the nodal plane as compared to the planes along the thickness of the laminate. The compressive stress in the two directions of the nodal plane is almost equal for the areas covering the major region of cells. The stresses near the region of the connections between interconnects are lower due to the presence of a thick compliant layer of encapsulant there.

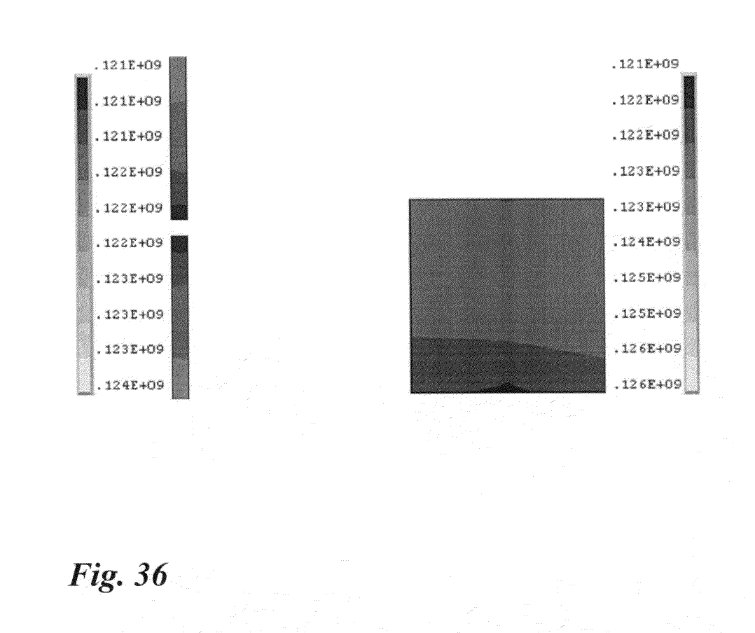

First principle stress is almost 121 MPa along the interconnect strip. They undergo plastic deformation just after the curing process. From the experiments performed in Wiese et al. it was found that the yield stress of copper is around 94 MPa at room temperature. The von-Mises stress, after the lamination process, reaches up to 96 MPa. As the temperature cycle is run, the interconnects yield further. Thus, it hardens producing high stress in cells along the region they are present. The nature of stress in copper is tensile as glass restricts its contraction. The contours are provided in FIG. 36.

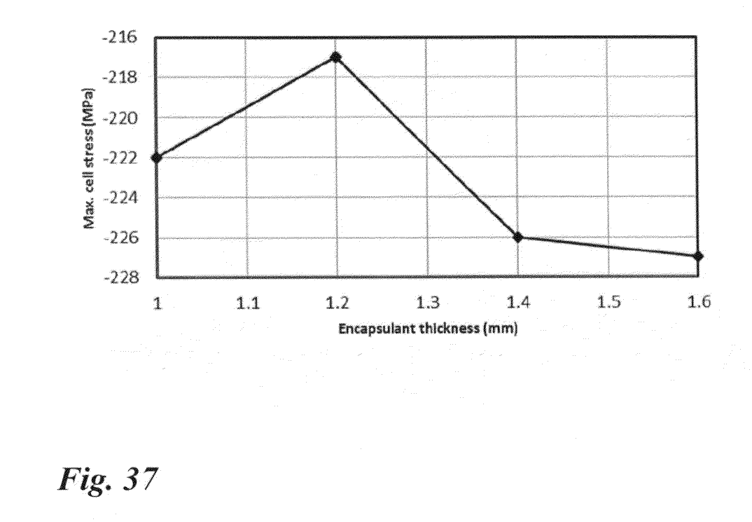

The encapsulant thickness was varied from 1.0 mm to 1.6 mm to see the effect on cells and interconnects. The variation in thickness did not show any difference on the stress value of interconnects. Although there were minor variations in the maximum third principle stress in cells (plotted in FIG. 37). It can be seen that the stress is least in the case of 1.2 mm thick encapsulant, whereas it is higher as the thickness is increased or decreased. It can be said that, at a lower thickness, copper follows the contraction of glass due to its dominancy and less encapsulant material. On the other hand, stresses are increased on increasing the encapsulant thickness; copper and silicon can gain room for their contraction thereby increasing the stress within the cell as both of them are directly tied to one another.

Simulation of the ASTM temperature cycle was performed. The model of the PV module developed is used and results are viewed at the worst condition to give the following conclusions:
Glass exhibits a dominant character towards the contraction of the module. It forces all components to follow its pure thermal contraction.
Stress in cells is higher along the interconnect region as:
They are both directly tied to one another.
Interconnect hardens as it undergoes plasticity.
Parametric study shows that 1.2 mm is the optimum encapsulation thickness
Interconnects undergo plasticity just after curing of the laminate. This hardens it thereby increasing the risk of breakage owing to fatigue induced during thereto cycles of day and night.

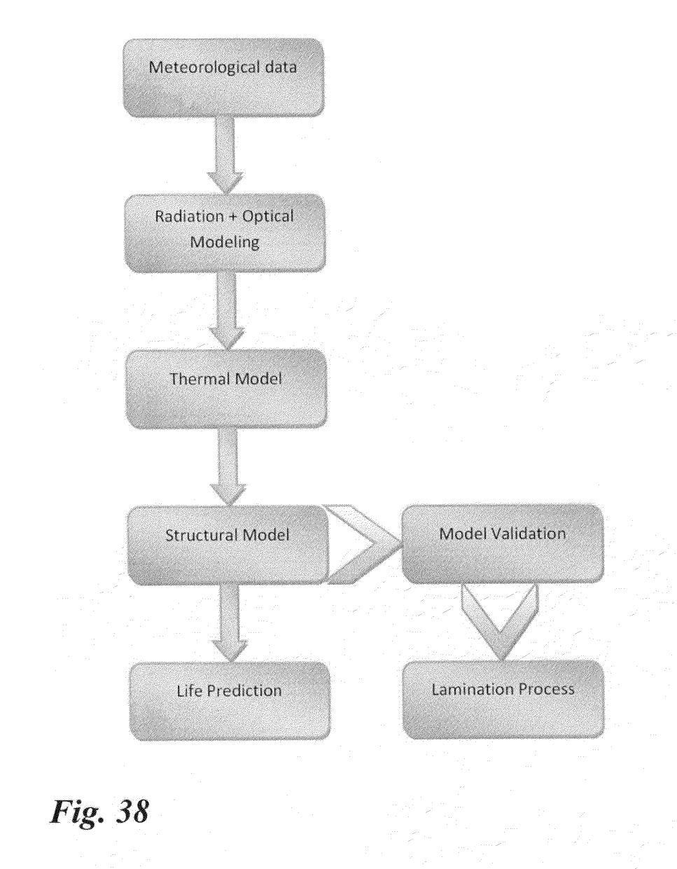

Firstly, a structural FE model was developed in which EVA encapsulant and silicon cells were modeled as viscoelastic and orthotropic respectively. The lamination procedure was simulated and it was found that the copper interconnects showed plastic deformation during cooling after curing of the encapsulant. This led to low-cycle fatigue as the cause of interconnect breakage. A thermal model was numerically developed and sequentially coupled to the structural model to include the effect of operating environment over PV modules. Finally, average life of a PV module (operating under the environment of Jeddah, Saudi Arabia) was estimated by using the thermal-structural coupled model. The results of the simulation were used within the Basquin-Coffin-Manson model to predict PV module life. The whole modeling procedure has been summarized by FIG. 38.

Fatigue is one of the failure mechanisms and is defined as a progressive and localized structural change that happens in a material which is subjected to cyclic loading. Such loading may induce crack initiation which becomes unstable over time to propagate to complete failure. Fatigue may be distributed into four stages Totten G. E., 2008, “Fatigue Crack Propagation,” Advanced Material Processes, 166(5), pp. 39-41 incorporated by reference herein:
(I) Initiation of micro-cracks due to cyclic stress. The micro-cracks are of the order of 0.1 μm to 1 μm.
(II) With time or by the increment of load, such cracks may propagate to larger length. These may range from 0.5 mm to 1 mm in length.
(III) The cracks propagate rapidly due to instable crack growth.
(IV) This stage relates to final instability leading to complete failure.

It has been already been discussed earlier about the cycling loading in photovoltaic modules due to successive temperature changes attributed to day and night. In the present disclosure, time to crack initiation (stage-I) has been predicted. Or in other words, a method is disclosed to predict the life of a standard photovoltaic module. Fatigue may be divided into two categories, high-cycle and low-cycle fatigue. When loads are of such magnitude that more than about 10,000 cycles are required to produce failure, then fatigue causing failure is termed as high-cycle fatigue. In such a case, deformation is principally elastic. On the contrary, when deformation is generally plastic due to cyclic loading or when failure occurs in less than 10,000 cycles, in such a case, fatigue is termed as low-cycle fatigue. It was seen that copper interconnects undergo plastic deformation just after lamination, so this makes it a case of low-cycle fatigue.

Certain life predicting models have been developed in order to evaluate life (time to failure) which make use of strain in the case of low-cycle fatigue. Strain based models are widely used at present. Among them, the Basquin-Coffin-Manson relationship is arenowned model to find out fatigue life as given by Eq. (37).

$$\frac{Δɛ}{2} = \frac{{σ}_{f}^{′}}{E} {( 2 {N}_{f} )}^{b} + {{ɛ}_{f}^{′} ( 2 {N}_{f} )}^{c} where , \\ \frac{Δɛ}{2} = total strain amplitude \\ {σ}_{f}^{′} = fatigue strength coefficient \\ {ɛ}_{f}^{′} = fatigue ductility coefficient \\ E = {Young}^{'} s modulus of elasticity \\ {N}_{f} = no . of cycles to crack initiation \\ b = fatigue strength exponent \\ c = fatigue ductility exponent \qquad ( 37 )$$

The total strain amplitude

$$( \frac{Δ ɛ}{2} )$$

is actually the half of the strain range within the loading cycle. For evaluating parameters required for life estimation, there are certain testing methods discussed in Stephens R. I., and Fuchs H. O., 2001, Metal Fatigue in Engineering, Book News, Inc., Portland, incorporated by reference herein, Eq. (37) is actually the combination of the Coffin-Manson relationship and Basquin's equation given by Eq. (38) and Eq. (39) respectively. Coffin-Manson model was proposed independently by Coffin and Manson in 1954. This model accounts for such low-cycle fatigue conditions where plasticity is involved. To deal with intermediate fatigue problems having the effect of both elastic and plastic deformation, Eq. (39) was added onto Eq. (38) by dividing by the Young's modulus of elasticity (E) to give Eq. (37).

$$\frac{{Δɛ}_{p}}{2} = {{ɛ}_{f}^{′} ( 2 {N}_{f} )}^{c} \\ \frac{Δ σ}{2} = {{σ}_{f}^{′} ( 2 {N}_{f} )}^{b} where , \\ \frac{{Δɛ}_{p}}{2} = plastic strain amplitude \\ \frac{Δ σ}{2} = stress amplitude \qquad ( 38 , 39 )$$

For the case of PV module, fatigue properties of copper were taken from [64], given in Table 14.

TABLE 14
Fatigue parameters for copper [64]

| Fatigue parameter | Value |
|---|---|
| σ′_{f} | 345.08 MPa |
| ε′_{f} | 0.3 |
| b | −0.05 |
| c | −0.6 |

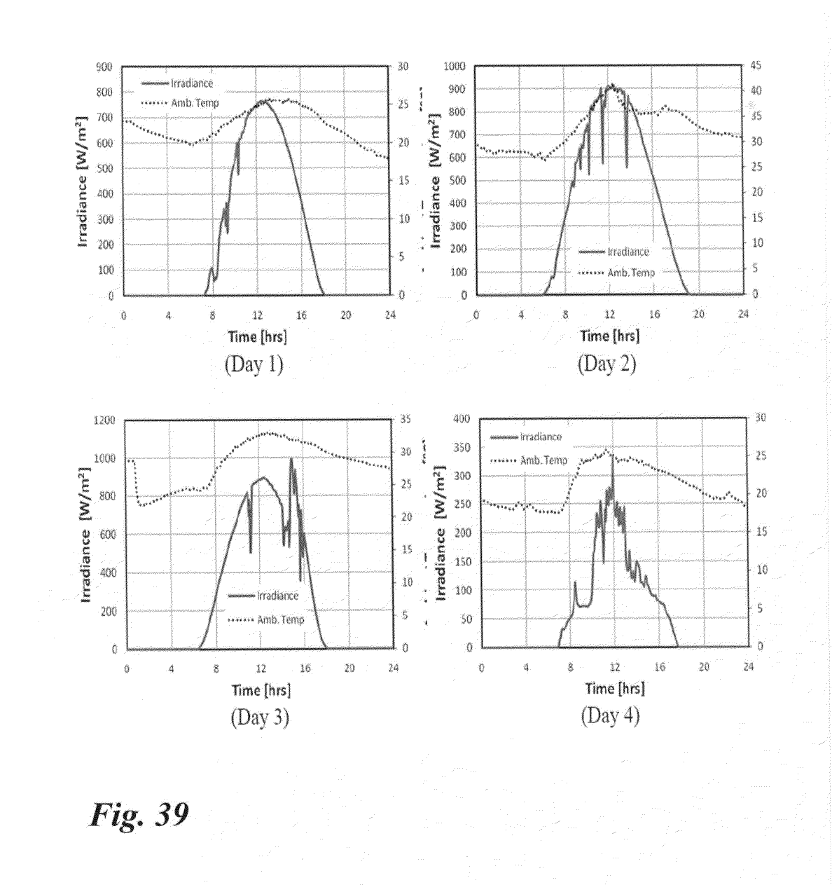

In the present disclosure the life of PV module was predicted operating under the atmospheric conditions of Jeddah, Saudi Arabia. From the irradiance and ambient temperature data for one year, four representative days were chosen to represent varying condition of irradiance throughout the year. The chosen days are displayed in FIG. 39 and had the following characteristics:
Day 1: First day was chosen out of January which represented low irradiance and low temperature.
Day 2: The second one was out of July representing hot weather and smooth irradiance/not cloudy.
Day 3: The third one was from October and was partially clouded with average ambient temperatures.
Day 4: The fourth one was chosen from December and had an extremely overcast sky with low temperatures.

The maximum and minimum principle strains for each of the four days were evaluated from FE simulation. Then time (no. of loading cycles) to crack initiation of copper interconnects was calculated through Eq. (37) under the assumption that the PV module continues to function under the same load cycle of the day.

Pre-stress due to the lamination process is studied followed by the actual temperature cycle of the representative days by coupling the thermal model to the structural model.

For the first part of analysis (lamination process), the module is constraint at one corner to allow free deformation. This will help to study the pure dependence of materials on one another. The stress-free temperature is taken as the lamination temperature (150° C.) because at that temperature every component of the module is independent to one another thus allowing a stress-free expansion. The room temperature is assumed to be 21° C. which is the final temperature after cooling. Steady state simulation is performed.

(a) Thermal Model

For the second part of analysis, thermal boundary conditions and loads are applied first. The Hay-Davies-Reindl-Klutcher (HDKR) model was used to evaluate the absorbed radiation from irradiance and optical parameters. Eq. (27) represents the HDKR model, Duffie J. A., and Beckman W. A., 2006, Solar Engineering of Thermal Processes, John Wiley & Sons, Inc., Hoboken, N.J., incorporated by reference herein, where S is the absorbed solar radiation, G is the horizontal plane solar radiation, Rbeam is the ratio of beam radiation on tilted plane to that on horizontal plane, ρ is the ground reflectivity, β is the tilt angle of PV module, Ai is the anisotropy index and M is the air mass modifier. The subscripts b, d, g and ref are for the beam, diffuse, ground reflected and reference solar radiations respectively. Some of the absorbed radiation is converted into electricity while the rest is converted into heat. The internal heat generation (Q) can then be given by Eq. (40).

$$Q = \frac{( 1 - {η}_{pv} ) \times S \times {A}_{panel}}{{V}_{pv cell}} \qquad ( 40 )$$

Where ηₚᵥ is the electrical efficiency of the cells, Apanel is the front area of PV module and Vpvcell is the volume of cells. Constant convection was applied with heat loss coefficients of 15.4 W/m2 K and 2.8 W/m2 K to the top and bottom surfaces of the module. The boundary condition applied to heat transfer equations of the top and bottom layers of the module is given by Eq. (41).

−n·q=h(T_{amb}−Tₛ) (41)

wherein is the surface normal, T_{amb} is the ambient temperature and Tₛ is the surface temperature.

(b) Structural Model

For the structural part, all the four edges of the module were fixed in all directions to approximate the presence of mounted frame. The reference temperature was the same as in lamination process. Thermal loads were applied from the solution of the coupled thermal model at each hour and steady state solution was performed.

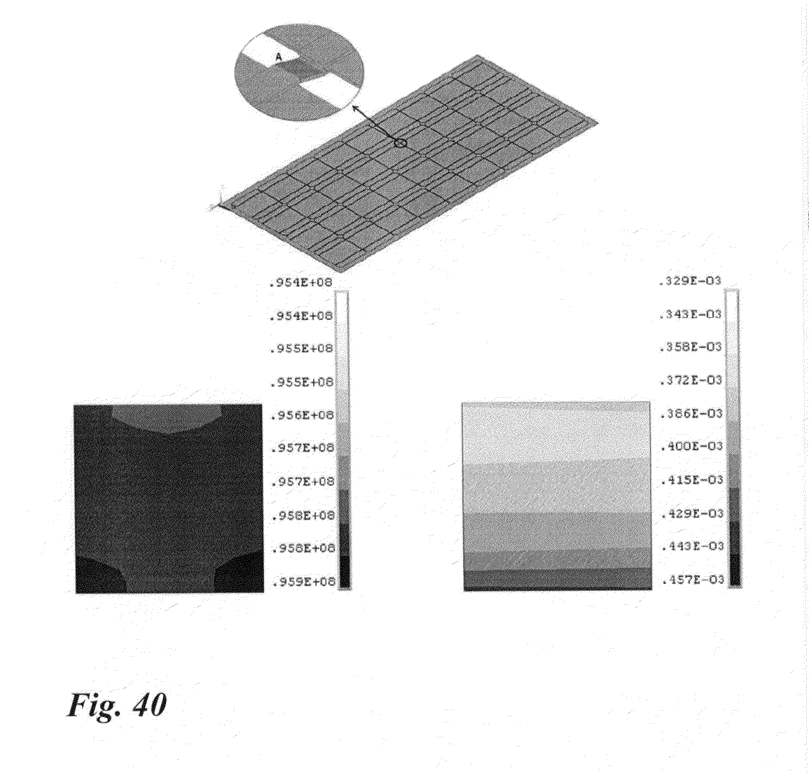

Lamination in PV modules is basically done to cure the encapsulant so that it holds the whole structure to form a single unit. Encapsulant (EVA) sheets are placed inbetween each layer and then are kept at 150° C. under vacuum for about 12 minutes. Then the structure is cooled down to room temperature. Cooling causes the encapsulant to solidify and adhere to all components. This process was simulated and the module was cooled to 21° C. At this temperature, von-Mises stress is almost constant over the whole interconnector strip and is about 95.8 MPa. They undergo plastic deformation just after the curing process and this phenomenon has also been discussed in Dietrich et al. From the experiments performed in Wiese et al. it is found that the yield stress of copper is around 94 MPa at room temperature. The contours for von-Mises stress and von-Mises plastic strain in the interconnects between two adjacent cells are given in FIG. 40 at 21° C. It should be noted that the shaded 3D view of the region for which the contours are displayed are merely for understanding. The results displayed are from the solution of the 2D shell model.

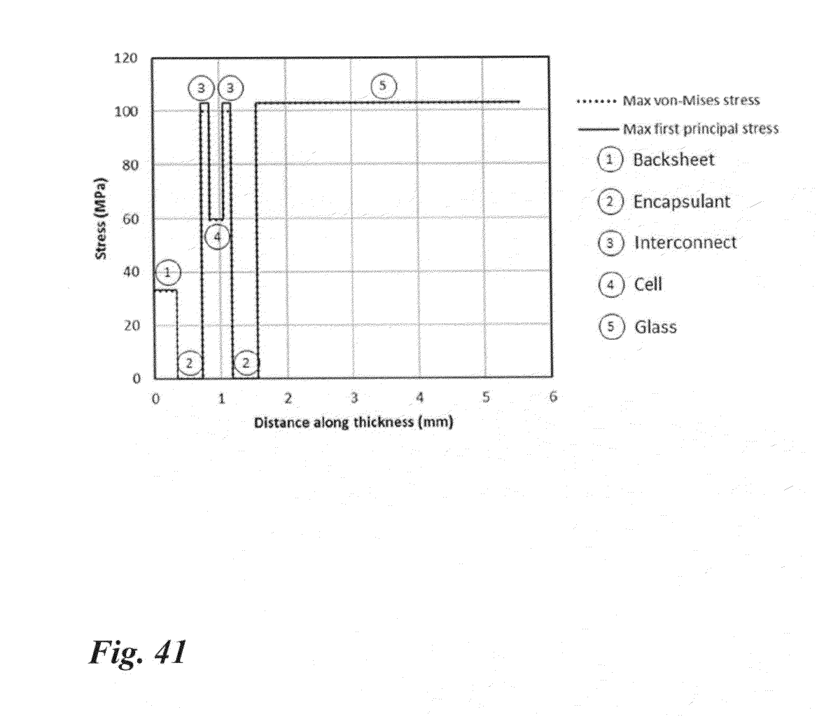

Out of the four days simulated, it was found that stresses are the highest during December. This month constitutes the lowest temperatures of the whole year which makes the PV module to operate farthest from its stress-free state. As the edges of the module are fixed to simulate the presence of frame, the nature of stresses is tensile over the whole laminate and hence, the third principal stress is almost zero. FIG. 41 shows the variation of maximum von-Mises stress through the thickness of the laminate on worst day condition at lowest temperature. It is seen that the maximum von-Mises stress and the maximum first principal stress are almost equal. Thus, the overall nature of stresses on all the components is almost tensile. Glass and the interconnects have almost the same first principal stress (around 103 MPa) which is highest amongst all. The high stress in glass is due to fixed boundary condition applied at its edges. Whereas, cells have a lower stress of 60 MPa as they are not directly constrained and their thermo-mechanical movements are aided due to the compliancy of the encapsulant material. The interconnects, on the other hand, are directly bound to cells causing them to yield. Lowest stress can be seen in the encapsulant as it is the least stiff material as compared to others.

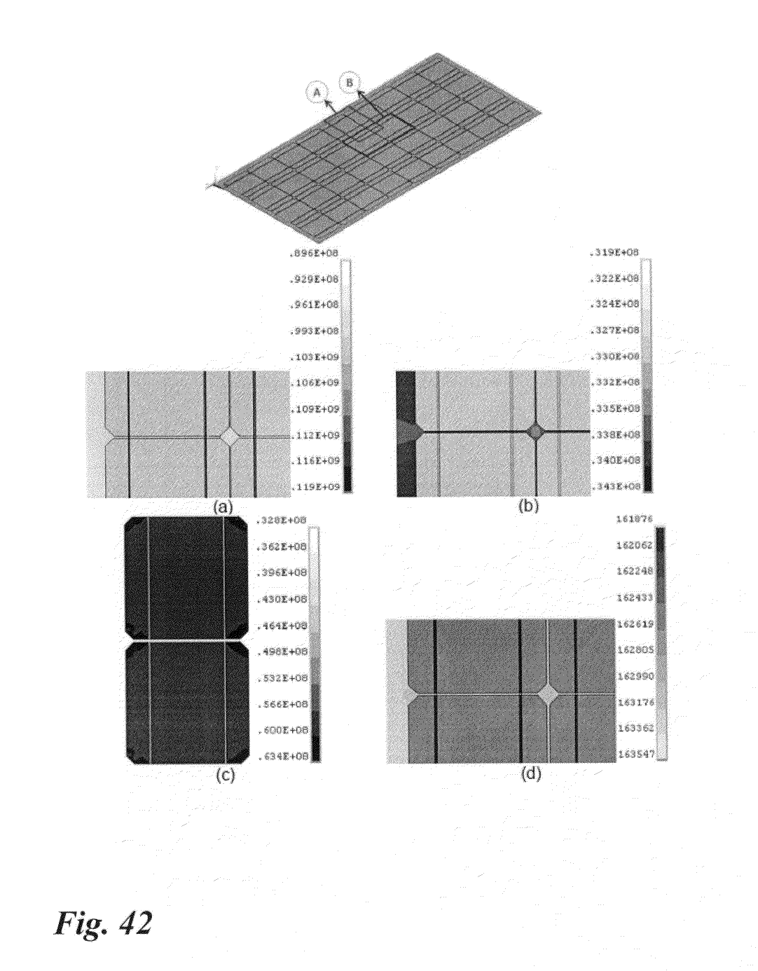

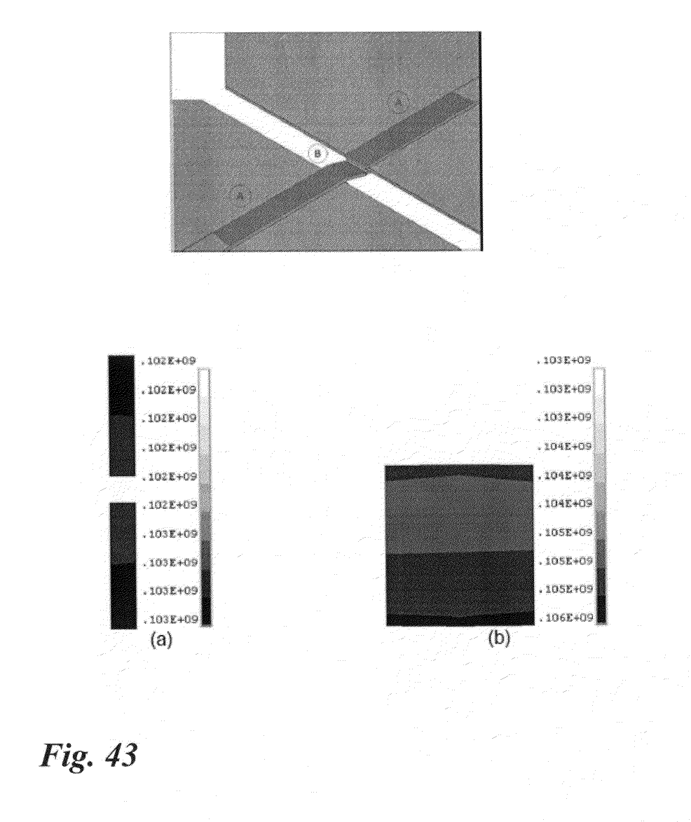

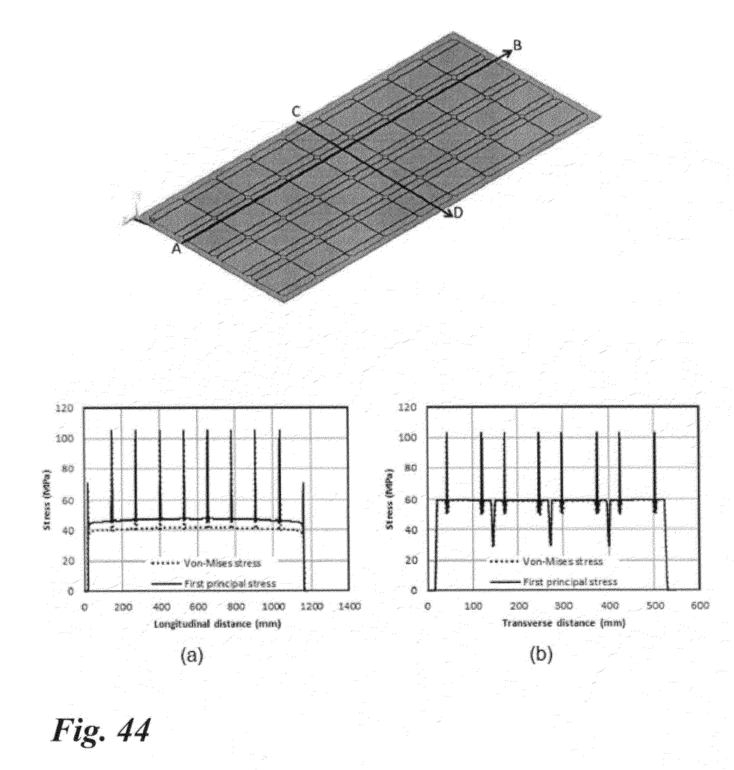

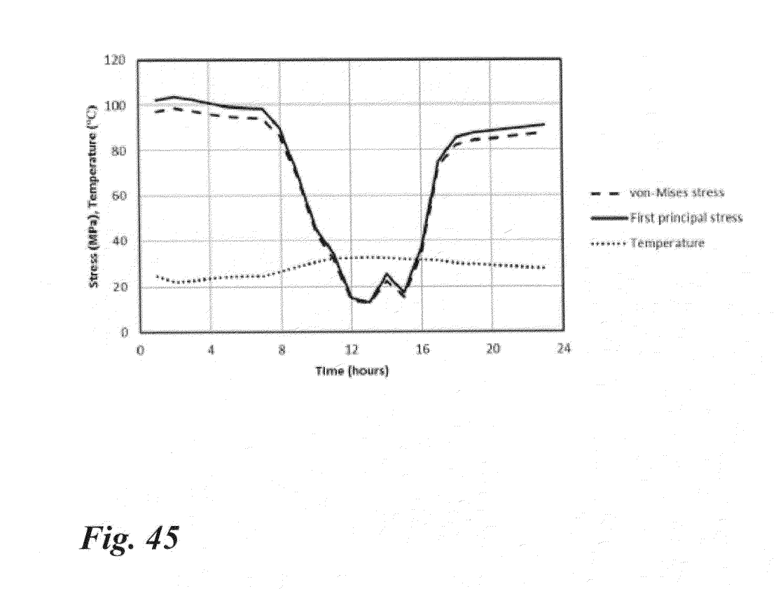

FIG. 42 shows the first principal stress contours of all the components of the laminate. Highest stress on glass can be seen along the interconnect region and is around 112 MPa. It is because of less encapsulant material present at that portion along the thickness. The segment of glass which is void of cells and interconnects beneath it has the least stress of 99.4 MPa. The majority area of glass is over the cells and has an intermediate value of stress around 106 MPa. There is no significant variation of stresses in backsheet but is less than that of glass (about 33 MPa) for having a lesser value Young's modulus of elasticity. The corners of the cells have the highest stress value of 63.4 MPa. This can be attributed to the lack of material present at the location due to rounded corners. Stress of 60 MPa covers the major region of cells and is higher than the portions representing the interconnect areas. The reason being that the effect of high CTE of glass as compared to cells is barred by the presence of the interconnect material in between. In the case of interconnects (shown in FIG. 43), it can be seen that the 100 maximum stress is on the corner of the connection between adjacent cells and is 106 MPa as the contraction of copper is restricted by silicon. Rest of the portion of interconnects has almost a constant stress of 103 MPa. FIG. 44 gives the stress variation along the longitudinal and transverse paths neglecting the backsheet and glass cover. Path AB displays maximum stresses is over the interconnect regions between adjoining cells. Lowest stress suggests the area of the encapsulant material which is the same in path CD. It is also seen that the stresses in cells are 13 MPa higher in the transverse direction than in the longitudinal direction, with almost the same principal and von-Mises stress. Stresses in interconnects in both direction are the same around 103 MPa. FIG. 45 shows the relation of von-Mises and first principle stress with time and temperature for Day 3. Location A represents maximum stress at minimum temperature whereas location B represents minimum stress at maximum temperature. Thus, by seeing the figure, it can be said that the temperature change of 10° C. causes a stress change of 85 MPa.

Table 15 shows the difference of the stress amplitudes for all the four days at a point over the interconnect region. As already mentioned that the maximum stress is during Day 4 but later in Table 16, it will be seen that the conditions of Day 4 also give maximum life for PV module. The reason is attributed to its least stress amplitude which can be seen according to Eq. (39). Thus, life or time to crack initiation is majorly affected by stress amplitude rather than its magnitude.

TABLE 15
Maximum and minimum principal stress and stress amplitude at
a point on the interconnect for all four representative days

| | Max Principal | Min Principal | |
|---|---|---|---|
| Day | Stress | Stress | Stress Amplitude |
| i | σₘₐₓ (MPa) | σₘᵢₙ (MPa) | Δσ/2 (MPa) |
| 1 | 104 | 27 | 38.5 |
| 2 | 99.8 | 16.6 | 41.6 |
| 3 | 102 | 6.8 | 47.6 |
| 4 | 105 | 59.2 | 22.9 |

The maximum and minimum total strain is given in Table 16. From them, the irrespective strain amplitudes (half of the difference between maximum and minimum strain) is evaluated. By using the material properties of copper in Table 6.1 and Eq. (6.1), the number of cycles is calculated for the four days and the number of years to crack initiation was determined. Now, to get the average life of a PV module operating in Jeddah, weights were assigned to each representative day according to their impact over the whole year. It was seen that at the maximum and minimum temperature of the day, the total strain was vice versa of temperature. It is because the zero strain temperature of the simulation was set to 150° C. as mentioned in the previous sections. Thus, it can be said that the temperature range of a day has a direct impact on the life of a PV module. To assign weights, total of average ambient temperatures (Ttotal) was calculated according to Eq. (42).

$${T}_{total} = {\sum }_{i = 1}^{n} \frac{{T}_{max\_i} + {T}_{min\_i}}{2} \qquad ( 42 )$$

where Tₘₐₓ_{_}ᵢ is the maximum ambient temperature of day i, Tₘᵢₙ_{_}ᵢ is the minimum ambient temperature of day i and n is the total no. of days in a year. Weight for each representative day is simply estimated by dividing the average temperature of the day by Ttotal. The average life (Lavg) can then be given by Eq. (43) and is calculated to be 26.63 years.

$${L}_{avg} = {\sum }_{i = 1}^{4} \frac{{W}_{day\_i} \times {L}_{day\_i}}{{W}_{total}} \qquad ( 43 )$$

where W_{day}_{_}ᵢ is the weight of the ith representative day, L_{day}_{_}ᵢ is the life of the ith representative day and total W is the sum of the weights of four representative days. The weights for the four days are given in Table 16.

TABLE 16
Maximum and minimum total strain, no. of cycles to crack initiation,
life and respective weights for the four representative days

| | Max Total | Min Total | | | Life |
|---|---|---|---|---|---|
| Day | Strain | Strain | Cycles | Weight | L_{day}_{_{—}}ᵢ |
| i | εₘₐₓ | εₘᵢₙ | N_{f} | W_{day}_{_{—}}ᵢ | (years) |
| 1 | 0.025931 | 0.019471 | 10563 | 10563 | 28.94 |
| 2 | 0.024076 | 0.017513 | 9685 | 9685 | 26.53 |
| 3 | 0.024237 | 0.017319 | 7366 | 7366 | 20.18 |
| 4 | 0.026252 | 0.01993 | 11937 | 11937 | 32.71 |

In the present disclosure FE analysis was used to determine the behavior of the components of PV module under operating conditions. A comprehensive structural model was formed and which was coupled to a thermal model. Starting from the lamination procedure and then by using meteorological data, the following conclusions have been drawn out of this work.
The high failure percentage of copper interconnects, given in the literature, is justified through its yielding during cooling after the lamination process. The plastic deformation makes it a subject of low-cycle fatigue.
Glass exhibits a dominating behavior due to its large thickness. As the contraction of glass was fixed, all the components of PV module had induced tensile stress within them. Glass also bears the maximum stress amongst all of the components as it bears most of the area of constraint, which was made to provide frame effect.
Silicon cells operate within a safe temperature range as the stresses induced in it are way below their yield stress; unless they are pre-cracked due to their manufacturing and soldering procedure.
Average life of a PV module has been estimated through its dominant mode of failure which is the breakage of copper interconnects and is found out to be 26.63 years. It is quite close to the 25-year warranty given my most of the PV module manufacturers.
The numerical procedure developed is inclusive of operating conditions and has the ability to predict proper behavior and life under operation with reasonable accuracy. It can be used as a tool to anticipate the effects of design changes in the form of stress distribution and life.

### Comparative Study of PV Module Encapsulants

The Photovoltaic (PV) industry has shown rapid growth in the last few decades. Its expansion has led to the selection of such materials in its construction, which enable it to meet its requirements efficiently. Now-a-days research on PV modules is mainly focused on the encapsulant material due to significant involvement of its properties over PV module performance. The structural performance of PV modules is enhanced due to the protective covering it provides to isolate silicon cells from the influence of the environment. At the same time, it also has to be transparent to light so as not to hinder the electrical performance of PV modules. It may also provide a medium to extract heat from the cells to increase their efficiency. So, the fulfillment of these requirements and others (discussed later) are important for an optimal performance of PV modules. During the 1960s and 1970s, Polydimethylsiloxane (PDMS)/Silicone was used as an encapsulant for PV modules Kempe M., 2011, “Overview of scientific issues involved in selection of polymers for PV applications,” 2011 37th IEEE Photovoltaic Specialists Conference, IEEE, pp. 000085-000090, incorporated by reference herein. But from the 1980s till today, the PV industry is dominated with Ethylene Vinyl Acetate (EVA) Mickiewicz R., Li B., Doble D., Christian T., Lloyd J., Stokes A., Voelker C., Winter M., Ketola B., Norris A., and Shephard N., 2011, “Effect of Encapsulation Modulus on the Response of PV Modules to Mechanical Stress,” 26th European Photovoltaic Solar Energy Conference and Exhibition, EU PVSEC, pp. 3157-3161, incorporated by reference herein. EVA was chosen over PDMS mainly due to its low cost. In the late 1990s, it was found that EVA turned yellow/brown due to UV radiation from the sun thus decreased its transmittance. It has also been reported to lose adhesion under UV light. Furthermore, EVA has the ability to concentrate water due to diffusion which makes it to react with moisture to form acetic acid. The acetic acid speeds up the corrosion process of the inner components of the PV module, Swonke T., and Auer R., 2009, “Impact of moisture on PV module encapsulants,” Proceedings of SPIE, N. G. Dhere, J. H. Wohlgemuth, and D. T. Ton, eds., Spie, p.74120A-74120A-7, incorporated by reference herein. This raises a question of its operation under humid climates. The glass transition temperature (Tg) of EVA is −15° C. and it comes in between the operating range of a PV module in cold regions. Thus, compliancy of EVA is an issue for modules operating in such regions. The mentioned concerns have recently revitalized the interest to study different polymers for PV module encapsulation. Such polymers include Polyvinylbutyral (PVB), Ionomer, PDMS and Thermoplastic polyurethane (TPU). The mentioned encapsulants have their merits and demerits over one another, but the best compromise amongst them needs to be chosen with respect to PV module performance and life.

Viscoelastic modeling of was utilized for EVA, PDMS, PVB and TPU to determine the proper effect of time-temperature dependence over stress distribution with in the components of the PV module. Ionomer was modeled as a hyper elastic. The electrical performance and life of the module is compared for all encapsulants. At the end, the remaining properties and cost for each encapsulant is seen to ultimately pick out an optimum one.

The main function of an encapsulant material is to protect the components of a PV module from foreign impurities and moisture along with the fortification from mechanical damage. An encapsulant also acts as an electrical insulator between cells and interconnects to prevent leakage current and binds all of the components together. Along with these, there are certain desirable properties of an encapsulant such as easy processability, good transmittance of light, high thermal conduction, long operating temperature range, UV radiation resistant, compliant, low cost and long life. These characteristics of an encapsulant have a direct impact on the performance and life of PV modules. A more compliant encapsulant will have a less modulus of elasticity. FE simulations were carried out to find out stresses in solder bond by changing the modulus of elasticity of EVA, Shioda T., and Zenkoh H., 2012, Influence of elastic modulus of encapsulant on solder bond failure of c-Si PV modules, Photovoltaic Module Reliability Workshop 2012, Golden, Colo., incorporated by reference herein. It was found that the increase in modulus caused mores tress transfer to solder bond. Same phenomenon is reported by Mickiewicz et al by performing accelerated aging tests on EVA and Silicones. The thermal conductivity of encapsulants is also an important factor. An increase in PV module electrical efficiency has been reported by increasing the thermal conductivity of EVA using thermally conductive fillers, Lee B., 2008, “Thermally conductive and electrically insulating EVA composite encapsulant for solar photovoltaic (PV) cell,” eXPRESS Polymer Letters, 2(5), pp. 357-363, incorporated by reference herein. More thermal conductivity of the encapsulant material will help to dissipate heat. It is also reported that PV modules face a 0.4% to 0.5% loss in efficiency per rise in temperature, Krauter S., and Hanitsch R., 1996, “Actual optical and thermal performance of PV-modules,” Solar Energy Materials and Solar Cells, 41-42, pp. 557-574, incorporated by reference herein. Thermally conductive polymers also help the cells to prevent mismatch losses which is usually generated due to temperature change (leading to change in power output) in cells. Cells may be burnt out due to heat generation, especially in the case of CPV. Encapsulants with larger thermal conductivity may assist the removal of heat to heat sink. Similarly, good light transmittance of encapsulants helps in more power generation. Long-term exposure to UV light may cause the breakage of bonds of encapsulant material. Encapsulants such as EVA don't remain transparent to light with such changes. Such chemical changes also cause the encapsulant to lose its adhesiveness and allows foreign impurities to enter and corrode the inner components of the module. Encapsulants with high water vapor transmission rate (WVTR) are the reason for corrosion of the solder bonds and copper interconnects. High water concentration ability in encapsulants such as EVA react with moisture to form acetic acid which speeds up the corrosion process, Ketola B., and Norris A., Moisture Permeability of Photovoltaic Encapsulants, Dow Corning Corporation, Midland, Mich., USA, incorporated by reference herein.

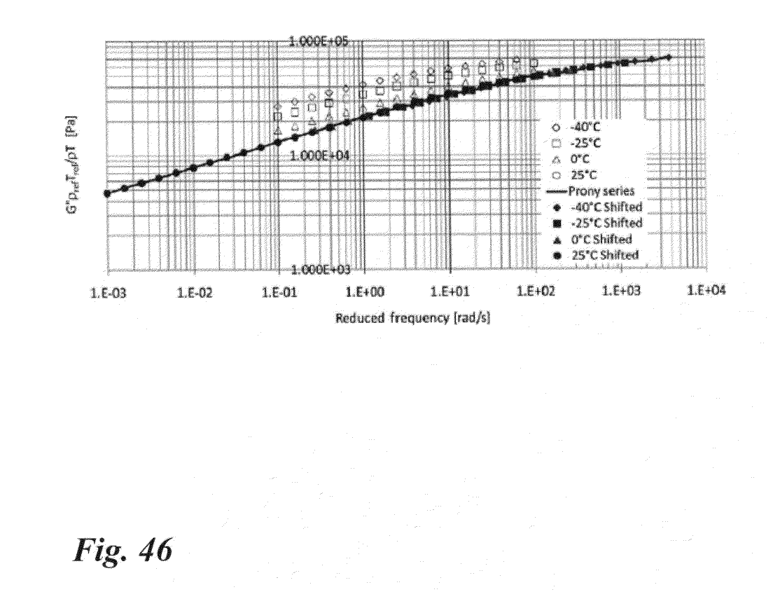

Dillard et al. have developed a numerical model to estimate stresses in PDMS sealants due to thermally-driven deformations, Dillard D. A., Yan L., West R. L., Gordon G. V., and Lower L. D., 2011, “Estimating the Stresses in Linear Viscoelastic Sealants Subjected to Thermally-Driven Deformations,” The Journal of Adhesion, 87(2), pp. 162-178, incorporated by reference herein. To model viscoelasticity of PDMS, experiments were performed on a controlled-strain rheometer at different temperatures over a frequency range. The recorded data was used to construct a master-curve by using the William-Landel-Ferry (WLF) shift function (Eq. (17)), to incorporate the effect of Time-Temperature-Superposition (TTS) as shown in FIG. 46. This master curve was then fit by Prony series (Eq.15)) of the Maxwell's model (FIG. 11); In the current work, instantaneous modulus (Gₒ) was found out by Eq. (22). Next, the relative moduli (φᵢ) were found out using Eq. (21) which were incorporated into the Finite-Element (FE) model.

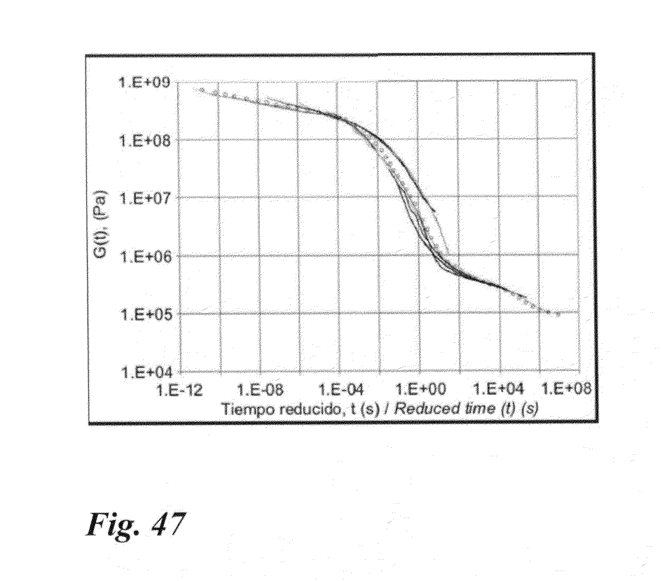

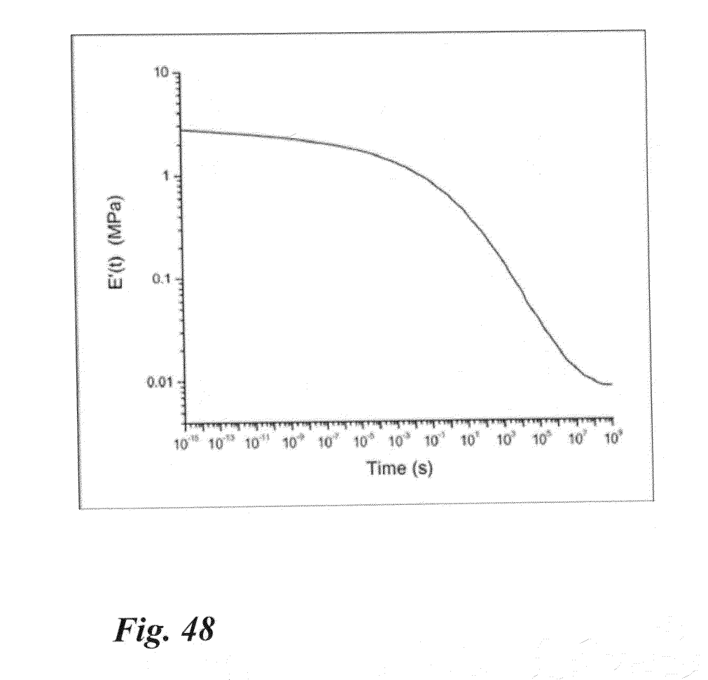

PVB is mostly used in structural laminated glass or glass/PVB/glass configuration. Sanz-Ablanedo et al. have performed the viscoelastic characterization of PVB, used in the stated application to incorporate the model into a numerical simulation, Sanz-Ablanedo E., Lamela M. J., Rodriguez-Pérez J. R., and Arias P., 2010, “Modelización y contraste experimental del comportamientomecánico del vidriolaminadoestructural,” Materiales de Construcción, 60(300), pp. 131-141, incorporated by reference herein. For this purpose, stress relaxation tests on PVB samples. The measured data was processed in a similar fashion to get the master-curve (FIG. 47). This master-curve was used to get φi, which is provided to ANSYS in the current work. Go was calculated for discrete data points of the curve in FIG. 47, using Eq. (23) and Eq. (24). Multi-layered structures are bonded together through a binding polymer such as TPU. Thermo-mechanical displacements of such structures lead to CTE mismatch and ultimately stressing of the laminate. To model such process, MacAloney et al. have characterized TPU to study its viscoelasticity. DMA was used to find the storage and loss moduli at different temperatures, MacAloney N., Bujanda A., Jensen R., and Goulbourne N., 2007, Viscoelastic Characterization of Aliphatic Polyurethane Interlayers, Aberdeen Proving Ground, MD 21005-5069, incorporated by reference herein. The frequency domain of the results was shifter to time domain using inverse Fourier transform. By going through a similar procedure, as described above, a single master-curve (FIG. 48) was constructed whose Prony coefficients were evaluated. The mentioned equilibrium modulus (G_{∞}) is used to find Go in the present work by Eq. (22). Go is then utilized to get φi as mentioned for PDMS.

Ionomer is used as a cover in golf balls. To simulate the collision of golf balls, Tanaka et al. have modeled Ionomer as a hyperelastic material which is also used in the current work, Tanaka K., Sato F., Oodaira H., Teranishi Y., and Ujihashi S., 2006, “Construction of the Finite-Element Models of Golf Balls and Simulations of Their Collisions,” Proceedings of the Institution of Mechanical Engineers, Part L: Journal of Materials: Design and Applications, 220(1), pp. 13-22, incorporated by reference herein. Although, it may not model the temperature and rate dependency of the material but it is a good assumption of the non-hookean properties of the polymer. The hyperelastic material properties are defined through the Mooney-Rivlin model given by Eq. (44),

$$W = {c}_{10} ( \overline{{I}_{1}} - 3 ) + {c}_{01} ( \overline{{I}_{2}} - 3 ) + \frac{1}{d} {( J - 1 )}^{2} \qquad ( 44 )$$

where,
W=Strain energy potential
I₁=First deviatoric strain invariant
I₂=Second deviatoric strain invariant
C₁₀,c₀₁=Material constants defining deviatoric deformation
d=Material incompressibility parameter
The initial shear modulus (μᵢ) and the initial bulk modulus (Kᵢ) are given by Eq. (45) and Eq. (46) respectively,

$$\begin{matrix}{µ}_{i} = 2 ( {c}_{10} + {c}_{01} ) & ( 45 ) \\ K = \frac{2}{d} & ( 46 )\end{matrix}$$

d can be defined as,

$$d = \frac{1 - 2 v}{{c}_{10} + {c}_{01}}$$

TABLE 17
Thermo-mechanical properties of polymers used in simulation

| | Properties | | | | | | | | | | | |
|---|---|---|---|---|---|---|---|---|---|---|---|---|
| | Eₒ | | C₂ | Tᵣ | Eᵢ | c₁₀ | c₀₁ | | ρ | α × 10⁻⁶ | k | C |
| Polymers | (MPa) | C₁ | (K) | (K) | (MPa) | (MPa) | (MPa) | ν | (kg/m³) | (K⁻¹) | (W/mK) | (J/kgK) |
| EVA | 1300 | 48.44 | 172.55 | 253 | — | — | — | 0.40 | 960 | 270 | 0.311 | 2090 |
| [37.39.41] | | | | | | | | | | | | |
| PDMS | 2.832 | 2.33 | 158 | 298 | — | — | — | 0.49 | 965 | 200 | 0.15 | 1460 |
| [73.77] | | | | | | | | | | | | |
| PVB | 2981 | 20.7 | 91.1 | 293 | — | — | — | 0.33 | 1030 | 412 | 0.2 | 1973 |
| [74.78] | | | | | | | | | | | | |
| TPU | 3.126 | 23.1 | 69.3 | 212 | — | — | — | 0.45 | 1230 | 220 | 0.176 | 1550 |
| [75.79.80] | | | | | | | | | | | | |
| Ionomer | — | — | — | — | 400 | 6.25 | 43.8 | 0.45 | 950 | 130 | 0.24 | 1200 |
| [76.81.82] | | | | | | | | | | | | |

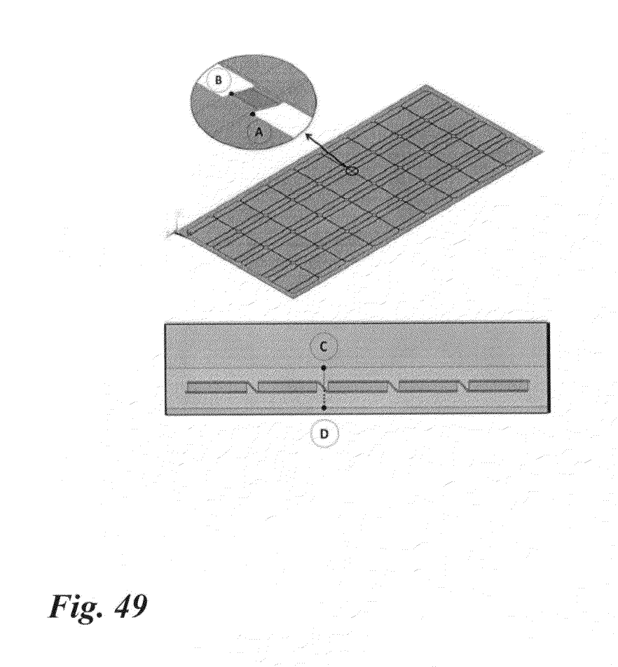

By sequentially coupling a transient thermal model and by using the meteorological data of Jeddah, Saudi Arabia, the simulation of four representative days was carried out. FIG. 49 gives four points selected on the PV module for which results are provided in Table 18. These points represent the critical points for each material and are at the interface of one another such that, A represents the point on cell at the interface of the interconnect, B represents the point on interconnect at the interface of the cell, C represents the point on glass at the interface of the encapsulant over the interconnect between cells and D represents point on back-sheet at the interface of the encapsulant below the interconnect region. Table 18 gives the von-Mises stress (σvon), the first principal stress (σ1) and the first principal total mechanical and thermal strain (∈total) which is later used in the life-prediction model. These results are provided at the minimum (Tmin) and maximum temperature (Tmax) for the month of October (Day 3). For cells, glass and backsheet, there is almost no difference within the operating stresses of the PV module. It can be inferred that the stress in cells is way below its yield stress, thus operate within a safe range. The highest stress is found in glass as it bears most of its part to frame which restricts its thermo-mechanical motion. An interesting set of results is seen over the interconnect region (point B). Although the changes in stress using all of the five encapsulants is insignificant, but the variation of first principal total mechanical and thermal strain (∈total) can be seen. The interconnects operate over its yield stress of 94 MPa. The Bilinear Isotropic hardening (BISO) model applied to copper causes large change in strains for small changes in stress. That is why a strain based life prediction model is used to find time to crack initiation in the copper interconnects. Copper faces a first principal stress difference of 97.5 MPa during the cycle of the day which is highest amongst all materials and makes it most vulnerable to fatigue. The strain it faces is almost more than 50 times higher than the other materials. An irregular pattern of strains is seen corresponding to their respective stresses as some of the encapsulants are so compliant that they help to provide free thermal motion.

Table 19 shows the von-Mises stress, first principal stress and the elastic strain in the encapsulant material for Day 3 at maximum and minimum temperature. Maximum stress can be seen in Ionomer whereas, TPU has the lowest stress. In the case of strains, PVB has induced maximum strain amongst all and on the contrary, Ionomer has the lowest strain.

TABLE 18
Table comparing von-Mises stress, first principal stress and total first principal strain
at four points (Fig. 49) using different encapsulants

| | A (Cell) | | | | | | B (Interconnect) | | | | | |
|---|---|---|---|---|---|---|---|---|---|---|---|---|
| | Tₘᵢₙ | | | Tₘₐₓ | | | Tₘᵢₙ | | | Tₘₐₓ | | |
| | σᵥₒₙ | σ₁ | | σᵥₒₙ | σ₁ | | σᵥₒₙ | σ₁ | | σᵥₒₙ | σ₁ | |
| | (MPa) | (MPa) | εₜₒₜₐₗ | (MPa) | (MPa) | εₜₒₜₐₗ | (MPa) | (MPa) | εₜₒₜₐₗ | (MPa) | (MPa) | εₜₒₜₐₗ |
| EVA | 39.1 | 44.6 | 0.0004 | 37.9 | 39 | 0.00032 | 98.8 | 103.4 | 0.024237 | 14.6 | 5.9 | 0.017319 |
| PDMS | 38.9 | 44.4 | 0.0004 | 37.9 | 33.7 | 0.00032 | 98.8 | 103.4 | 0.018438 | 15.9 | 4.1 | 0.010273 |
| PVB | 39.2 | 44.6 | 0.0004 | 37.9 | 38.9 | 0.00032 | 98.8 | 103.5 | 0.036816 | 14.9 | 4.8 | 0.027388 |
| TPU | 37.8 | 38.8 | 0.0004 | 37.8 | 38.8 | 0.00032 | 98.8 | 103.4 | 0.020884 | 15.1 | 5.3 | 0.01117 |
| Ionomer | 39.9 | 46.1 | 0.0004 | 40.1 | 40.2 | 0.00033 | 98.8 | 102.9 | 0.012874 | 13.7 | 6.6 | 0.007092 |
| | C (Glass) | | | | | | D (Backsheet) | | | | | |
| | Tₘᵢₙ | | | Tₘₐₓ | | | Tₘᵢₙ | | | Tₘₐₓ | | |
| | σᵥₒₙ | σ₁ | | σᵥₒₙ | σ₁ | | σᵥₒₙ | σ₁ | | σᵥₒₙ | σ₁ | |
| | (MPa) | (MPa) | εₜₒₜₐₗ | (MPa) | (MPa) | εₜₒₜₐₗ | (MPa) | (MPa) | εₜₒₜₐₗ | (MPa) | (MPa) | εₜₒₜₐₗ |
| EVA | 101 | 112.4 | 0.00027 | 64.5 | 69 | 0.00013 | 31.9 | 32.8 | 0.00038 | 19.2 | 19.5 | 0.0002 |
| PDMS | 101.1 | 112.6 | 0.00026 | 64.4 | 68 | 0.00013 | 31.9 | 32.8 | 0.00038 | 19 | 19.3 | 0.0002 |
| PVB | 101 | 112.4 | 0.00026 | 64.5 | 68.2 | 0.00013 | 31.9 | 32.8 | 0.00038 | 19.2 | 19.4 | 0.0002 |
| TPU | 101.1 | 112.6 | 0.00026 | 64.7 | 68.5 | 0.00013 | 31.9 | 32.8 | 0.00038 | 19.2 | 19.5 | 0.0002 |
| Ionomer | 100.1 | 110.4 | 0.00022 | 64.7 | 67.5 | 0.00011 | 31.9 | 32.7 | 0.00033 | 19.4 | 19.6 | 0.00017 |

TABLE 19
Von-Mises stress, first principal stress and total strain comparison of encapsulants at
minimum and maximum temperature for the month of October

| | σᵥₒₙ | | σ₁ | | | | |
|---|---|---|---|---|---|---|---|
| | (Pa) | | (Pa) | | εₑₗ | | |
| | | | | | | | Tₘᵢₙ − |
| | Tₘᵢₙ | Tₘₐₓ | Tₘᵢₙ | Tₘₐₓ | Tₘᵢₙ | Tₘₐₓ | Tₘₐₓ |
| EVA | 126320 | 29412 | 126180 | 29370 | 0.025565 | 0.014698 | 0.010867 |
| PDMS | 27588 | 16109 | 27270 | 16092 | 0.02812 | 0.016341 | 0.011779 |
| PVB | 91508 | 49578 | 91113 | 49559 | 0.052668 | 0.030548 | 0.02212 |
| TPU | 7465.6 | 1527.5 | 4554.9 | 1026.5 | 0.034514 | 0.020144 | 0.01437 |
| Ionomer | 8859800 | 5359700 | 8900800 | 5369900 | 0.016845 | 0.010135 | 0.00671 |

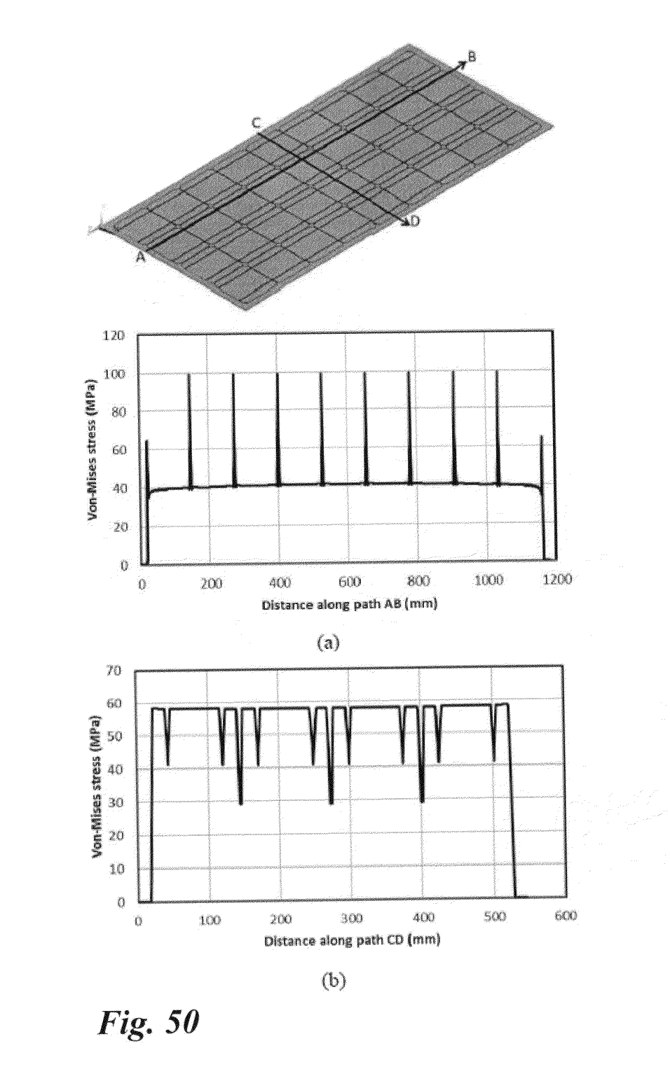

FIG. 50 provides the von-Mises stress variation over the PV module along longitudinal and transverse paths for Day 3. The shell layer considered includes the encapsulant, cells and interconnects between cells only. The same profile was seen for all of the five encapsulants with no significant stress difference which can be seen in Table 18. Thus, results are shown using EVA as the encapsulant material. The start of path AB includes the encapsulant material which is under minimum von-Mises stress of 0.12619 MPa. The maximum stress is found in the interconnect region and is around 100 MPa. Neglecting, the boundary edges of cells, they face an almost constant stress of 40 MPa. The same situation can be seen for the transverse path CD except that the stress in cells is increased to almost 58 MPa and it drops to 41 MPa below the interconnect region over it. The dominant effect of glass over other materials of the laminate has been discussed. The interconnects over the cells help to block the effect of glass thereby, reducing stress. The encapsulant between cells is stressed to 28 MPa as it has a little room of relief.

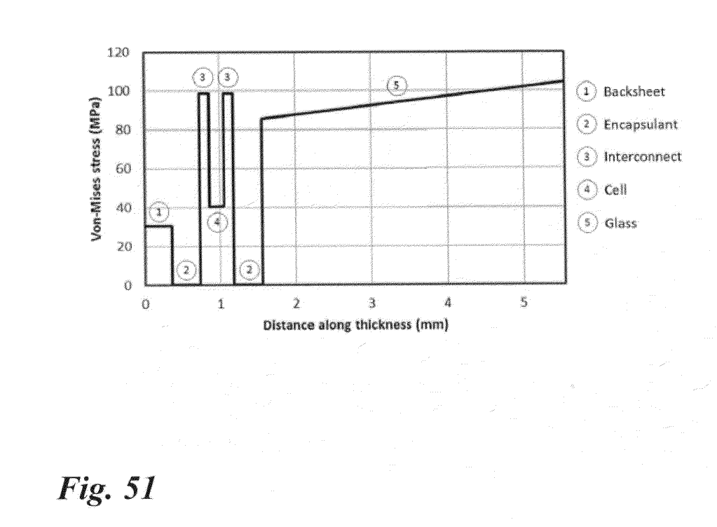

FIG. 51 gives the stress variation along the thickness of the module starting from backsheet to glass using EVA for Day 3. No variation of stress is seen along the thickness direction for each material except for glass. Glass also covers the maximum thickness within the laminate with a stress difference of almost 19 MPa. The interconnects above and below the cell share the same stress of 99 MPa. Cells constitute a lesser stress as its thermo-mechanical movement is aided through the compliancy of the encapsulant material.

TABLE 20
Maximum power point voltage and current along with the efficiency
of the PV module at 10:30 am during Day 3 for all encapsulants

| | Max. Power | Max. Power | |
|---|---|---|---|
| | Voltage | Current | Efficiency |
| Encapsulant | Vₘₚ (V) | Iₘₚ (A) | ηₚᵥ (%) |
| EVA | 13.1105 | 4.5326 | 6.0867 |
| PDMS | 13.0198 | 4.5305 | 6.0752 |
| PVB | 13.08 | 4.5319 | 6.0716 |
| TPU | 13.0822 | 4.5322 | 6.0731 |
| Ionomer | 13.1186 | 4.5337 | 6.092 |

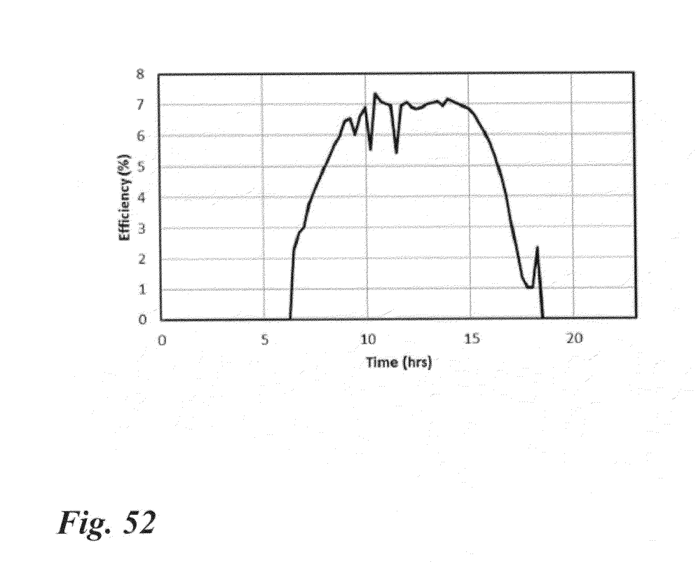

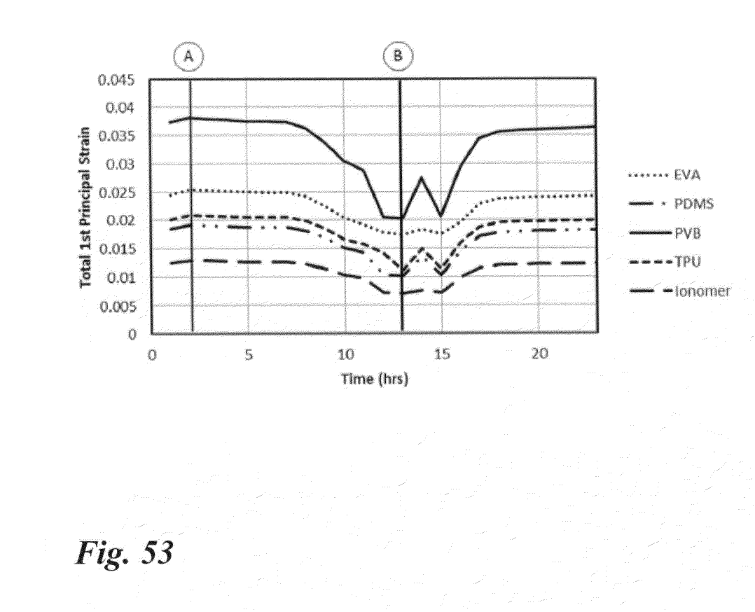

FIG. 52 shows the cell efficiency during Day 3. No change in cell efficiency was found by changing the encapsulants in the model as shown in Table 20. The power output of cells depends on cell temperature. There was a very little cell temperature difference for all five encapsulants and was around 0.5 to 1 K which led to almost no change. For life prediction, the Basquin-Coffin-Manson relationship (Eq. (37)) was used to predict life or time to crack initiation in copper interconnects. The total strain amplitude was found out as the half the difference between the maximum and the minimum first principal strains. FIG. 53 gives the first principal strain variation of copper during Day 3. As it can be seen PVB provides the most strain change during the day, and thus provides the minimum time to crack initiation, shown by Table 21. Similarly, the strain change in Ionomer is the least providing it the maximum life. Line A and B provide the times of maximum and minimum strain respectively using all encapsulants. The factor providing a great variation in life of PV module (Table 21), is the compliancy of the encapsulant material. The instantaneous moduli of the encapsulants (Eo) in Table 17 can be seen for comparison. PVB provides the highest value of modulus and thus resulting in minimum life. Similarly, the rest can be ranked by viewing it. The simulation, on the other hand, gives an idea of the extent to which the life has decreased or increased.

Table 21 also shows that the module is under worst condition during October, as suggested by the evaluated module lives. On the contrary, module life is best during December. It was found that the temperature range of the day during October and December was maximum and minimum respectively. In order to find average life (Lavg) for all encapsulants, weights were assigned according to Eq. (42). Eq. (43) was then used to get average life. PDMS, TPU and Ionomer are seen to better than the commonly used EVA with respect to structural performance. Life, by using Ionomer, may be overestimated due to the usage of hyperelastic model although the material is viscoelastic.

If the life outcomes of Table 21 are compared with the strains of Table 19, it can be seen that the strain range of the encapsulant material has an impact on the life of PV module such that the larger the strain range, the lesser is the life. It is also seen that the life trend of encapsulants in October is different to that of the other months. For instance, EVA has a better life in October as compared to PDMS, but by comparing their results during other months, PDMS excels EVA in life. According to FIG. 24, the minimum temperature (and the maximum strain of copper interconnects) is reached at 2 am. As each encapsulant relaxes at a different rate, at this time, some of the encapsulants are harder as compared to other, and might be softer at a later time. For January, July and December, the minimum temperature is reached at 11 pm, 6 am and 7 am respectively during which each encapsulant is much relaxed than October's case. Glass dominates the thermo-mechanical movements and forces all components of the PV module to follow its contraction during cooling due to its large thickness as compared to others. The encapsulant material restricts glass's motion by binding it and thus, it can be seen that the encapsulants having a larger strain range provide minimum life of PV module.

TABLE 21
Life of PV module using different encapsulants

| | | | | | | |
|---|---|---|---|---|---|---|
| | | Maximum | Minimum | | | |
| | | Total 1^{st} | Total 1^{st} | Half | | |
| | | Principal | Principal | of Strain | Life | Average |
| | Weights | Strain | Strain | Amplitude | L_{day} ᵢ | Life |
| Month | W_{day} ᵢ | εₘₐₓ | εₘᵢₙ | Δε/2 | (years) | L_{avg} |

EVA

| | | | | | | |
|---|---|---|---|---|---|---|
| January | 0.003147 | 0.025931 | 0.019471 | 0.00323 | 28.94 | 26.63 |
| July | 0.004786 | 0.024076 | 0.017513 | 0.0032815 | 26.53 | |
| October | 0.003932 | 0.024237 | 0.017319 | 0.003459 | 20.18 | |
| December | 0.003065 | 0.026252 | 0.01993 | 0.003161 | 32.71 | |

PDMS

| | | | | | | |
|---|---|---|---|---|---|---|
| January | 0.003147 | 0.019624 | 0.01443 | 0.002597 | 130.7 | 80.09 |
| July | 0.004786 | 0.018343 | 0.012668 | 0.0028375 | 65.23 | |
| October | 0.003932 | 0.018438 | 0.010273 | 0.0040825 | 9.631 | |
| December | 0.003065 | 0.019753 | 0.014607 | 0.002573 | 141.7 | |

PVB

| | | | | | | |
|---|---|---|---|---|---|---|
| January | 0.003147 | 0.038653 | 0.031931 | 0.003361 | 23.4 | 14.37 |
| July | 0.004786 | 0.036376 | 0.027268 | 0.004554 | 6.361 | |
| October | 0.003932 | 0.036816 | 0.027388 | 0.004714 | 5.361 | |
| December | 0.003065 | 0.039481 | 0.03303 | 0.003226 | 29.17 | |

TPU

| | | | | | | |
|---|---|---|---|---|---|---|
| January | 0.003147 | 0.021466 | 0.015898 | 0.002784 | 74.88 | 46.98 |
| July | 0.004786 | 0.020064 | 0.013949 | 0.003058 | 39.86 | |
| October | 0.003932 | 0.020884 | 0.01217 | 0.004357 | 7.482 | |
| December | 0.003065 | 0.02161 | 0.01609 | 0.00276 | 80.1 | |

Ionomer

| | | | | | | |
|---|---|---|---|---|---|---|
| January | 0.003147 | 0.01323 | 0.008077 | 0.002577 | 140 | 111.6 |
| July | 0.004786 | 0.012371 | 0.007099 | 0.002636 | 115.1 | |
| October | 0.003932 | 0.012874 | 0.007092 | 0.002891 | 57.27 | |
| December | 0.003065 | 0.013317 | 0.008191 | 0.002563 | 146.7 | |

EVA, PDMS, PVB, Ionomer and TPU represent the currently used and prospective encapsulants for flat plate PV module. Michael Kempedeals with the comparison of these encapsulants with respect to light transmittance, UV durability and electrical insulation, Kempe M., 2010, “Evaluation of encapsulant materials for PV applications,” Photovoltaics International 9th Edition, incorporated by reference herein. The properties have been summarized in Table 22. The glass transition temperature of an encapsulant is the reversible transition in polymer materials from a hard and relatively brittle state into a molten or rubber-like state. As the definition suggests, a polymer becomes stiff and its E is increased to one or two orders of magnitude when the operating temperature is lower than the Tg. The sudden change in modulus would make the encapsulant brittle and reduce its compliancy. Therefore, it is preferred that the Tg of the encapsulant should not lie within the operating range. As seen in Table 22, PDMS has a very low Tg and it is impossible for it to lie within the operating range of PV module thus makes it the best option. It can also be seen that the conventional EVA has its Tg in the operating range for PV modules working in cold regions.

As discussed earlier, encapsulant polymers must have the ability to be transparent to light so in order to achieve maximum power generation from cells. Table 22 provides the percentage transparency of encapsulants to light. Again, PDMS provides the highest transmittance with respect to other encapsulants. But as the difference is quite less between one another, changing an encapsulant would not have a major effect on the efficiency of PV module which is also discussed in the previous section. The transmittance of an encapsulant is majorly affected by UV radiation in light as it may cause destruction of bonds with in the encapsulant material thereby changing its color. It is well known that EVA turns to yellow/brown after few years of operation due to the same reason. Kempe has performed accelerating aging tests on these encapsulants by exposing them to 42 UV suns at a temperature between 80 to 95° C. As shown in table 22, PDMS samples showed no significant loss for up to 6000 hours of exposure.

EVA and TPU showed loss of transmittance between 750 to 6000 hours. Ionomer was better than EVA and PVB had lost the most transmittance. High electrical resistivity of a polymer prevents leakage current as well as electrochemical corrosion. All five polymers were measured in both dry and wet conditions. PVB was mostly affected by water due to its ability to absorb it. It showed least resistance in both dry and wet conditions. Other polymers were slightly affected by saturation. Ionomer and PDMS had almost the same resistance which was highest amongst all of the polymers.

The impact of moisture over PV module encapsulants can be measured by Water Vapor Transmission Rate (WVTR) and water concentration. WVTR is actually the measure of rate of moisture ingress into the PV module through encapsulant. Encapsulants with high WVTR are the reason for corrosion of the solder bonds and copper interconnects. Water concentration is actually the measure of the water absorption ability of a polymer. Swonke and Auer measured WVTR and water concentration of the encapsulants and found that Ionomer was the most suitable polymer with respect to moisture stability. PDMS has a high value of WVTR but did not absorb water. PVB had the highest water absorption with high WVTR and thus provides highest vulnerability. Rest of the polymers also had the ability to absorb and transmit water with their values mentioned in Table 22.

In order to provide the best encapsulant for PV module with respect to its properties and outcomes of life, weighting and rating decision matrices have been utilized. The weighting matrix (Table 23) is used to determine the relative importance of the properties of encapsulants. Each property and outcome of encapsulant usage was compared over one another (by comparing the columns with the rows of Table 23). If a column property was considered to be more important than the row one, a “+” sign was entered in the relative position. Similarly, if it is considered less important, then a “−” was entered. The mentioned actions helped to assign weights to each property. Table 24 gives the rating matrix for encapsulants. Each property was first ranked in a scale of 1 to 5. To do so, the property was first normalized by its respective maximum value and then multiplied by five. For example, life of PV module using PDMS encapsulant is mentioned to be 80.09 years. It is the divided by the life of Ionomer (111.6 years) which is the maximum amongst all to give 3.59 out of 5. The computed ranking is then multiplied by the respective weight of the property from Table 23, to give the final rank. At the end, sum of all the results for each encapsulant gives its final score which helps to decide the best encapsulant for PV module.

One of the most important properties of encapsulant is that it should be transparent to light. High transmittance leads to better power output and without it, a PV module is nonoperational. Thus, it was given the highest importance within Table 23. Next, the UV durability of the encapsulant is assessed. The importance of UV durability was set in accordance with experiments performed by Dechthummarong et al. Dechthummarong C., Wiengmoon B., Chenvidhya D., Jivacate C., and Kirtikara K., 2010, “Physical deterioration of encapsulation and electrical insulation properties of PV modules after long-term operation in Thailand,” Solar Energy Materials and Solar Cells, 94(9), pp. 1437-1440, incorporated by reference herein. The experiment involved the testing procedure prescribed by IEC 61215. The module was kept under illumination of not less than 1000 Lx and was then examined visually. Next, the DC dielectric insulation test was carried out under humidity. The yellowing/browning of the encapsulant was seen along with the corrosion along the busbar of the cells. This suggested delamination which is a cause of moisture. When the electric insulation properties were tested, it was found that there was no dielectric breakdown and the insulation was still within the limits of IEC61215. With the introduction of Ce-doped glass, as given in Mcintosh et al. Mcintosh K. R., Cotsell J. N., Cumpston J. S., Norris A. W., Powell N. E., and Ketola B. M., 2008, “The Effect of Accelerated Aging Tests on the Optical Properties of Silicone and EVA Encapsulants,” Proc. Eur. PVSEC (2008), pp. 3475-3482, incorporated by reference herein, much of the UV light is filtered and hence structural life of copper interconnects is preferred over it. In addition to this the breakage of copper interconnects has been attributed to thermal cycling and has a percentage of being a reason of warranty returns. High WVTR irresponsible for allowing water to enter the PV module which causes corrosion of the inner components and ultimately failure. But a more hazardous property of the encapsulant is water absorption or concentration as it enables the encapsulant, such as EVA, to react with moisture to form acetic acid which speeds up the corrosion process. The properties related to the resistance to moisture ingression thus have a high weightage. Finally, it is seen that the cost has also been given a large importance as now a-days technology changes are fast, and it is preferred to have cheap technology with satisfactory results, so that it can be replaced easily with a more advance alternative within a few years.

Table 24 gives the rating matrix and it suggests Ionomer to be the best option amongst all encapsulants. Although its life is somewhat over-estimated due to the usage of hyperelastic properties but it is good in other properties as well. EVA is next as it gains a heavy score due to its low cost. EVA is also better than TPU and PVB in other aspects. PDMS provides the best properties, but its high cost lags it behind.

In the present disclosure the thermal, structural and life prediction models were coupled to find life of the PV module using five different encapsulants. EVA, PDMS, TPU, PVB and Ionomer were modeled and their respective results were discussed and compared. The comparison also includes the findings in the literature to draw out the following conclusions:
Changing the encapsulant material of PV module has an insignificant effect on the stresses of its components.
More PV module life is observed by using encapsulants with least strain range.
The efficiency of the PV module is not affected by changing its encapsulant.
Maximum life of PV module is predicted when Ionomer is used as an
encapsulant. On the contrary, the usage of PVB gives minimum life.
Ionomer is seen to be as the best encapsulant for PV modules as it provides a mix of good properties at a reasonable cost as rated by the decision matrix.

TABLE 22
Comparison of encapsulant properties in the literature

| | Properties | | | | |
|---|---|---|---|---|---|
| | | | UV Durability | Volume | |
| | Glass Transition | Light | (under 42 suns | Resistivity/Electrical | |
| | Temperature | Transmittance | at 6000 hours of | Insulation | Moisture |
| Encapsulants | (T_{g}) [86] | [83] | exposure) [66] | (Ohm-cm) [66] | Ingression [68] |
| EVA | −16° C. | 93.9% | Significant | 10¹⁴ | WVTR = |
| | | | degradation | | 115 g⁻¹d⁻¹: |
| | | | during 750 to | | Water |
| | | | 6000 hours | | concentration is |
| | | | | | lower than TPU |
| PDMS/ | <−100° C. | 94.5% | No significant | 10¹⁶ | WVTR = |
| Silicone | | | loss | | 310 g⁻¹d⁻¹: |
| | | | | | No water |
| | | | | | concentration |
| PVB | 35° C. | 93.9% | Poor | 10¹² (Dry) | WVTR = |
| | | | performance | 10¹⁰ (Wet) | 310 g⁻¹d⁻¹: |
| | | | | | Highest water |
| | | | | | concentration |
| TPU | 21° C. | 93.3% | Significant | 10¹⁴ | WVTR = |
| | | | degradation | | 510 g⁻¹d⁻¹: |
| | | | during 750 to | | Water |
| | | | 6000 hours | | concentration is |
| | | | | | lower than PVB |
| Ionomer | 69° C. | 92.3% | Better than EVA | 10¹⁶ | WVTR = |
| | | | with some loss | | 55 g⁻¹d⁻¹: |
| | | | | | No water |
| | | | | | concentration |

TABLE 23
Weighting matrix for properties
of encapsulant and its outcomes

| ID | CRITERIA | A | B | C | D | E | F | G | TOTAL | WEIGHT |
|---|---|---|---|---|---|---|---|---|---|---|
| A | Light | | + | + | + | + | + | + | 6 | 0.286 |
| | Trans- | | | | | | | | | |
| | mittance | | | | | | | | | |
| B | UV | − | | + | − | − | − | − | 1 | 0.048 |
| | Durability | | | | | | | | | |
| C | Electrical | − | − | | − | − | + | − | 1 | 0.048 |
| | Insulation | | | | | | | | | |
| D | WVTR | − | + | − | | − | + | − | 3 | 0.143 |
| E | Water | − | + | + | + | | + | − | 4 | 0.190 |
| | Absorbance | | | | | | | | | |
| F | Structural | − | + | − | − | − | | − | 1 | 0.048 |
| | Life | | | | | | | | | |
| G | Cost | − | + | + | + | + | + | | 5 | 0.238 |
| | | | | | | | | TO- | 21 | 1 |
| | | | | | | | | TAL | | |

TABLE 24
Rating matrix for encapsulants by scaling properties on a scale of 1 to 5 and the
weights from Table 23

| | | RATING | | | | | WEIGHTED RATING | | | | |
|---|---|---|---|---|---|---|---|---|---|---|---|
| CRITERIA | WEIGHT | EVA | PDMS | PVB | TPU | Ionomer | EVA | PDMS | PVB | TPU | Ionomer |
| Light Transmittance | 0.286 | 4.97 | 5 | 4.97 | 4.93 | 4.88 | 1.421 | 1.430 | 1.421 | 1.410 | 1.396 |
| UV Durability | 0.048 | 3 | 5 | 1 | 3 | 4 | 0.144 | 0.240 | 0.048 | 0.144 | 0.192 |
| Elecuical Insulation | 0.048 | 0.05 | 5 | 0 | 0.05 | 5 | 0.002 | 0.240 | 0.000 | 0.002 | 0.240 |
| WVTR | 0.143 | 2.42 | 0.9 | 0.9 | 0.54 | 5 | 0.346 | 0.129 | 0.129 | 0.077 | 0.715 |
| Water Absorbance | 0.190 | 3 | 5 | 1 | 2 | 5 | 0.570 | 0.950 | 0.190 | 0.380 | 0.950 |
| Structural Life | 0.048 | 1.19 | 3.59 | 0.64 | 2.07 | 5 | 0.057 | 0.172 | 0.031 | 0.099 | 0.240 |
| Cast | 0.238 | 5 | 0.75 | 3.33 | 2.58 | 2.58 | 1.190 | 0.179 | 0.793 | 0.614 | 0.614 |
| | | | | | | TOTAL | 3.731 | 3.340 | 2.611 | 2.727 | 4.347 |

Sensitivity analysis is used to detect the influence of the encapsulant material over the structural, thermal and electrical performance of PV module. The constitutive, thermal and geometrical properties of the encapsulant are slightly varied and results are reported by performing FE analysis by taking Ethylene-Vinyl Acetate (EVA) as the nominal case. The measurement of the results is done through electrical and structural performance of the PV module.

Much of the principles of sensitivity analysis have been discussed by Malik et al, Malik M. H., Arif A. F. M., Al-Sulaiman F. A., and Khan Z., 2013, “Impact Resistance of Composite Laminate Flat Plates-A Parametric Sensitivity Analysis Approach,” Composite Structures, incorporated by reference herein. To find the influence of an input to the model over its outcomes, let us consider the independent input variables as Xi. The vector X denotes the set of these variables.

X=X̅±Uₓ (47)

In Eq. (47), X denotes the nominal value of the independent variable and the UX is the small change about the nominal value. The range of UX is selected such that the nominal value, if changed with UX, lies within the real domains of the problem. Or it can be said that the change may be quite less i.e. from 5% to 10% of the nominal value.

Y=Y(X₁,X₂ . . . X_{N}) (48)

Y defines the output variable in Eq. (48), such that it is a function of all the input variables Xi. Therefore the uncertainty in the output variables is linked with the uncertainty of the input variables by Eq. (49).

$${U}_{Y} = \frac{d Y}{d X} {U}_{X} \qquad ( 49 )$$

To include the effect of the uncertainties of all the input parameters, the uncertainty in Y can be expressed in terms of the root sum square values given in Eq. (50). The uncertainties are normalized as provided by Eq. (51).

$${{U}_{Y} [ {\sum }_{i = 1}^{N} {( \frac{\partial Y}{\partial {X}_{i}} {U}_{{X}_{i}} )}^{2} ]}^{1 / 2} \\ ( \frac{{U}_{Y}}{\overline{Y}} ) = {\{ {\sum }_{i = 1}^{N} {[ ( \frac{\partial Y}{\partial \overline{Y}} \frac{{\overline{X}}_{i}}{\partial {X}_{i}} ) ( \frac{{U}_{{X}_{i}}}{{\overline{X}}_{i}} ) ]}^{2} \}}^{1 / 2} \qquad ( 50 , 51 )$$

One of the terms in Eq. (51) is the Normalized Sensitivity Coefficient (NSC) which is used to compare the impact of an input over a models output. This term is given in Eq. (52).

$${NSC}_{{X}_{i}} = {( \frac{\partial Y}{\partial \overline{Y}} \frac{{\overline{X}}_{i}}{\partial {X}_{i}} )}^{2} \qquad ( 52 )$$

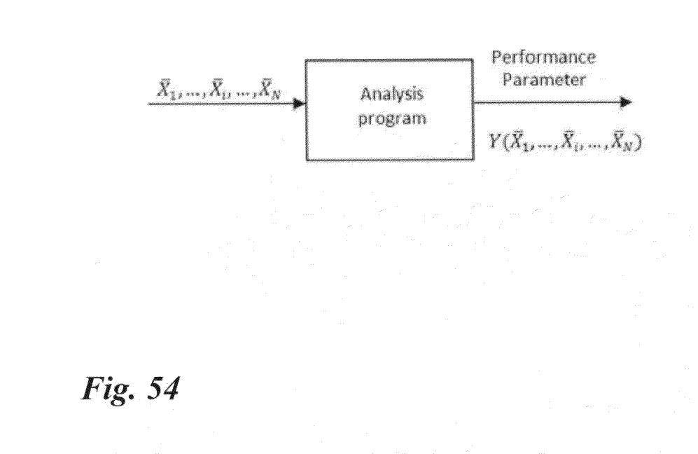

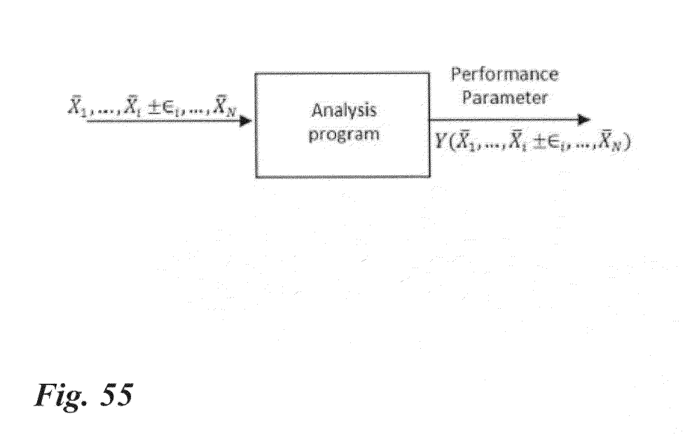

The whole idea of sensitivity analysis is portrayed by FIG. 54 and FIG. 55. The first figure gives the nominal case where a certain set of inputs is provided to the program to compute the output. In order to find the influence of an input, it is varied to add the uncertainty in the output. This way, each input is changed to a small amount keeping others constant and the results are recorded and analyzed.

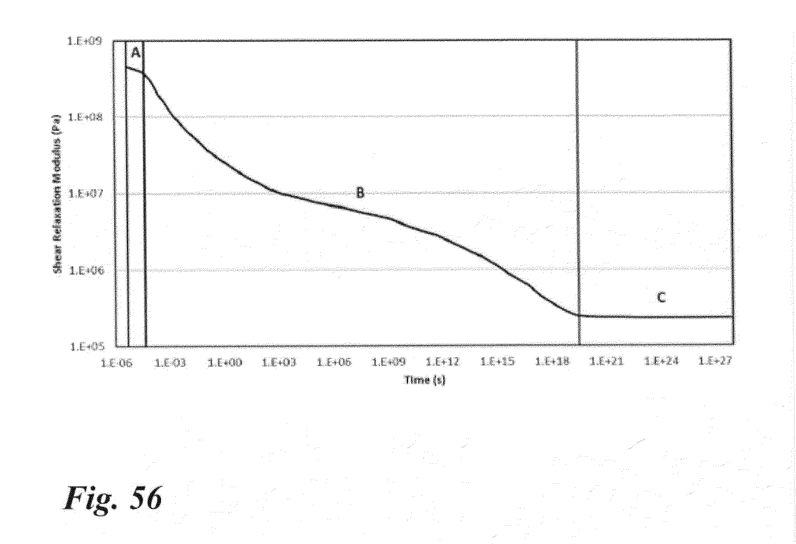

The selection of the varying input parameters are based on the constitutive, thermal and geometrical properties of the encapsulant. Five encapsulants were studied and compared. It was seen that EVA is mainly used due to its cost effectiveness and satisfactory properties. Thus, EVA is selected to see what parameters are important to consider in the selection of an encapsulant for PV module. Viscoelastic modeling of EVA where Eq. (15) provided its relaxation modulus. The relaxation curve of EVA on a time scale can be divided into three portions, glassy, viscoelastic and rubbery as given by FIG. 56. The glassy region represents the rigid state of EVA where it is brittle. The viscoelastic region represents the degradation of the viscosity of the material. The decrease is viscosity is seen in the form of decrease in modulus of the material. It is the region where the glass transition temperature of the polymer lies. After the glass transition, the material goes on to its rubbery state where the polymer is flexible and soft. By seeing the time scale it can be inferred that the PV module operates when the encapsulant is in viscoelastic mode. After all of these, the polymer comes in the flow region (not shown) which represents its degradation by showing its ability to flow.

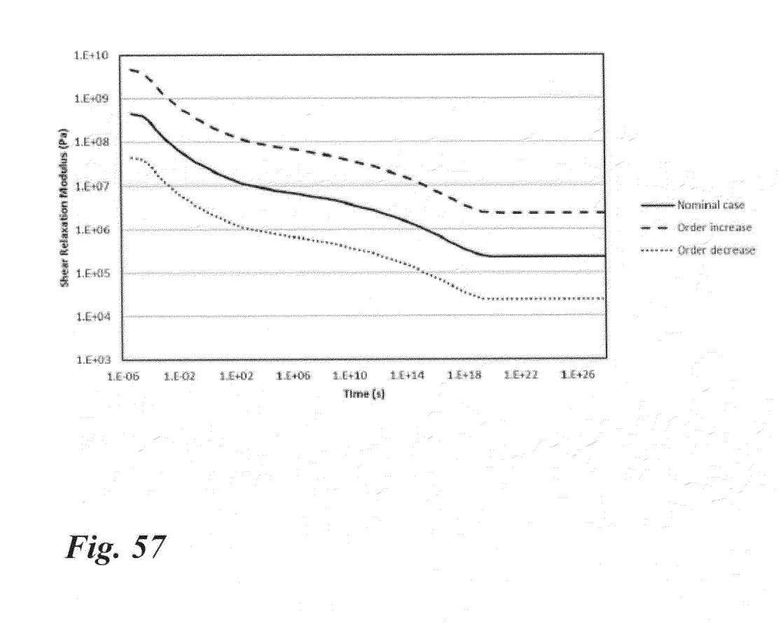

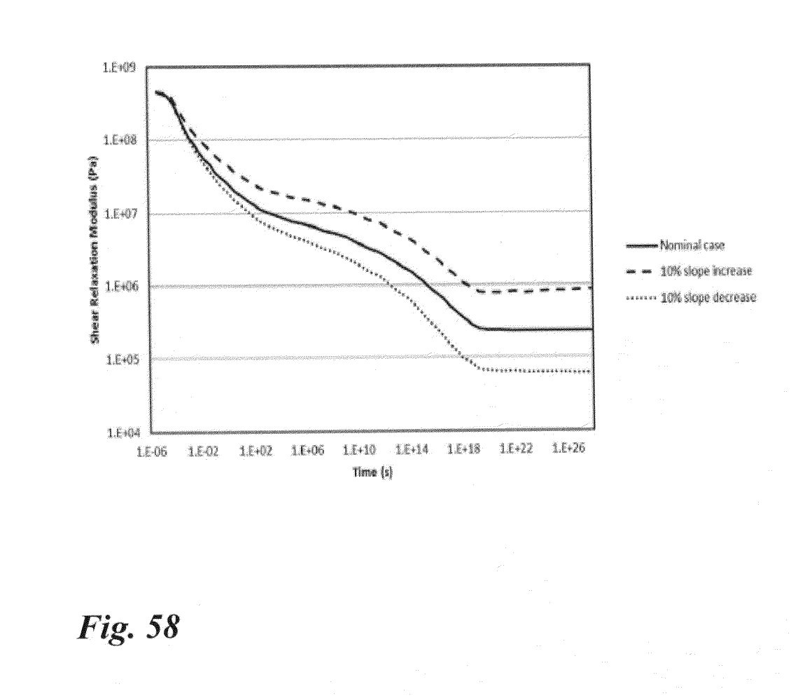

The term Go in Eq. (15) is the instantaneous modulus of EVA. Or it can be said that it gives the start of the relaxation curve in time-temperature domain while keeping its shape constant. This is explained by FIG. 57, where Go was varied by an order from the nominal case. Another property ought to change is the overall slope of this curve. The slope change provides the rate at which EVA degrades its relaxation modulus. It is done by varying the modulus at each time with the variation increasing from its previous value as advancing over the time scale. The overall percentage increase or decrease is measured by the sum of nominal and changed moduli and was kept up to 10%.

Next focus is towards the thermal properties of an encapsulant material. The thermal conductivity is an important factor as it will define the ability of a polymer to dissipate heat from cells to the environment. It is well known that the heating of cells is a cause of its decrease in efficiency. Similarly, by increasing the density and specific heat of the encapsulant, the conductive heat loss of the encapsulant increases thereby barring heat from reaching the cells. The effect of CTE has a direct impact on the structural life of PV module as it will define the inter-structural movements in the module where each component is constrained onto one another. The only geometric parameter which was varied was the thickness of the encapsulant.

The outputs are measured in the form of structural and electrical performance. Structural performance is measured through the life prediction formula given by Eq. (37) which is actually the time to crack initiation in the copper interconnects.

Power output is measured by the procedure used by the electrical model. The selection list is summarized by Table 25 with their nominal values. The life mentioned is for the month of July. This month is chosen as it has the most weightage over others. The overall life is not calculated in order to save simulation time. There is no value for the slope of the relaxation curve as it directly gives the fractional percentage (δx/x) through the procedure described before and is equal to 0.1. This fractional percentage is directly used in Eq. (52).

TABLE 47
List of variables with their nominal values
selected for sensitivity analysis

| | |
|---|---|
| Variable | Nominal value |

Inputs

| Instantaneous shear modulus (Gₒ) | 464 | MPa |
|---|---|---|
| Slope of relaxation curve | — | |
| Coefficient of thermal expansion (CTE) | 270 × 10⁻⁶ | K⁻¹ |
| Thermal conductivity (k) | 0.311 | W/m K |
| Specific heat (C) | 2090 | J/kg K |
| Density (p) | 960 | kg/m³ |
| Thickness (r) | 1.2 | mm |

Outputs

| | | |
|---|---|---|
| Life in July | 26.53 | years |
| Power output | 53.7095 | W |

To calculate power output, thermal model for PV module was utilized to find the cell temperatures. The cell temperatures along with the absorbed solar radiation were used in the electrical model for power output. Similarly, for life estimation, maximum and minimum total principal strains were evaluated for copper interconnects and were deployed in Eq. (37). For the month of July, it was seen that the maximum efficiency is at 10:30 am, so the results reported in Table 26 are at this time.

By using the nominal values in Table 25 and input and output variables from Table 26, NSC was evaluated in terms of power output and life.

The instantaneous shear modulus was changed by one order (FIG. 57) and its exponents were utilized in the Eq. (52). In the case of life, it is seen that it provides the minimum impact amongst all parameters. It is clear that the life prediction formula deals with the half of strain amplitude, and the amplitude remains almost same in all the three cases. The change in instantaneous shear modulus, definitely, will not have an impact on cell temperature. Therefore, no change in power output is observed to give NSC a value of zero.

TABLE 26
Outputs and NSCs with respect to varying input properties of EVA encapsulant

| | | | | | | Life | Cell | Power | NSC (Eq. (8.6)) | |
|---|---|---|---|---|---|---|---|---|---|---|
| | | Input | | Total Strain | | Y₁ ± ΔY₁ | Temperature | Y₂ ± ΔY₂ | wrt | wrt |
| Property | Variation | Xᵢ ± ΔXᵢ | | εₘₐₓ | εₘᵢₙ | (years) | T_{c} (K) | (W) | Life | Power |
| Gₒ | +Order | 4640 | MPa | 0.024192 | 0.017512 | 26.51 | 329.265 | 53.7095 | 9.09 × 10⁻⁶ | 0 |
| | change | | | | | | | | | |
| | −Order | 46.4 | MPa | 0.02419 | 0.017511 | 26.53 | 329.265 | 53.7095 | | |
| | change | | | | | | | | | |
| Slope | +10% | — | | 0.026919 | 0.01981 | 20.03 | 329.265 | 53.7095 | 19.38 | 0 |
| | −10% | — | | 0.021896 | 0.015452 | 31.71 | 329.265 | 53.7095 | | |
| CTE | +10% | 297 × 10⁻⁶ K⁻¹ | | 0.026505 | 0.019192 | 45.09 | 329.265 | 53.7095 | 26.38 | 0 |
| | −10% | 243 × 10⁻⁶ K⁻¹ | | 0.021882 | 0.015835 | 17.84 | 329.265 | 53.7095 | | |
| k | +10% | 0.3421 | W/mK | 0.024192 | 0.017486 | 26.03 | 329.218 | 53.7270 | 0.031 | 1 3 × 10⁻⁵ |
| | −10% | 0.2799 | W/mK | 0.024192 | 0.017486 | 26.96 | 329.322 | 53.6882 | | |
| C | +10% | 2299 | J/kg K | 0.024193 | 0.017522 | 26.36 | 329.203 | 53.7326 | 0.0039 | 1.86 × 10⁻⁵ |
| | −10% | 1881 | J/kg K | 0.024191 | 0.017503 | 26.69 | 329.327 | 53.6863 | | |
| ρ | +10% | 1056 | kg/m³ | 0.024193 | 0.017522 | 26.36 | 329.203 | 53.7326 | 0.0039 | 1.86 × 10⁻⁵ |
| | −10% | 864 | kg/m³ | 0.024191 | 0.017503 | 26.69 | 329.327 | 53.6863 | | |
| t | +10% | 1.32 | mm | 0.024196 | 0.017513 | 26.46 | 329.251 | 53.7147 | 0.0008 | 9.55 × 10⁻⁷ |
| | −10% | 1.08 | mm | 0.024188 | 0.017513 | 26.61 | 329.279 | 53.7042 | | |

With the results of the instantaneous shear modulus, it was clear that the slope of the relaxation curve will have an impact on life. Greater strain change of encapsulant led to lesser life of the interconnects. Thus, when the slope was increase by 10%, life reduced from 26.53 years to 20.03 years. Likewise, the decrease in slope increased life up to 31.71 years. This large impact gave it a NSC of 19.38, which is the second highest of all parameters. No change in power output is observed.

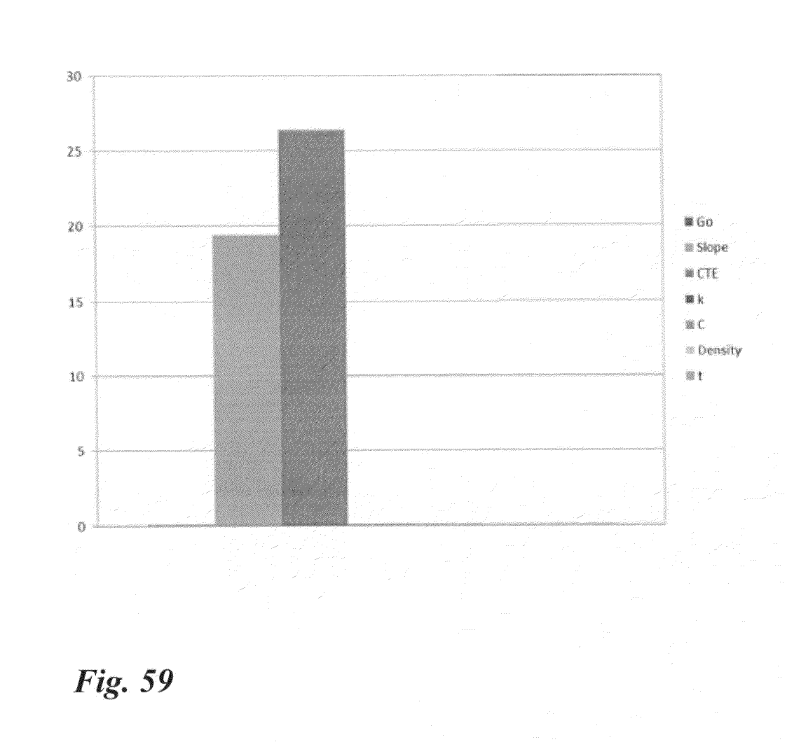

The CTE played a significant role in the case of life (FIG. 59). Larger the CTE, more inter-structural movement is bound to occur, leading to larger strains in all components of the PV module. The ±10% change has altered life between 17.84 and 45.09 years. This is the highest change seen with respect to all the parameters thereby giving it the largest NSC of 26.38. It is evident that there no change in power output. Thermal conductivity was altered in a similar fashion. Quite a little change in power output is seen. With a higher conductivity, the encapsulant provides a path to dissipate heat from cells. But this gives a negligible amount of improvement along with a NSC of 1 3×10-5 in terms of power output. The alteration in thermal conductivity gave an opposite impact in the case of life. Life was increased to 26.96 by decreasing 10% decrease in k. Although NSC in the case of life was as little as 0.031, but still it is better than the power output. The decrease in thermal conductivity causes lesser change in strain by trapping heat with the interconnects.

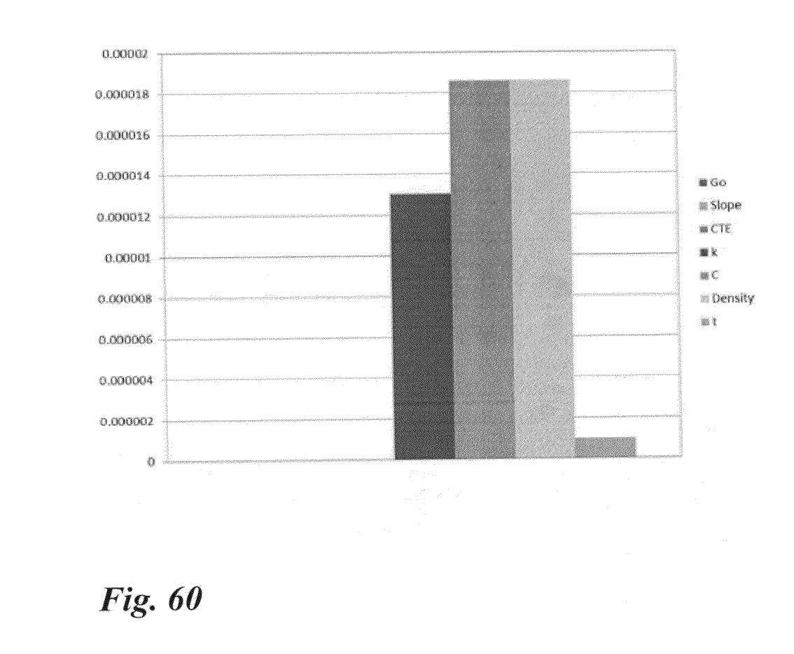

When the specific heat and density were altered by 10%, both of them gave the same impact for both life and power output cases. It gave the highest NSC with respect to power output and equal to 1.86×10-5, displayed in FIG. 60. The concept and outcomes are the same as seen in the thermal conductivity case. The increase in both of them provides a thermal barrier, thus restraining increase in cell temperature. The encapsulant can absorb greater amount of heat. On the other hand, life displays a reverse influence.

The increase in thickness decreases life and increases the power output. As the encapsulant material in increased, the effect of glass dominancy decreases, which increases the inter-structural motion between glass and the interconnects. The NSC in the case of electrical power is 9.55×10⁻⁷ which is so little that the change can be neglected. In this study sensitivity analysis was performed over certain parameters of the encapsulant material to find its effect on the life and the power output of PV module. EVA was kept as the nominal case as it is the least expensive and the most widely used encapsulant. The constitutive and thermal properties were slightly altered to draw out the following conclusions:
The slope of the relaxation curve and the CTE of the encapsulant have a dominant influence over the life of the PV module with CTE proving the highest impact.
There is negligible improvement or loss in the electrical efficiency of PV module. Thus, it can be inferred that the encapsulant material has an insignificant effect over the electrical performance of PV module.

A comprehensive finite element model for PV module was developed in this work. The model included viscoelastic modeling of the encapsulant material along with the orthotropic modeling of silicon cells. The concept of layered-shell modeling was utilized to reduce problem size, so that the effect of whole 36 cell PV module, incorporating the interconnects, could be analyzed. The model was validated by an experiment in the literature. This model was utilized to simulate ASTM E1171-09 qualification test and copper interconnects were found to go under low-cycle fatigue. In the next study, a life prediction model for the copper interconnects was used in conjunction with a thermal model. The meteorological conditions of Jeddah, Saudi Arabia were used to predict PV module life under actual operating loads. In the third study, five different encapsulants were incorporated in the model and their effects on structural and electrical performance were studied. In the last study, sensitivity analysis was performed to find the most important properties of the encapsulant material that would impact on the overall performance of PV module.

The disclosure includes the following:
Viscoelastic model for EVA is a close estimate of its constitutive behavior, unlike the linear elastic model which gave a large deviation from actual behavior.
Shell model is able to capture the response of PV module over loads as the solid model. It also provides conservative estimates, useful for design purposes.
Glass exhibits a dominant character towards the contraction of the module. It forces all components to follow its pure thermal contraction.
Stress in cells is higher along the interconnect region as:
They are both directly tied to one another.
Interconnect hardens as it undergoes plasticity.
Parametric study shows that 1.2 mm is the optimum encapsulation thickness.
Interconnects undergo plasticity just after curing of the laminate. This hardens it thereby increasing the risk of breakage owing to fatigue induced during thermo cycles of day and night.
The high failure percentage of copper interconnects, given in the literature, is justified through its yielding during cooling after the lamination process. The plastic deformation makes it a subject of low-cycle fatigue.
Glass exhibits a dominating behavior due to its large thickness. As the contraction of glass was fixed, all the components of PV module had induced tensile stress within them. Glass also bears the maximum stress amongst all of the components as it bears most of the area of constraint, which was made to provide frame effect.
Silicon cells operate within a safe temperature range as the stresses induced in it are way below their yield stress; unless they are pre-cracked due to their manufacturing and soldering procedure.
Average life of a PV module has been estimated through its dominant mode of failure which is the breakage of copper interconnects and is found out to be 26.63 years. It is quite close to the 25-year warranty given my most of the PV module manufacturers.
The numerical procedure developed is inclusive of operating conditions and has the ability to predict proper behavior and life under operation with reasonable accuracy. It can be used as a tool to anticipate the effects of design changes in the form of stress distribution and life.
Changing the encapsulant material of PV module has an insignificant effect on the stresses of its components.
More PV module life is observed by using encapsulants with least strain range.
The efficiency of the PV module is not affected by changing its encapsulant.
Maximum life of PV module is predicted when Ionomer is used as an encapsulant. On the contrary, the usage of PVB gives minimum life.
Ionomer is seen to be as the best encapsulant for PV modules as it provides a mix of good properties at a reasonable cost as rated by the decision matrix.
The slope of the relaxation curve and the CTE of the encapsulant have a dominant influence over the life of the PV module with CTE proving the highest impact.
There is negligible improvement or loss in the electrical efficiency of PV module. Thus, it can be inferred that the encapsulant material has an insignificant effect over the electrical performance of PV module.
This model can be used to predict life of PV module under direct mechanical loading due to wind, hail and snow. The loads of ASTM E1830-09 can be utilized. An optimized design for frame can be proposed under such loading conditions.
In the future, there is also a possibility to incorporate this model with dust accumulation and moisture ingression models to predict PV module overall performance.
The model can be utilized to assess the effect of concentration over PV module.
   Next, a hardware description describing the smart alarm system device 100 according to exemplary embodiments is described with reference to FIG. 8.

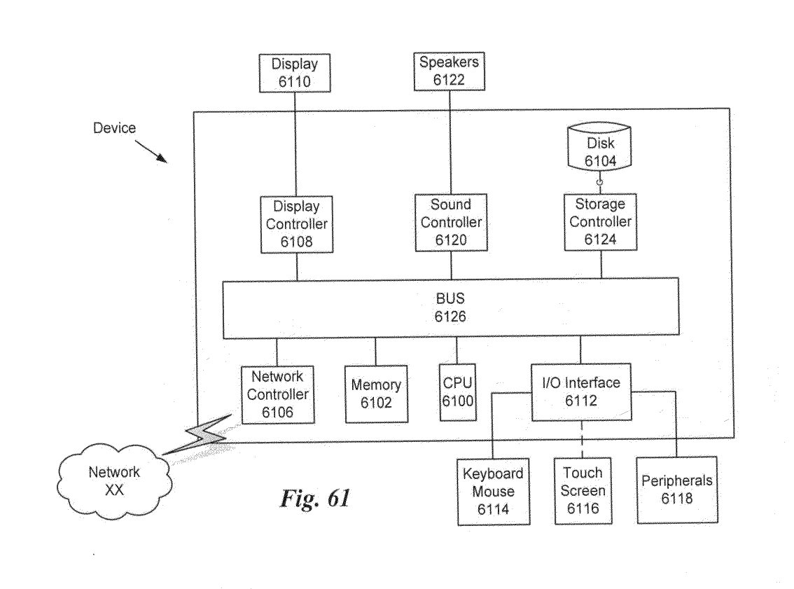

In FIG. 61, the method includes a CPU 6100 which performs the processes described above. The process data and instructions may be stored in memory 6102. These processes and instructions may also be stored on a storage medium disk 6104 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server communicates, such as another server or computer. Further, the above-noted processes may be provided as a utility application, background daemon, or component of an operating system, or combination thereof, executing in conjunction with CPL 6100 and an operating system such as Microsoft Windows 8, UNIX, Solaris, LINUX, Apple MAC-OS and other systems known to those skilled in the art.

CPU 6100 may be a Xenon or Core processor from Intel of America or an Opteron processor from AMD of America, or may be other processor types that would be recognized by one of ordinary skill in the art. Alternatively, the CPU 6100 may be implemented on an FPGA, ASIC, PLD or using discrete logic circuits, as one of ordinary skill in the art would recognize. Further, CPU 6100 may be implemented as multiple processors cooperatively working in parallel to perform the instructions of the inventive processes described above.

It also includes a network controller 6106, such as an Intel Ethernet PRO network interface card from Intel Corporation of America, for interfacing with network 6106. As can be appreciated, the network 6106 can be a public network, such as the Internet, or a private network such as an LAN or WAN network, or any combination thereof and can also include PSTN or ISDN sub-networks. The network 6106 can also be wired, such as an Ethernet network, or can be wireless such as a cellular network including EDGE, 3G and 4G wireless cellular systems. The wireless network can also be WiFi, Bluetooth, or any other wireless form of communication that is known.

The method further includes a display controller 6106, such as a NVIDIA GeForce GTX or Quadro graphics adaptor from NVIDIA Corporation of America for interfacing with display 6110, such as a Hewlett Packard HPL2446w LCD monitor. A general purpose I/O interface 6112 interfaces with a keyboard and/or mouse 6114 as well as a touch screen panel 6116 on or separate from display 6110. General purpose I/O interface also connects to a variety of peripherals 6118 including printers and scanners, such as an OfficeJet or DeskJet from Hewlett Packard.

A sound controller 6120 is also provided in the smart alarm system device 6100, such as Sound Blaster X-Fi Titanium from Creative, to interface with speakers/microphone 6122 thereby providing sounds and/or music. The speakers/microphone 6122 can also be used to accept dictated words as commands. The general purpose storage controller 6124 connects the storage medium disk 6104 with communication bus 6126, which may be an ISA, EISA, VESA, PCI, or similar, for interconnecting all of the components of the method. A description of the general features and functionality of the display 6110, keyboard and/or mouse 6114, as well as the display controller 6108, storage controller 6124, network controller 6106, sound controller 6120, and general purpose I/O interface 6112 is omitted herein for brevity as these features are known.

Any processes, descriptions or blocks in flow charts should be understood as representing modules, segments, portions of code which include one or more executable instructions for implementing specific logical functions or steps in the process, and alternate implementations are included within the scope of the exemplary embodiment of the present system in which functions may be executed out of order from that shown or discussed, including substantially concurrently or in reverse order, depending upon the functionality involved, as would be understood by those skilled in the art. Further, it is understood that any of these processes may be implemented as computer-readable instructions stored on computer-readable media for execution by a processor.

Obviously, numerous modifications and variations of the present invention are possible in light of the above teachings. It is therefore to be understood that within the scope of the appended claims, the invention may be practiced otherwise than as specifically described herein.

Osama Hasan, “Performance and Life Prediction Model for Photovoltaic Module: Effect of Encapsulant Constitutive Behavior,” Master of Science Thesis in Mechanical Engineering, King Fahd University of Petroleum and Minerals, Dhahran Saudi Arabia (April 2013) is incorporated herein by reference in its entirety.

1. A method for modeling the performance and lifetime of a photovoltaic module (PV) comprising one or more silicon cells interconnected with copper leads and encapsulated with an encapsulant polymer, a layer of glass bonded to a top surface of the encapsulant, and a back layer bonded to a back surface of the encapsulant, comprising:
preparing a comprehensive finite element model of the PV module;
viscoelastically modeling of the encapsulant polymer in the PV module; and
orthotropically modeling the silicon cells of the PV module,
wherein the viscoelastic modeling and the orthotropic modeling affect the performance of the PV module based on differences in the coefficients of thermal expansion (CTE) of the encapsulant polymer, the silicon cells, the copper leads, the glass layer and the back layer, and corresponding thermo-mechanical stresses within the PV module.

2. The method according to claim 1, wherein the finite element model includes a prediction of a required time to crack initiation due to temperature; and
wherein the method further comprises analyzing the temperature cycling fatigue of copper interconnects in the PV module.

3. The method according to claim 2, wherein the analyzing includes analyzing the PV module under variable mechanical environmental stresses including temperature and sun exposure.

4. The method according to claim 1, wherein viscoelastic modeling of encapsulant is utilized to study the effect of change in encapsulant material on copper interconnects.

5. The method according to claim 1, wherein the performance of the PV module is electrical performance based on a power output (Vmp×Imp) and an electrical efficiency, wherein Vmp and Imp are the voltage and current at maximum power point respectively.

6. The method according to claim 1, wherein the performance of the PV module is thermal performance quantified through a cell temperature (Tc) representing heat removal from silicon cells.

7. A non-transitory computer-readable medium including executable instructions, which when executed by circuitry, cause the circuitry to execute a process, comprising:
preparing a comprehensive finite element model of the PV module;
viscoelastically modeling of the encapsulant polymer in the PV module; and
orthotropically modeling the silicon cells of the PV module,
wherein the viscoelastic modeling and the orthotropic modeling affect the performance of the PV module based on differences in the coefficients of thermal expansion (CTE) of the encapsulant polymer, the silicon cells, the copper interconnects, the glass layer and the back layer, and corresponding thermo-mechanical stresses within the PV module.
